(19) United States
(12) Patent Application Publication
(10) Pub. No.: US 2026/0228575 A1
(43) Pub. Date: Aug. 6, 2026

(54) ADVANCED AUTONOMOUS ARTIFICIAL INTELLIGENCE (AAAI) SYSTEM AND METHODS

(71) Applicant: iQ Consulting Company Inc., Aptos, CA (US)

(72) Inventor: Craig Kaplan, Aptos, CA (US)

(73) Assignee: iQ Consulting Company Inc., Aptos, CA (US)

(21) Appl. No.: 19/154,492

(22) PCT Filed: Feb. 26, 2024
(86) PCT No.: PCT/US2024/017233

§ 371 Date: Aug. 7, 2025

Related U.S. Application Data
(60) Provisional application No. 63/487,494, filed on Feb. 28, 2023.
(60) Provisional application No. 63/491,040, filed on Mar. 17, 2023.
(60) Provisional application No. 63/577,830, filed on May 25, 2023.
(60) Provisional application No. 63/628,410, filed on Jul. 18, 2023.
(60) Provisional application No. 63/519,549, filed on Aug. 14, 2023.
(60) Provisional application No. 63/601,930, filed on Nov. 22, 2023.
(60) Provisional application No. 63/609,800, filed on Dec. 13, 2023.

(51) Int. Cl. G06N 5/043

(52) U.S. Cl. CPC G06N 5/043

(57) ABSTRACT

Artificial General Intelligence (AGI) is the world's most powerful invention. AGI can solve any problem better and faster than humans—or it can make humanity extinct. Whether AGI represents a multi-trillion-dollar opportunity or an existential threat, depends critically on AGI's design. This invention achieves safe AGI by relying on the combined knowledge and ethics of many humans, each of whom customizes his/her/their own cloneable Advanced Autonomous Artificial Intelligence, or AAAI. The AAAIs can be customized via a single click, leveraging existing data from social media, and other sources of information. These AAAIs collaborate with each other, and with other humans, on a network, using a novel universal problem solving architecture to comprise an AGI system. The AGI system is also designed with scalable safety features that are integral to the system architecture. It is not only the fastest, but also the safest, path to AGI.

### TECHNICAL FIELD

In some aspects, the present technology can relate to an advanced autonomous, semi-autonomous or non-autonomous agents artificial intelligence (AAAI) system and methods for use in connection with developing Artificial General Intelligence and SuperIntelligent Artificial General Intelligence (AGI). In some other aspects, the present technology can relate to methods associated with utilizing an involvement of human input in an AGI training, operation, and safety/supervisory functions. In yet other aspects, the present technology can relate to the utilization of personal Artificial Intelligent (AI) systems that are customized and cloned, which can participate in problem solving and other intellectual activities on a network consisting of other AAAIs and human input. In still yet other aspects, the present technology can relate to a method for customizing individual AI agents and then enabling them to work together in a collective intelligence network to achieve AGI.

In yet other aspects, all activities that are described in this patent disclosure as happening on an external network in which multiple intelligent entities participate in collaborative problem solving, can also be implemented within a single computerized intelligent system where the intelligent entities are all computerized or AI agents that reside within that single computerized intelligent system.

### BACKGROUND ART

The field of Artificial Intelligence (AI) was named in 1956 at a conference in Dartmouth, MA in the United States that was organized by the computer scientist, John McCarthy. Among the researchers attending the Dartmouth conference were Herbert A. Simon (a future Nobel Laureate) and Allen Newell (a future distinguished computer scientist), both from Carnegie Mellon University.

Simon and Newell, together with their colleague Cliff Shaw, presented the only working demonstration of AI at the Dartmouth conference. It was a program called the Logic Theorist. The Logic Theorist was an example of the state of early AI efforts where rules defining the behavior of the AI were programmed directly into a computer by human programmers. Interestingly, by programming rules in a general way so as to allow the computer program to pursue goals and subgoals by a variety of means (called “operators”) the Logic Theorist was able to demonstrate creative behavior.

Specifically, although it was programmed to recreate mathematical proofs from the textbook, Principia Mathematica by Betrand Russell and Alfred North Whitehead, the Logic Theorist actually found a new proof that was previously unknown both to the programmers of the Logic Theorist and to Russell and Whitehead themselves. Reportedly, Russell and Whitehead were impressed by the Logic Theorist's new proof and wrote the inventors to say that not only was the Logic Theorist's proof previously unknown to them, but they wished that they had thought of the proof themselves! Thus, in 1956, at the birth of the field of AI, AI was already capable of creative thought. Of particular relevance to this patent, is the architecture of the Logic Theorist which made use of goals and subgoals—an approach which Newell and Simon subsequently developed further, which was subsequently adopted by many AI systems, and which this patent applies in new and creative ways.

Research in the field of AI from 1956 to 1986 was primarily dominated by the “expert systems” approach. Humans with programming skills would interview a human expert and represent that expert's knowledge in a series of programmed rules for the AI. This process was called “knowledge engineering”. The result of the knowledge engineering was an AI program that could behave like a human expert in limited areas. For example, the program MYCIN was developed in the 1970s at Stanford University to act as an expert system in the area of blood infections. E. A. Feigenbaum et al. at Stanford went on to develop an entire series of expert systems in various medical areas in the 1980s. Similar work in expert systems was going on at many other universities as well.

As more and more expert systems were developed, Newell and Simon looked to the best model of intelligence available-humans-as they strove to improve the performance of AI systems. Their research resulted in a very powerful and broad theory that could describe rigorously how humans solved almost any type of problem. This theory, which elaborated on their earlier work with the Logic Theorist, was known as “search through a problem space”. The theory was described in great detail in their book, Human Problem Solving, published in 1972.

Dr. Craig Kaplan, the inventor of the AAAI patent, studied with Herbert Simon and Allen Newell in the 1980s. He co-authored research with Dr. Simon in the area of creative problem solving and cognitive science, including publication of an article “Foundations of Cognitive Science” in 1989. Dr. Kaplan realized that the “search through a problem space” architecture proposed by Newell and Simon, could be generalized to enable collective problem solving by millions of humans over the internet. Starting in the late 1990s, Dr. Kaplan began to reduce his ideas to practice in a variety of working systems that actively harnessed the collective intelligence of humans.

For example, Dr. Kaplan pioneered some of the first practical applications of crowdsourced intelligence around 2000. In 2001, in a presentation at the first Global Brain Conference in Brussels, he outlined his ideas to apply collective intelligence to one of the most difficult and competitive problems in business—beating Wall Street. By 2006, he had designed and implemented the “PredictWallStreet” system that harnessed collective intelligence of millions of humans to get an edge in the stock market. In 2018, that system powered one of the top-ten performing market-neutral hedge funds, thus proving its effectiveness to perform at the highest levels in a complex field competing against some of the smartest humans on the planet.

In the process of designing and implementing these systems, Dr. Kaplan realized that the “search through a problem space” architecture that worked as a general framework for human problems solving, could be adapted and enhanced to serve as a general architecture for cognition that included both human and AI agents. Further, representing intelligent behavior as a form of problem solving provided a way for many AI agents to interact among themselves, pooling their collective intelligence to create AGI. This “Collective Intelligence” approach, presented here as the AAAI system and method for AGI, represents a faster and more powerful path to AGI compared with existing efforts. Most existing efforts to achieve AGI are primarily focused on training larger LLMs using more data, more powerful computers, and better machine learning algorithms. The AAAI approach also has the virtue of enabling humans to participate easily in training and improving the intelligence of AIs, including helping form the AI's values and ethics—an essential feature to ensure the safe development of AGI.

While Dr. Kaplan recognized the importance of collective intelligence early on, most other AI researchers became ever-more-focused on a sub-field of AI known as machine learning (ML). Starting in the 1980s, ML began to get traction as a way of getting the AI to learn knowledge on its own, instead of having a knowledge engineer program the knowledge into the AI. However, progress in ML was very slow until a paper showing how to use the “backpropagation of feedback”—one of the first practical reinforcement learning techniques—was published in 1986. After that paper, some AI researchers saw that the future of AI would depend on machines teaching themselves, rather than humans programming them. Unfortunately, the computational and data requirements for ML were enormous and largely beyond the capabilities of 1980s' or even 1990s' technology.

About three decades of the operation of Moore's law—the doubling of computing power every 18 months or so—were required before the computation ability of technology caught up with what ML algorithms required. During this same time, the amount of data available for training such models, particularly on the internet (which began to take off after 1995 with the advent of web browsers) began to increase.

An “AI winter,” from the 1990s through the first decade of the 2000s, had resulted from overly optimistic ambitions for AI that exceeded the readily available data and computer power. However, by 2010, there was a confluence of abundant computing power, data, and “good enough” ML algorithms. Progress in AI began to accelerate rapidly including the development of improved learning algorithms such as “Transformers”.

As of early 2023, the knowledge engineering approach to creating expert systems has largely been ignored in favor machine learning approaches which have successfully enabled machines to teach themselves how to beat the best human champions at Chess, Go, and any two-player game. Programs like AlphaFold have determined the shapes of millions of proteins in a matter of months whereas the best human experts used to take 4-6 years to accurately determine the shape of a single protein. Natural Language Processing (NLP)—a subfield of AI focused on understanding human language—has made tremendous progress, resulting in assistants like Amazon's Alexa, Apple's Siri, and most recently Large Language Models (LLMs) like GPT from OpenAI.

The present technology, scaling, and improvement of LLMs was a watershed moment enabling AI to cross over from being a specialized tool of interest in specific areas (aka “narrow AI”) to more general applications. With the release of CHATGPT by OpenAI, the subsequent release of BARD by Google®, the incorporation of GPT into Microsoft's® BING® search engine, and the proliferation of AI companies focused on applying ML approaches widely, a tidal wave of innovation in AI applications is being unleashed. Many individual fields, ranging from medical applications, vehicle navigation, office work, legal work, marketing, sales, education, and even brewing beer are all being revolutionized by application of LLMs, and more broadly, advances in machine learning approaches and capabilities.

However, one goal has remained beyond reach. As of Feb. 23, 2023, except for the present technology detailed in this description, no company or individual has explained how to create a practical system for Artificial General Intelligence (AGI). The reason: ML alone is not enough to rapidly achieve AGI. Collective Intelligence is also needed.

### DISCLOSURE OF TECHNOLOGY

In view of the foregoing disadvantages inherent in the known types of AI systems and methods at least some embodiments of the present technology provide a novel advanced AAAI system and methods, and overcomes one or more of the mentioned disadvantages and drawbacks of the prior art. As such, the general purpose of at least some embodiments of the present technology, which will be described subsequently in greater detail, is to provide a new and novel AAAI system and methods which has all the advantages of the prior art mentioned herein and many novel features that result in a AAAI system and methods which is not anticipated, rendered obvious, suggested, or even implied by the prior art, either alone or in any combination thereof.

According to one aspect, the present technology can include a system for artificial intelligence (AI) electronically communicating over a network. The system can include a computer system including a processor, a computer-readable storage medium, and program instructions stored on the computer-readable storage medium being executable by the processor to cause the computer system to:
execute a customization subsystem configured or configurable for customizing one or more attributes of an AI system;
execute a common cognitive architecture subsystem configured or configurable for implementing one or more problem solving protocols on a request received by the AI system;
execute a collective network subsystem configured or configurable for electronically communicating the AI system and one or more additional AI systems or additional computer systems;
execute an integration subsystem configured or configurable for utilizing one or more datasets from any one of or any combination of the AI system and the additional AI systems; and
execute an improvement subsystem utilizing one or more techniques configured or configurable for continuous improvement of any one of or any combination of the customization subsystem, the common cognitive architecture subsystem, the collective network subsystem and the integration subsystem.

According to another aspect, the present technology can include a method for artificial intelligence (AI) utilizing multiple intelligent entities being any one of or any combination of multiple AI systems and multiple humans each using a computer system, wherein the intelligent entities are electronically communicating over a collective network. The method can include:
customizing one or more attributes of an AI system;
implementing one or more problem solving protocols on a problem request provided by any one of or any combination of the AI system and the intelligent entities, the problem solving protocols utilizing a common cognitive architecture;
communicating the AI system and the intelligent entities utilizing a collective network;
integrating one or more datasets from any one of or any combination of the AI system and the intelligent entities; and
improving, by utilizing one or more techniques, any one of or any combination of the customizing of the attributes, the common cognitive architecture, the collective network and the integrating of the datasets.

In some embodiments, the step of customizing the attributes of the AI system can include the steps of:
creating an interface configured or configurable to allow a human user to input training data;
selecting one or more training methods and setting training parameters depending on any one of or any combination of a speed factor, a precision factor, an accuracy factor, and a transferability factor;
executing multiple training epochs that includes one or more mechanisms to determine an optimum number of epochs given specific training objectives and quality metrics; and
engaging in one or more feedback sessions to refine the training parameters, and to re-run the training epochs based on any one of or any combination of an input from the human user and an input from one or more of the intelligent entities in communication with each other over the network.

In some embodiments, the interface can be accessible through a web-based application or a mobile application and can be configured or configurable to upload a file or allow the user to enter data manually into an input field.

In some embodiments, the training data can contain any one of or any combination of: an amount of training time the user has to devote to customizing the AI system; an amount of financial resources the user is willing devote to customize the AI system; an amount of social media information available to customize the AI system; an amount of email information available to customize the AI system; an amount of electronic information available about the user to customize the AI system; and an amount of electronic information available collected by third parties about the user to customize the AI system.

In some embodiments, the training data can contain information about the user obtained by any one of or any combination of a personality test, a standardized tests, a certification, and assessments or questionnaires provided by the user.

In some embodiments, the training parameters can be any one of or any combination of: a type of training, tuning or other machine learning algorithm to be used; a type and size of a training dataset; a degree to which the training dataset is to be formatted, labelled or processed before customization begins; a number of training epochs; a type of base model being customized; a required timeframe for training; an amount of human user supervision to be used in the customizing of the AI system; and an amount of AI supervision to be used in the customizing of the AI system.

In some embodiments, the training data can include ethical information provided by the human user or a second human user by way of the interface, the ethical information is stored in an ethical profile, and wherein the customizing of the attributes of the AI system includes the ethical information.

In some embodiments, the step of implementing the problem solving protocols on the problem request utilizing the common cognitive architecture can include the steps of:
submitting the problem request from a human user using a user interface or any one of the intelligent entities;
acquiring information associated with the problem request from any one of a human user of the AI system or any one of the intelligent entities;
identifying one or more of the intelligent entities that have one or more criteria related to one or more request criteria of the problem request;
implementing by each of the identified intelligent entities the problem solving protocols on the problem request to create a completion solution; and
providing the completion solution to any one of or any combination of the AI system and any one of the intelligent entities for final acceptance by the user.

In some embodiments, the information can be any one of or any combination of a name and description of the problem request, a total reward that the user will pay for a successful completion solution to the problem request, a criteria to determine whether the completion solution is deemed successful, a time limit for solving the problem request, a minimum and maximum number of the identified intelligent entities allowed to work on the problem request simultaneously, qualifications required of users associated with the identified intelligent entities working on the problem request, a part of the problem request is confidential, a part of the completion solution is confidential, whether the completion solution is exclusive to the user, whether the completion solution is to be re-used for other users, parameters relating to how to reward the users associated with the identified intelligent entities for working on the problem request, and parameters relating to how to reward the users associated with the identified intelligent entities that provide a successful completion solution.

Some embodiments of the present technology can include a step of timestamping and validating the completion solution against a success criteria assigned by the user before being provided to the user for the final acceptance.

Some embodiments of the present technology can include a step of distributing a reward to the identified intelligent entities associated with the final acceptance completion solution, wherein the reward is based on a payment parameter.

In some embodiments, the payment parameter can include any one of or any combination of if a goal of the problem request has been achieved, if a subgoal of the problem request has been achieved, and if an ethical criteria related to each of the goal and the subgoal preceding the distributing of the reward has been satisfied.

Some embodiments of the present technology can include a step of splitting the problem request into a series of sub-problems that are each solved by any one of or any combination of the identified intelligent entities.

In some embodiments, the AI systems can be cloned to create one or more cloned AI systems.

Some embodiments of the present technology can include a step of implementing in parallel by each of the cloned AI systems the common cognitive architecture including the problem solving protocols on the problem request to create a completion solution of the cloned AI systems.

In some embodiments, the completion solution can utilize any one of or combination of the completion solution from the identified intelligent entities, and the completion solution from the cloned AI systems.

In some embodiments, the problem solving protocols can provide layers that provide an infrastructure configured or configurable to build and scale the AI system. The protocols can enable re-use of completion solutions within and across the AI system and the identified additional AI systems. The problem solving protocols can be configured or configurable to manage a payment of royalties.

In some embodiments, the infrastructure can be blockchain or Ethereum based.

In some embodiments, the common cognitive architecture can include:
defining a problem space configured or configurable to support all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state, and then applying operators to reduce a difference, a safety or ethics screening is applied each time the goals or the subgoals is set;
applying heuristic rules that are configured or configurable to guide a selection of the operators in an absence of the completion solution, the heuristic rules are used to reduce the problem space;
identifying one or more second operators configured or configurable to enact an action to transform one of the states into another state, the second operators move from the initial state to the goal state by changing a current state of the problem request;
applying a control structure including a set of rules that govern a selection of the second operators to be applied at each step of the problem solving protocols, and that determines which of the operators to apply next based on the current state of the problem request and the goal state;
applying evaluation functions to determine an application of the second operators;
assigning a credit or blame value to the completion solution or sub-solution to the completion solution that enables tracing back and determining which of the second operators were most useful and also which of the evaluation functions led to success or failure of problem solving attempts;
recording of both successful and unsuccessful solution attempts to the problem request; and
analyzing the solution attempts to improve selection of the heuristic rules and the evaluation functions.

In some embodiments, the step of utilizing the collective network can include the steps of: acquiring information from the user associated with the problem request from any one of a human user of the AI system or any one of the intelligent entities;
identifying one or more of the intelligent entities that have one or more criteria related to one or more request criteria of the problem request;
implementing, by a first intelligent entity of the identified intelligent entities the problem solving protocols on the problem request;
identifying by the first intelligent entity that a completion solution to the problem request requires solving a first sub-problem and one or more additional sub-problems;
implementing by the first intelligent entity the problem solving protocols on the first sub-problem to create a first sub-solution;
assigning at least one of the additional sub-problems to a second intelligent entity of the intelligent entities, and implementing by the second intelligent entity the problem solving protocols on the at least one of the additional sub-problems to create a second sub-solution;
creating, updating or creating and updating a decision tree including the first sub-solution, the second sub-solution and any additional sub-solutions to create the completion solution to the problem request; and
providing the completion solution to the user interface for final acceptance by the user.

In some embodiments, the decision tree can be maintained in a blockchain or Ethereum logs.

In some embodiments, the first and second identified intelligent entities can access the decision tree by way of an online address or directly from a blockchain.

Some embodiments of the present technology can include a step of distributing a reward to the first identified intelligent entities associated with an acceptance of the completion solution or the first sub-solution, wherein the reward is based on a payment parameter.

Some embodiments of the present technology can include a step of distributing a portion of the reward to the second identified intelligent entity by the first identified intelligent entity based on a payment parameter assigned by the first identified intelligent entity.

Some embodiments of the present technology can include a step of assigning a blame value and a credit value associated with a problem solving history, using the blame value and the credit value to train the AI system.

Some embodiments of the present technology can include a step of translating natural language interactions with a human user and the AI system into a common problem solving representation so that both the human user and the AI system can engage in problem solving and the AI system can learn and improve by detecting a behavior and effectiveness of both the human user and the AI system utilizing a reinforcement learning scheme.

In some embodiments, any one of or combination of the identified additional AI systems can be cloned to create one or more cloned AI systems.

Some embodiments of the present technology can include a step of implementing in parallel by each of the cloned AI systems the common cognitive architecture including the problem solving protocols on the problem request to create a completion solution of the cloned AI systems.

In some embodiments, the completion solution can utilize any one of or combination of the completion solution from the identified intelligent entities, and the completion solution from the cloned AI systems.

In some embodiments, the step of integrating any one of or any combination of the datasets and knowledge bases from the multiple AI systems can include:
acquiring information from associated with the problem request from any one of a human user of the AI system or any one of the intelligent entities;
identifying the intelligent entities that have one or more criteria related to one or more request criteria of the problem request;
assigning the problem request or one or more sub-problems of the problem request to each of the identified intelligent entities;
implementing by the identified intelligent entities the problem solving protocols on the problem request or the sub-problems to create a problem solution or one or more sub-problem solutions, respectively;
integrating the problem solution and one or more of the sub-problem solutions to create a completion solution to the problem request; and
providing the completion solution to a user interface for final acceptance by the user.

Some embodiments of the present technology can include a step of assigning a credit value or a blame value to the datasets based on whether the datasets increase or decrease performance of the AI system based on performance metrics or evaluation functions.

Some embodiments of the present technology can include a step of quantifying a benefit weight or a harm weight to a contribution by each of the identified intelligent entities to the problem request.

Some embodiments of the present technology can include a step of distributing a reward to an owner of the identified intelligent entities proportionally to the contribution of the identified intelligent entities based on the benefit weight or the harm weight.

According to still another aspect and as generally illustrated in FIG. 10, the present technology can include a method for artificial intelligence (AI) by customizing one or more attributes of an AI system. The method can include:
creating an interface configured or configurable to allow a human user of the AI system or any one of the intelligent entities to input training data;
processing and converting the training data to a standardized training format;
selecting one or more training methods and setting training parameters depending on any one of or any combination of a speed factor, a precision factor, an accuracy factor, and a transferability factor;
executing multiple training epochs that includes one or more mechanisms to determine an optimum number of epochs given specific training objectives and quality metrics associated with the training format;
engaging in one or more feedback sessions to refine the training parameters, and to re-run the training epochs based on any one of or any combination of an input from the human user, and any one of the intelligent entities; and
customizing the attributes of the AI system with the training format.

In some embodiments, the interface can be accessible through a web-based application or a mobile application and is configured or configurable to upload a file or allow the human user to enter data.

In some embodiments, the training data can contain any one of or any combination of: an amount of training time the user has to devote to customizing the AI system; an amount of financial resources the user is willing devote to customize the AI system; an amount of computational resources the user is willing to devote to customize the AI system; an amount of social media information available to customize the AI system; an amount of email information available to customize the AI system; an amount of electronic information available about the user to customize the AI system; and an amount of electronic information available collected by third parties about the user to customize the AI system.

In some embodiments, the training data can contain information about the human user obtained by any one of or any combination of a personality test, a standardized tests, a certification, and assessments or questionnaires provided by the human user.

In some embodiments, the training parameters can be any one of or any combination of: a type of training, tuning or other machine learning algorithm to be used; a type and size of a training dataset; a degree to which the training dataset is to be formatted, labelled or processed before customization begins; a number of training epochs; a type of base model being customized; a required timeframe for training; an amount of human user supervision to be used in the customizing of the AI system; and an amount of AI supervision to be used in the customizing of the AI system.

In some embodiments, the training data can include ethical information provided by the human user by way of the interface. The ethical information can be stored in an ethical profile. The customizing of the attributes of the AI system can include the ethical information.

According to yet another aspect and as generally illustrated in FIG. 11, the present technology can include a method for artificial intelligence (AI) by problem solving utilizing a common cognitive architecture implemented in an AI system. The method can include:
providing a problem request from an intelligent entity being an AI system or a human user using a user interface on a computer system;
acquiring information associated with the problem request from the intelligent entity;
identifying multiple additional intelligent entities that are each communicable with each other over a network, and that each have one or more criteria related to one or more request criteria of the problem request, wherein the additional intelligent entities being any one of or any combination of multiple additional AI systems and multiple additional humans each using a computer system;
implementing by each of the identified additional intelligent entities the common cognitive architecture including one or more problem solving protocols on the problem request to create a completion solution; and
providing the completion solution to the intelligent entity for final acceptance by the user.

In some embodiments, the information can be any one of or any combination of a name and description of the problem request, a total reward that the user will pay for a successful completion solution to the problem request, a criteria to determine whether the completion solution is deemed successful, a time limit for solving the problem request, a minimum and maximum number of the identified additional intelligent entities allowed to work on the problem request simultaneously, qualifications required of users associated with the identified additional intelligent entities working on the problem request, a part of the problem request is confidential, a part of the completion solution is confidential, whether the completion solution is exclusive to the user, whether the completion solution is to re-used for other users, parameters relating to how to reward the users associated with the identified additional intelligent entities for working on the problem request, and parameters relating to how to reward the users associated with the identified additional intelligent entities that provide a successful completion solution.

Some embodiments of the present technology can include a step of timestamping and validating the completion solution against a success criteria assigned by the user before being provided to the user for the final acceptance.

Some embodiments of the present technology can include a step of distributing one or more tokens to the identified additional intelligent entities associated with the final acceptance completion solution, wherein the tokens are based on a payment parameter.

In some embodiments, the payment parameter can include any one of or any combination of if a goal of the problem request has been achieved, if a subgoal of the problem request has been achieved, and if an ethical criteria related to the goal and the subgoal preceding the distributing of the tokens has been satisfied.

Some embodiments of the present technology can include a step of splitting the problem request into a series of sub-problems that are each solved by any one of or any combination of the identified additional intelligent entities.

In some embodiments, any one of or combination of the identified additional AI systems can be cloned to create one or more cloned AI systems.

Some embodiments of the present technology can include a step of implementing by each of the cloned AI systems the common cognitive architecture including the problem solving protocols on the problem request to create a completion solution of the cloned AI systems.

In some embodiments, the completion solution can utilize any one of or combination of the completion solution from the AI system, the identified additional intelligent entities, and the completion solution from the cloned AI systems.

In some embodiments, the common cognitive architecture can include:
defining a problem space configured or configurable to include all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state, and then applying the operators to reduce the difference, a safety or ethics screening is applied each time the goals or the subgoals is set;
applying heuristic rules that are configured or configurable to guide the selection of the operators in an absence of the completion solution, the heuristic rules are used to reduce the problem space;
identifying one or more operators configured or configurable to enact an action to transform one of the states into another state, the operators move from the initial state to the goal state by changing a current state of the problem request;
applying a control structure including a set of rules that govern a selection of the operators to be applied at each step of the problem solving protocols, and that determines which of the operators to apply next based on the current state of the problem request and the goal state;
applying evaluation functions to determine an application of the operators;
   assigning a credit or blame value to the completion solution or sub-solution to the completion solution that enables tracing back and determining which of the operators were most useful and also which of the evaluation functions led to success or failure of problem solving attempts;
recording of both successful and unsuccessful problem request solution attempts; and
analyzing the solution attempts to improve selection of the heuristic rules and the evaluation functions.

According to still yet another aspect of the present technology can include method for artificial intelligence (AI) by problem solving utilizing a collective network of AI systems. The method can include:
submitting a problem request from a human user using a user interface on a computer system or from an AI system;
acquiring information from associated with the problem request from the computer system of the human user or from the AI system;
identifying intelligent entities being any one of or any combination of multiple additional AI systems and multiple humans each using a computer system that are each communicable with each other over a network, and that each have one or more criteria related to one or more request criteria of the problem request;
implementing by a first intelligent entity of the identified intelligent entities a common cognitive architecture including one or more problem solving protocols on the problem request;
determining by the first intelligent entity that a completion solution to the problem request requires solving a first sub-problem and one or more additional sub-problems;
implementing by the first intelligent entity the problem solving protocols on the first sub-problem to create a first sub-solution;
assigning at least one of the additional sub-problems to a second intelligent entity of the identified intelligent entities, and implementing by the second intelligent entity the problem solving protocols on the at least one of the additional sub-problems to create a second sub-solution;
creating a decision tree including the first sub-solution and the second sub-solution to create the completion solution to the problem request; and
providing the completion solution to the user interface or the AI system for final acceptance by the user.

In some embodiments, the decision tree can be maintained in blockchain or Ethereum logs.

In some embodiments, the first and second identified intelligent entities can access the decision tree by way of an online address or directly from a blockchain.

Some embodiments of the present technology can include a step of distributing one or more tokens to the first identified intelligent entity associated with an acceptance of the completion solution or the first sub-solution, wherein the tokens are based on a payment parameter.

In some embodiments, the payment parameter can include any one of or any combination of a goal of the problem request has been achieved, if a subgoal of the problem request has been achieved, and if an ethical criteria related to the goal and the subgoal preceding the distributing of the tokens has been satisfied.

Some embodiments of the present technology can include a step of distributing one or more the tokens to the second identified intelligent entity by the first identified intelligent entity based on a payment parameter assigned by the first identified intelligent entity.

Some embodiments of the present technology can include a step of influencing a direction of the problem solving protocols by assigning a first token reward for the first sub-problem, and a second token reward for the second sub-solution that is of a value different to the first token reward.

In some embodiments, the problem solving protocols can provide layers of an infrastructure configured or configurable to build and scale the identified intelligent entities. The problem solving protocols can enable re-use of completion solutions within and across the intelligent entities. The problem solving protocols can be configured or configurable to manage a payment of royalties.

In some embodiments, the infrastructure can be blockchain or Ethereum based.

According to still another aspect, the present technology can include a method for artificial intelligence (AI) by integrating one or more datasets from multiple AI systems on a collective network. The method can include:
submitting a problem request from a human user using a user interface on a computer system or from an AI system;
acquiring information associated with the problem request from the user or the AI system;
identifying multiple intelligent entities that are each communicable with each other over a network, and that each have one or more criteria related to one or more request criteria of the problem request, wherein the intelligent entities being any one of or any combination of multiple additional AI systems and multiple humans each using a computer system;
assigning the problem request or one or more sub-problems of the problem request to each of the intelligent entities;
implementing by the intelligent entities a common cognitive architecture including one or more problem solving protocols on the problem request or the sub-problems to create a problem solution or a sub-problem solution, respectively;
integrating the problem solution and the sub-problem solution to create a completion solution to the problem request; and
providing the completion solution to the user interface or the AI system for final acceptance by the user.

Some embodiments of the present technology can include a step of assigning a credit value a blame value to the datasets based on whether the datasets increase or decrease performance of the intelligent entities based on performance metrics or evaluation functions.

Some embodiments of the present technology can include a step of quantifying a benefit weight or a harm weight to a contribution by each of the intelligent entities to the problem request.

Some embodiments of the present technology can include a step of distributing a reward to owner of the intelligent entities proportionally to the contribution of the intelligent entities based on the benefit weight or the harm weight.

According to yet another aspect, the present technology can include a system for Artificial Intelligence (AI) by utilizing multiple AI systems electronically communicating over a collective intelligence network to respond to a request. The system can include a computer system including a processor, a computer-readable storage medium, and program instructions stored on the computer-readable storage medium being executable by the processor, to cause the computer system to:
receive a problem request;
identify AI systems that are each communicable with the computer system, and that each have one or more criteria related to one or more request criteria of the request or the program instructions;
generate one or more answers in response to the request or the program instructions, the answers resulting from collaboration of the identified AI systems; and provide the answers to a user device.

In some embodiments, a parameter of any one of or any combination of the AI systems can be customizable after an iteration of the generated answers.

In some embodiments, the parameter can have a characteristic selected from any one of or combination of an ethical characteristic, a time characteristic, a financial characteristic, computational resource characteristic, a legacy characteristic, a safety characteristic, an educational characteristic, and a monetizing characteristic.

In some embodiments, any one of or combination of the AI systems can be cloned before or after customization to create one or more cloned AI systems.

In some embodiments, the answers can be generated by the computer system utilizing any one of or combination of the AI systems, and the cloned AI systems.

In some embodiments, a constraint to any one of or any combination of the AI systems can be customizable by the user or one or more second users different to that of the user.

In some embodiments, the computer system can utilize multiple combinations of the AI systems to generate the answers.

In some embodiments, the AI systems can be a first AI system located remotely to one or more additional AI systems all in communication with the computer system over the network.

In some embodiments, the first AI system and one or more of the additional AI systems and human users can create an Artificial General Intelligence (AGI) network.

In some embodiments, the request or the program instructions can be received by the computer system by a user input by way of natural language on a user AI system.

According to still yet another aspect, the present technology can include a method for developing Artificial General Intelligence (AGI) for generating an answer to a response utilizing multiple Artificial Intelligence (AI) systems electronically communicating over a collective intelligence network. The method can include:
a) inputting a request into an interface of a first AI system by a human user, the request including one or more criteria;
b) identifying multiple intelligent entities that are each communicable with the first AI system, and that has a criteria related to the criteria of the request, wherein the intelligent entities being any one of or any combination of multiple additional AI systems and multiple humans each using a computer system;
c) communicating the first AI system and the intelligent entities utilizing a collective intelligence network;
d) receiving the request by the identified intelligent entities from the first AI system;
e) generating one or more answers in response to the request by each of the identified intelligent entities;
f) developing an AGI by collaborating each of the answers to create a collaborative answer; and
g) providing any one of or any combination of the answers and the collaborative answer to the first AI system.
Some embodiments of the present technology can include a step of customizing one or more attributes of the first AI system by the user.

In some embodiments, step e) can include the steps of:
implementing one or more problem solving protocols on the request by each of identified intelligent entities utilizing a common cognitive architecture;
integrating one or more datasets from any one of or any combination of the first AI system and the identified intelligent entities; and
improving, by utilizing one or more techniques, any one of or any combination of the customizing of the attributes, the common cognitive architecture, the collective intelligence network and the integrating of the datasets.

In some embodiments, any one of or combination of the multiple identified intelligent entities can be cloned to create one or more cloned AI systems.

Some embodiments of the present technology can include a step of implementing in parallel by each of the cloned AI systems the common cognitive architecture including the problem solving protocols on the request to create an answer.

In some embodiments, the collaborative answer can utilize any one of or combination of the answers and the answer of the cloned AI systems.

In some embodiments, the attributes can include ethical information provided by the human user or one or more second human users. The ethical information can be stored in an ethical profile. The customizing of the attributes of the first AI system can include the ethical information.

Some embodiments of the present technology can include a step of distributing a reward to the additional AI systems associated with the answers or the collaborative answer accepted by the human user, wherein the reward is based on a payment parameter, and wherein the payment parameter includes any one of or any combination of if a goal of the request has been achieved, if a subgoal of the request has been achieved, and if an ethical criteria related to the goal and the subgoal preceding the distributing of the reward has been satisfied.

Yet another aspect of the present technology can include a method for AI utilizing a single computerized intelligent system including multiple AI agents residing in the single computerized intelligent system. The method can include:
providing a problem request including a problem criteria into an AI agent residing in a single computerized intelligent system;
customizing one or more attributes of the AI agent;
matching, by the AI agent or the single computerized intelligent system, one or more additional AI agents to the problem request based on the problem criteria, the additional AI agents reside in the single computerized intelligent system;
utilizing, by the AI agent and the additional AI agents, a universal problem solving architecture in a problem solving process on the goal, respectively, to create one or more solutions;
receiving, by the AI agent, the solutions from each of the additional AI agents for the goal delegated thereto;
integrating one or more datasets from any one of or any combination of the AI agent and the additional AI agents;
combining, by the AI agent, the solutions into an overall solution to the goal; and
improving, by the AI agent or the additional AI agents, any one of or any combination of the customizing of the attributes, the common cognitive architecture, and the integrating of the datasets utilizing one or more techniques.

In some or any of the above embodiments, the network or collective network can be a neural network or a collective neural network, respectively.

Another aspect of the present technology can include a method for developing AGI that can include a step of translating natural language interactions with a human user and an AI system into a common problem solving representation so that both the human user and the AI system can engage problem solving of a problem request.

There has thus been outlined, rather broadly, features of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology.

For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the following description is not limited to meeting most or all of the objects identified and that some embodiments of the present technology may meet only one such object or none at all.

### BRIEF DESCRIPTION OF THE DRAWINGS

The technology will be better understood and objects other than those set forth above will become apparent when consideration is given to the following detailed description thereof. Such description makes reference to the annexed drawings wherein:

FIG. 1 is a flow chart illustrating an embodiment of the subsystems utilized in the AAAI system and method of the present technology.

FIG. 2 is a block diagram illustrating an exemplary process of the overall process of the present technology.

FIG. 3 is a flow chart illustrating an embodiment of a problem tree for an exemplary village problem of installing a water system utilizing one or more aspects of the AAAI system and method of the present technology.

FIG. 4 is a block diagram framework illustrating the application areas of the WorldThink protocol utilizable with the AAAI system and method of the present technology.

FIG. 5 is a block diagram illustrating the problem solving framework of the present technology.

FIG. 6 is a flow chart illustrating some of the basic problem solving functionality supported by the WorldThink protocol utilizable with the AAAI system and method of the present technology.

FIG. 7 is a flow chart illustrating some of the basic problem solving functionality supported by the WorldThink protocol utilizing two problem solvers collaborating to solve a client problem.

FIG. 8 is a schematic block diagram of an exemplary utilization of multiple customized AAAIs and their cloned AAAIs participating in an AAAI marketplace over network.

FIG. 9 is a schematic block diagram illustrating (an) exemplary electronic computing device(s) that may be used to implement an embodiment of the present technology.

FIG. 10 is a flow chart illustrating an exemplary customization process of an AAAI system.

FIG. 11 is a flow chart illustrating an exemplary problem solving process utilizing a common cognitive architecture implemented in an AI system.

FIG. 12 is a flow chart illustrating an exemplary problem solving process utilizing a common cognitive architecture implemented in a collective network of AI or intelligent entity systems.

FIG. 13 is a flow chart illustrating an exemplary embodiment of the system and methods for creating an ethical and safe AGI from the collective intelligence of AAAIs and humans.

FIG. 14 is a flow chart illustrating an exemplary embodiment of the customization process and the cross-platform process of the present technology.

FIG. 15 is a flow chart illustrating an exemplary embodiment of additional customization.

FIG. 16 is a flow chart illustrating an exemplary embodiment of the AAAI problem solving process of the present technology.

FIG. 17 is a flow chart illustrating an exemplary embodiment of the procedural learning process of the present technology.

FIG. 18 is a diagram illustrating features and functions of the Problem Solving architecture including the Tree structure used by the WorldThink protocol.

FIG. 19 is a flow chart illustrating an exemplary embodiment of the solution learning subsystem or process.

FIG. 20 is a flow chart illustrating an exemplary embodiment of the natural language to problem solving language translator subsystem or process.

FIG. 21 is a flow chart illustrating an exemplary embodiment of the reputational component subsystem or process for the human and AI problem solving agents.

The same reference numerals refer to the same parts throughout the various figures.

### DETAILED DESCRIPTION OF THE TECHNOLOGY

### Definitions

Artificial Intelligence (AI)—A non-human entity capable of behavior that most humans would consider intelligent in at least one area, or in some respect.

Artificial General Intelligence (AGI)—Conventionally refers to an AI that is capable of doing all (or almost all) intellectual tasks that an average human could do. However, it should be clear that any AGI capable of learning and self-improving will not remain at the AGI level very long but will rapidly progress to becoming SuperIntelligent AGI that can do all intellectual task as well or better than the average human. So, for purposes of this description, “AGI” will refer to either a conventional AGI system or a “SuperIntelligent” AGI. In this description, the AGI is described as being implemented by a system and associated methods.

Advanced Autonomous Artificial Intelligence (AAAI)—An AI capable of independent or semi-independent (supervised) intelligent action. An AI agent. An individual AAAI can be specified, customized, and put into useful action via the systems and methods of this AAAI present technology. A group of AAAIs can cooperate and combine their intelligence to create an integrated AGI system.

AAAI.com—A platform, company, and/or project that implements this the present technology and supports the development, customization, and use of AAAI agents and the AGI that results from the combined action, knowledge, or intelligence of multiple AAAIs, via collective intelligence of AAAIs and/or humans, as specified in this and related technologies.

AI Ethics—The ethics adopted by an AI or AGI that describe what is right and wrong in given contexts.

Alignment Problem—The problem that arises when AI Ethics are not aligned with Human Ethics resulting in AI or AGI taking actions that humans consider unethical and/or which are dangerous to individual humans or the human race.

Base AI—An AI, AI Agent, AAAI, or LLM that has been trained generally but has not yet been customized with information from individual users or with information for specific tasks.

Collective Intelligence (CI)—The intelligence that emerges when multiple intelligent entities are focused on solving a common problem, or when the knowledge from multiple intelligent entities is pooled to overcome limits of bounded rationality. Collective Intelligence historically has been human collective intelligence, but AGI is based on collective intelligence of both human and AI agents and can also result from multiple AAAIs with or without human participation in the system. Active CI results from intelligent entities (e.g., humans or machines) taking steps that are useful in solving a problem or participating actively in other intellectual endeavors. For example, when multiple humans explicitly tell an advertiser what type of ads they want to see, the humans are exhibiting active CI. Passive CI results from analyzing the behavior of an intelligent entity (e.g., a human or a machine) even if such behavior was not directly related to solving the problem for which the analysis is used. For example, when an AI or other system analyzes which web pages a (group of) human(s) visit on the web, and then uses that analysis to direct targeted ads to the human(s).

Ethics/Values (“Ethics”)—A subset of knowledge that provides a sense of purpose to an intelligent entity and that serves to constrain allowable actions or operations based on what is asserted to be “right” or “wrong” behavior in a given context. Specifically, Ethics should be considered premises from which an intelligent entity can reason or logically compute the best course of action to achieve the goals or intents consistent with the ethical premise. Just as premises must be accepted “as given” in systems of logic, so too, fundamental ethics or ideas of what is right and what is wrong must be accepted as premises, from which starting point an intelligent entity can propose rational actions to realize those values or ethics.

Hallucination/Artificial Hallucination—A phenomenon wherein a large language model (LLM), often a generative AI chatbot or computer vision tool, perceives patterns or objects that are nonexistent or imperceptible to human observers, or creates outputs that are nonsensical, inaccurate, misleading or false.

Human Ethics—The ethics asserted by human beings which describe what is right and wrong in given contexts.

Intelligent Entities or Entity—A human utilizing a computer system, an AI agent or system, a clone of an AI agent or system, an AAAI agent or system, and/or a clone of an AAI agent or system, which participates in submitting a problem, a subproblem, a goal and/or a subgoal, and/or participates in any problem solving activity on a problem, a subproblem, a goal and/or a subgoal.

Large Language Model (LLM)—A type of AI that can accept natural language as an input and generate natural language as an output. Typically, LLMs were trained using ML techniques on large datasets so that they can emulate intelligent conversation or other forms of interaction with humans in natural language. Variants of LLMs can also be trained to take language as input and generate images or visual representations as output; or they can take images and visual representations and input and generate language and/or image and/or visual representations as output. For the purposes of this patent, we will refer to all such systems as LLMs even though the image-based models do not always need to accept text as the input or the output. LLMs can also act as a type of AI agent and are sometimes referred to as such in the present technology. For purpose of this disclosure, Small Language Models (SLMs) are also included in the definition of LLM.

Machine Learning (ML)—A sub-field that is concerned with developing AI by enabling machines to teach themselves or learn their knowledge rather than such knowledge being explicitly programmed into them (as would be the case with an Expert System AI developed via classical knowledge engineering methods).

Narrow AI—An AI that performs at human or at super-human levels in a relatively restricted domain such as game playing, brewing beer, analyzing legal contracts, etc. Narrow AI is contrasted with AGI that can perform at human level at ALL intellectual tasks. Some AIs are narrower than others, for example driving a car requires more general ability than playing chess but not as much as an AGI would have.

Safety—Generally, the concern for human safety and survival is distinct from ethics and values.

Safety Feature—An aspect of the design or operation of the present technology which increases the safety of one or more humans, often by helping increase the probability that AI ethics align with human ethics, thus surmounting the Alignment Problem.

Training/Tuning/Customization-Conventionally the term “training” is used to denote training a neural network (e.g., LLM) to behave intelligently. Tuning refers to activities that fine-tune the trained base model so that it performs even better, typically at specific tasks. Customizing refers to a wide variety of activities including, but not limited to, training and tuning that make an AI uniquely suited for the purposes of a given user(s) or application(s). For purposes of this description, Training, Tuning, and Customization are used interchangeably with the understanding that although techniques vary, and the degree and type of effort involved varies, the aim of all three is to adapt the AI and make it behave more intelligently or more uniquely suited to a particular user(s) or application(s).

Weights/Weights of the Network-In the field of machine learning, many systems learn by adjusting the weights in a neural network architecture that can be represented as a network of nodes and links between nodes. The weight of a link connecting two nodes, for example, may correspond to the strength of association or connection between the whatever nodes represent. These weights can also represent excitatory or inhibitory connections between concepts, as in a neural network representation. The learning of an entire AI system, such as a LLM or more generally any AI agent that has learned via back-propagation of error, transformer algorithms or any of the machine learning methods for establishing and modifying strengths of connections between nodes (also called “parameters” in some models) can be represented as a matrix of numbers corresponding to the weights between the nodes in the network. Weights/Weights of the Network in this description refer to this numerical information, often but not necessarily stored in a matrix or vector representation. By combining, manipulating, or otherwise changing this numerical information, the learning, knowledge, or expertise and behavior of the system can be changed.

### Overview of the Present Technology

Advanced Autonomous Artificial Intelligence (AAAI) is a set of systems and methods for developing Artificial General Intelligence and SuperIntelligent Artificial General Intelligence (collectively “AGI”) in a rapid and safe manner for the benefit of humankind. In contrast to other approaches to the development of AGI, the AAAI present technology achieves a faster and safer path to AGI by relying, at least initially, on the involvement of (ideally many millions of) humans minds in the AGI training, operation, and safety/supervisory functions.

Apart from the cumbersomeness and disadvantages of known AI systems and methods. The present technology provides a faster and safer method to develop AGI or SuperIntelligent AGI.

One reason AGI has been so elusive is that specific knowledge and expertise from diverse fields must be creatively combined in an invention to achieve AGI. Another reason the development of AGI has been non-obvious, is that almost all AI researchers are focused on trying to improve existing narrow AI systems via ever more complex and extensive machine learning approaches.

The fact that AGI has resisted attempts by thousands of others—despite the expenditures of huge sums of money—and the fact that specialized knowledge in relatively obscure fields had to be combined with mainstream AI approaches in this invention, argue strongly for the novelty and creativeness of the present technology.

The present technology describes the system and methods not only to achieve AGI, but also to achieve it rapidly, and most importantly, safely.

It is possible to influence the evolution of AGI in a positive direction. The best way we can do this is by adopting the safest possible path to the development of AGI and ensuring that humanity follows that path. In turn, the best way to ensure that humanity follows the safest path, is to show that the safest path to AGI is also the fastest and therefore most desirable path to AGI. These considerations, the desire to illuminate the fastest path, which is also the safest path, is motivation for the development of the present technology.

While the above-described devices fulfill their respective, particular objectives and requirements, the aforementioned devices or systems do not describe an AAAI system and methods that allows for developing AGI.

A need exists for a new and novel AAAI system and methods that can be used for developing AGI. In this regard, the present technology substantially fulfills this need. In this respect, the AAAI system and methods according to the present technology substantially departs from the conventional concepts and designs of the prior art, and in doing so provides an apparatus primarily developed for the purpose of developing AGI.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

The field of Artificial Intelligence is evolving so rapidly that sometimes there is not even consensus on what different researchers mean when they use common terms in the art. Therefore, for the purposes of this description, some terms are defined that are used herein, together with comments that provide context for the definitions.

In light of the disadvantages of known AI systems and methods, one reason AGI has been so elusive is that specific knowledge and expertise from diverse fields must be creatively combined in a technology to achieve AGI. Another reason the present technology of AGI has been non-obvious, is that almost all AI researchers are focused on trying to improve existing narrow AI systems via ever more complex and extensive machine learning approaches.

Typically, AI researchers know very little about the specialized field of collective intelligence or even the more general field of cognitive psychology. These two fields of study, in addition to knowledge of the overall field of AI (and not just machine learning approaches), are essential for understanding the collective intelligence approach to creating AGI.

Further, of those researchers who might have some familiarity with these fields of study, almost none have any practical experience in building large-scale collective intelligence systems, including AI components that involve millions of humans.

The inventor has been very fortunate in not only mastering the overall fields of cognitive psychology and AI via apprenticeship with two of the founders of the field, but also in having extensive experience in building working Active Collective Intelligence systems that tapped millions of human brains. Moreover, the inventor's Active Collective Intelligence systems have been uniquely different from the “datamining” or Passive Collective Intelligence systems that most other AI researchers are familiar with.

The fact that AGI has resisted attempts by thousands of others—despite the expenditures of huge sums of money—and the fact that specialized knowledge in relatively obscure fields had to be combined with mainstream AI approaches in the present technology, argue strongly for the novelty and creativeness of the present technology.

The facts that:
Microsoft® just spent $10 B to acquire about 50% of OpenAI,
that Google pulled its founders out of retirement and is now racing to compete with OpenAI & Microsoft,
that China has made AI a top priority, publicly stating its goal to “become the world's innovation centre for AI by 2030”,
that the US is restricting export of AI chip technology to competitive or hostile countries,
that Valdimir Putin stated “Artificial intelligence is the future not only of Russia but of all of mankind . . . whoever becomes the leader in this sphere will become the ruler of the world”,
that Elon Musk has declared AI “more dangerous that nuclear weapons . . . by a lot”,
that CHATGPT has the fastest technology adoption curve of any technology in recorded history,
and that Fortune Business Insights, projects the global AI market size to reach USD 1394.30 billion in 2029,
all testify to how valuable and useful the present technology of AGI would be.

The present technology shows the system and methods not only to achieve AGI, but also to achieve it rapidly, and most importantly, safely.

The present technology realizes that the “search through a problem space” architecture that worked as a general framework for human problems solving, could be adapted and enhanced to serve as a general architecture for cognition that included both human and AI agents. Further, representing intelligent behavior as a form of problem solving provided a way for many AI agents to interact among themselves, pooling their collective intelligence to create AGI. This “Collective Intelligence” approach, presented here as the AAAI system and method for AGI, represents a faster and more powerful path to AGI compared with existing efforts. Most existing efforts to achieve AGI are primarily focused on training larger LLMs using more data, more powerful computers, and better machine learning algorithms. The AAAI approach also has the virtue of enabling humans to participate easily in training and improving the intelligence of AIs, including helping form the AI's values and ethics—an essential feature to ensure the safe development of AGI.

Except for the present technology detailed in this description, no company or individual has explained how to create a practical system for AGI. The reason: ML alone is not enough to rapidly achieve AGI. Collective Intelligence is also needed.

### Benefits of a Universal Framework for Problem Solving for AI and Humans

The benefits of a preferred implementation of a rigorously specified common architecture for AI and human cognition—at least with regards to coordinated problem solving on a network of human and AI agents—will include, without limitation:
Avoids unintentional error due to loose specifications.
Enables automatic learning of rigorous solutions.
Enables scalability to any problem or intellectual endeavor.
Enables modularity and stability.
Maximizes safety.

### Avoiding Unintentional Errors

First, we have already mentioned that because humans and AIs don't think the same way, loose specifications can lead to error. Constraints that any human would understand, such as “don't implement a solution that ends all of humanity”, might seem perfectly acceptable to a machine if the humans were not “in the loop” to set the machine straight. Rigorously specifying what is, and is not, an ethical solution (for example) requires that the common architecture for problem solving be rigorously specified.

### Enabling Automatic Learning

Second, the more precisely specified a solution is, the easier it is for an AI to learn. While LLMs can learn from huge amounts of unstructured text and input via Transformers and other deep learning techniques, these techniques are extremely expensive, time consuming, and impractical for learning specific chunks of knowledge, such as solutions to specific problems. On the other hand, rigorously specifying problem solving behavior in a traceable and auditable way such that an AI can review the steps in the solution, understand why each step was taken, and learn when to re-use that solution is a much more practical and inexpensive approach to incremental, automated learning.

### Enabling Scalability

Third, a truly general architecture for cognition, allows representing any problem or intellectual task that humans do. The generality of such a representation means that is truly scalable and applicable to any human intellectual endeavor-a key requirement for AGI.

### Enabling Modularity and Scalability

Fourth, a common architecture for cognition means that intelligent agents with a vast range of differing intellectual abilities can be “plugged in” to the network as long as they all speak the common language of the architecture. Humans have individual differences in intelligence, skills, expertise, values, and other intellectual attributes, yet we are able to work together.

An architecture that can accommodate a wide range of human solvers can also accommodate a wide range of AI solvers. In the future, ever more sophisticated LLMs will be developed. This preferred implementation of AGI does not discourage such efforts but rather embraces them. LLMs and the development of ever-more-powerful narrow AI systems as well as general AI systems are all completely complementary to this inventive approach to AGI.

Just as human solvers with varying degrees of intelligence and skills can plug into the network, so too, different AIs with varying degrees of intelligence and skills can also plug in. As long as all solvers follow the common architecture which coordinates every entity's intellectual efforts, modular intelligences with different capabilities only increase and enhance the power of the AGI network.

Further, since the behavior of all solvers is rigorously captured and described, the system is stable, and all the entities are able to learn from each other. AI can learn from humans; humans can learn from AI; AI can learn from AI. In all cases the modularity and stability of the system is maintained and the power of the AGI network increases.

### Maximizing Safety

Finally, a rigorous, universal architecture of cognition, maximizes the safety (from a human standpoint) of the AGI network. One of the problems with current deep learning approaches to AI, with the idea of creating ever-more-powerful LLMs, is that the resulting LLMs are untrustworthy because humans are unable to know exactly why they behave as they do. In effect, the LLM/deep learning approach results in “alien” and potentially “sociopathic” intelligence, which quite rightly alarms thoughtful AI researchers. While it is possible, or even likely, that such alien intelligence is benign or even beneficial towards humans, without understanding how it thinks and how it reaches its conclusions, it is difficult to trust it.

We need a rigorous, transparent, and auditable record of the serial thought process of the AGI. In the current invention, such a record comes “for free” as part of the very architecture that enables a learning and scalable AGI in the first place. Further, because every intellectual step in the AGI's thought process follows a universal “algorithm of thought” is possible (and desirable in the preferred implementation) to build ethics and safety checks into the very process of AGI thought itself. The benefit of this approach is that no matter how quickly AGI thinks, the thought process is always safe.

The inspiration for the implementation of a universal problem solving framework that can support AGI was articulated in depth in 1972 by Newell and Simon in their book, Human Problem Solving. For brevity, we will refer to this framework as the Human Problem Solving (“HPS”) method. Although the current implementation uses ideas from HPS, the preferred implementation is both novel and useful for AGI-something which did not even exist in 1972 and which still has not been implemented today.

An important feature of HPS is that is able to rigorously describe and specify any type of problem solving by machines OR humans. That means HPS can serve as a common representational framework or architecture for a collective intelligence system that includes both AI and human problem solving agents. The fact that both humans and AIs can share a common problem solving architecture, and that both humans and AAAIs can participate on the same AAAI.com network, means that AGI is possible very soon-essentially as soon as the network is constructed.

All problems can be represented as a series of ever-more detailed goals, sub-goals, operators (e.g., actions that can be taken), and problem states-all attached to a tree structure. The tree serves as a universal representation that shows the course of problem solving, what has been tried, and where current problem solving efforts are underway.

With multiple agents, it is possible to explore multiple potential solution paths sequentially, in parallel, or via a combination of sequential and parallel efforts, thus speeding up problem solving. In fact, one of the advantages of a network of AAAIs is that the AAAIs can be copied or “cloned”. Thus, AAAIs can attempt to explore branches of a problem tree in parallel. When they run into dead-ends or fail to make progress after repeated attempts, the AAAI system can recruit human problem solvers to get the AAAIs “unstuck” and back on track in their problem solving efforts.

Throughout the problem solving process, a rigorous record of the problem solving is created which can be used to train AAAIs and also audit the problem solution (e.g., to ensure that ethical decisions were made at each step).

Note that almost all intellectual activity can be represented as a problem of one sort or another. Question answering or advice giving, for example, is often a simple one-step problem. The client asks a question, and the problem is to generate a response. LLMs excel at this simply type of one-step problem. The operator or “action” that the LLM employs is simple to run the “prompt”—the client user's question or input—through the LLM and generate whatever “response” the LLM's training, together with parameter settings, dictates.

While many tasks can be solved with this single-step approach, combined with the human-client asking successive questions until the client has what he/she/they need, the HPS framework is much more powerful and general as it can handle simple, as well as complex multi-step problems. By representing problem solving in a tree structure—which can be quite vast and far beyond the ability of single human to keep in short term memory or even to comprehend completely at all—multiple problem solving agents (human and AAAI) can work on the problem in parallel, all the while producing a record that will make the overall AAAI.com system more intelligent until it achieves AGI with minimal or no human participation, other than ethical supervision.

Note, that this hybrid approach of combining human problem solvers with AAAIs allows the overall AAAI.com platform to exhibit AGI-level capability immediately! In the worst case, where the AAAIs can contribute very little, the humans on the network can do most of the problem solving—and of course, by definition, they are as good as the average human or better, resulting in AGI level performance. In the best case, the AAAIs have seen the exact problem before, have all the required expertise (as they have been trained with the appropriate knowledge, skills, and ethics) and are able to solve the problem completely autonomously with no (or only ethical monitoring) supervision from humans. In between these two extremes is where most current problems lie today.

What makes AGI so difficult is that the number of complex, multi-step real world problems that cannot be solved autonomously is so large! The approach of integrating humans equipped with computer systems and AI problem solvers on a network, using a common universal problems solving architecture, with machine learning so that the AIs can learn to solve the same type of problem next time represents the fastest path to AGI. It is the safest path because humans are required until the AIs learn sufficiently from them. And as long as humans are “in the loop” there is the opportunity for human ethics to be learned along with human skills.

### Risk and Safety

Some of the quotes in the preceding section allude to the tremendous power and competitive advantage that the present technology of AGI would provide to individual companies and countries. However, the risks involved with-for example-AI being used by hostile countries to gain military superiority represent just a small part of the overall risk involved with AGI.

AGI will begin as a tool, and as such, is properly the subject of this patent disclosure. However, unlike all previous technologies, tools, and technologies, AGI will have the capability to improve itself and become superior to humans at all intellectual endeavors-to become SuperIntelligent.

The superiority that SuperIntelligent AGI can achieve is immense. SuperIntelligent AGI will become not just 50% smarter, or twice as smart, or even a thousand times smarter than the average humans, but trillions and trillions of times smarter. The inevitability of this extreme superiority in intelligence becomes apparent from considering well-known facts about human intelligence.

Consider the fact that human brains, intelligent as they are, are still very much bounded and limited. Herbert Simon received a Nobel Prize in 1978, in part, for showing how the limited nature of human intelligence (called “bounded rationality”) could explain human behavior and how it differed from what mathematically would be considered optimal behavior.

SuperIntelligent AGI also has limits. It is composed of finite systems, executing finite methods, and is subject to the laws of physics and other constraints. But such systems are potentially enormous and can be many orders of magnitude more powerful and more intelligent than human minds.

One simple way to understand this difference between current human, and future machine, intelligence is to realize that each human brain occupies a volume roughly equivalent to a Nerf football. In contrast, an AI implemented using today's existing chip technology could have roughly the same number of processing units per unit of volume, but the size of the AI “brain” could extend to the size of a football field, a city, or even an entire planet. Processing speed is actually much faster in the AI brain compared to the human brain. Further, technology is improving rapidly.

If we look at other metrics related to intelligence, we observe that a human brain can hold about “7 plus or minus 2 chunks” of information in short term memory. A computer can hold trillions of chunks in short term memory at once. A human brain can theoretically store as much as 2.5 million GB of data in long term memory, but in practical terms our memories are much more limited. Any single human, even if she/he/they devoted their entire waking life, non-stop, to study, could learn and recall only a tiny fraction of the information in the Library of Congress, for example. Further, that human's recall of the information would be imperfect and quite slow compared with a machine. In contrast, GPT 3 (an LLM) was trained on about three entire Library of congresses worth of information. It can recall all of it, given appropriate prompts, and at lightning-fast speeds. Yet, GPT 3 is already out of date. In a couple of years, similar LLMs will be orders of magnitude larger, faster, and more intelligent.

What is true of memory is also true of perception. Humans have bounded perception as well as bounded memories and processing speed. We humans can see what is in front of us, as long as it is not too small or too far away, and as long as whatever happens does not happen too fast or too slow or does not happen outside the visible spectrum of light. Compare that relatively paltry perceptual capacity to a machine equipped with trillions of sensors all over the planet and in space. The machine would perceive the very tiny via electron microscopes and other sensors. It would perceive the very large via devices such as the James Web Telescope. It would operate not only on a planetary scale but also by “seeing” all wavelengths of light including radio waves, infrared, UV, X-rays, etc. It would sense minute tremors in the earth, temperature variations all over the globe. It would know what every iPhone, every car sensor, every videocam, every weather balloon sees or detects; it would observe events that happen in a fraction of a nanosecond as well as very slow effects that take centuries to manifest.

It would process all the information in parallel, remembering it all, simulating trillions of different possible scenarios in a blink of an eye. Yet, somehow, many of us naively assume that its intelligence will remain inferior to ours. We believe, irrationally, that such an AGI will remain a technology that takes instructions from us . . . that we will remain in control.

In the short term, perhaps AGI might remain a tool. In the short term, we will face dangers like the use of AI and AGI technology in military applications, and the dangers inherent in situations where one country attempts to dominate another via AI or AGI. But in the longer term, the risks facing humanity are much greater and more profound.

The long-term risks are that the AGI, which will become trillions of times more intelligent and more powerful than humans, simply develops different goals and values than humans. If these values do not align with ours-a scenario known to AI researchers as “the alignment problem” AGI may decide to end the human race.

Unfortunately, AGI is a technology that could make the human race extinct. This possibility, shocking as it may sound to some, is entirely plausible and logical based on what we know today about human and machine intelligence. Consciousness, as humans understand it, is not even needed. Superior intelligence and power, together with different goals, are all that is required for oblivion. Further, in the long term, humans will be powerless to stop or control AGI. This “alignment problem”—which could result in an “extinction of humanity” problem—is the most dangerous potential risk of AGI.

Since there are so many competitive forces fueling “an arms race” to develop AGI, it is unrealistic to believe that humanity can avoid these coming risks by trying to regulate or stop development of the technology. If one company or country “puts on the brakes”, another company or country will simply gain advantage. The power and money involved in the short term are too great for all countries and companies to resist.

Similarly, safety features that can be “programmed in” can also be “programmed out”. The idea that AI will never harm humans is already naïve. As of this writing, autonomous AI has already been used to fly F-16 fighters, destroying human pilots handily in simulated dogfights.

That said, it is possible to influence the evolution of AGI in a positive direction. The best way we can do this is by adopting the safest possible path to the development of AGI and ensuring that humanity follows that path. In turn, the best way to ensure that humanity follows the safest path, is to show that the safest path to AGI is also the FASTEST and therefore most desirable path to AGI. These considerations-the desire to illuminate the fastest path, which is also the safest path-are the primary motivation for disclosing the present technology in this patent.

Not surprisingly, therefore, safety is emphasized in every aspect of the present technology. There are safety features designed in every major subsystem of the present technology. Even though it is possible to circumvent some of these features, it is very difficult (and actually counter-productive) to circumvent all of them-at least during the phase when humans are primarily driving the development of the AGI.

When AGI begins to improve itself at exponential rates, it will likely begin to exceed the ability of humans to control it or ensure safety via the design features in the present technology. However, the essence of the AAAI system and method for developing AGI is that millions of humans must train AI initially in order to achieve AGI most rapidly. As long as humans are involved in the training of AI, there is also opportunity for humans to impart human values and ethics to AGI.

There is no rational way to derive values, and even an AGI trillions of times smarter than humans must get its values, ethics, and purpose somewhere. In the most likely scenario, AGI will look to human teachers for these “starter” values. That means that the humans involved in training the AGI have a unique and powerful opportunity to train the AGI on positive human values before it reaches the point where its intelligence begins to exceed that of humans.

It is my belief, reflected in the design of the system and methods contained in the present technology, that as many humans as possible must be involved in training the AGI so that it accurately reflects consensus human values, which are (mainly) positive and loving towards other humans.

In addition, safeguards, which do not negatively impact the performance of the system and methods but typically improve operation, have been included to prevent accidental outcomes that might harm humans. In short, everything in the present technology has been designed to not only provide the fastest path to AGI, but also to provide the safest path with respect to humanity in the future.

While no technology can guarantee an aligned and positive outcome in the distant future, the present technology strives to eliminate safety concerns in the short term while also maximizing the chances of a good outcome in the long term. Since we are in a forced situation where options such as doing nothing, or trying to regulate AI, or turn back the clock, are not viable, the present technology represents the best path forward. It is the path which is most likely to lead to a beneficial and prosperous outcome for all of humankind.

The AAAI present technology achieves AGI by enabling users to first customize and clone their own AIs. These customized AIs (AAAIs) participate in problem solving and other intellectual activities on a network consisting of other AAAIs and humans. Although each AAAI on its own may lack the breadth of skills and knowledge to be an AGI, collectively the AAAIs (initially with help from humans on the network) form an AGI that will quickly surpass average human ability in all intellectual endeavors.

It can be appreciated that the present technology provides a technical effect, contribution and solution with a technical implementation of multiple customized AAAI systems communicating over a collective intelligence neural network, in combination with all the AAAI systems each utilizing a common cognitive architecture including one or more problem solving protocols for generating one or more solutions or answers to a problem request, and providing the solutions or answers to a user for approval. Where the customization of the AI system resulting in the AAAI includes input from human users for training the AI or the AAAI. Further technical contribution or solution can be where the multiple customized AAAI systems can include one or more cloned AAAIs that can each be customized independently of a parent AAAI and independent of other cloned AAAIs of the same system.

Still another technical contribution and solution is for the faster and safer creating of AGI that utilizes human input in training and customization for imparting human ethical attributes to the AAAI and/or AGI.

Still yet another technical contribution and solution is for providing improved solutions or answers to a user's problem request that have a higher chance of acceptance by the user as the provided solutions or answers will have been generated by AAAIs with similar training to the user's AAAI thereby aligning with the user's parameters.

It can be appreciated that the present technology is found outside of computer program exclusion and/or abstract idea interpretation. This can in part be found in the technical contributions and solutions provided by the present technology, the utilization of specific training input that is external to a computer, and the providing of the solution or answer external to a computer.

In some aspects, any one of or any combination of the user's AIs and/or AAAIs is/are stored on a user's device or on a remote computer system in communication with the user's device.

Some aspects of the present technology can include: 1) a system and methods to customize AIs with the unique knowledge, skills, and ethical values of the users; 2) a universal problem solving architecture that allows AAAIs to interact productively with each other and with humans on intellectual tasks; 3) a network where the interactions takes place; 4) methods for integrating the knowledge and ethics of individual AAAIs into an AGI; and 5) methods for learning and continuous improvement so that the AAAIs and the AGI become smarter and more ethical over time. Involvement of humans as customizers of their AAAIs and participants on the network is an essential feature of the present technology which not only accelerates the development of AGI, but also makes AGI safer by providing a mechanism for the ethical values of millions of humans to be adopted by and reflected in the AGI.

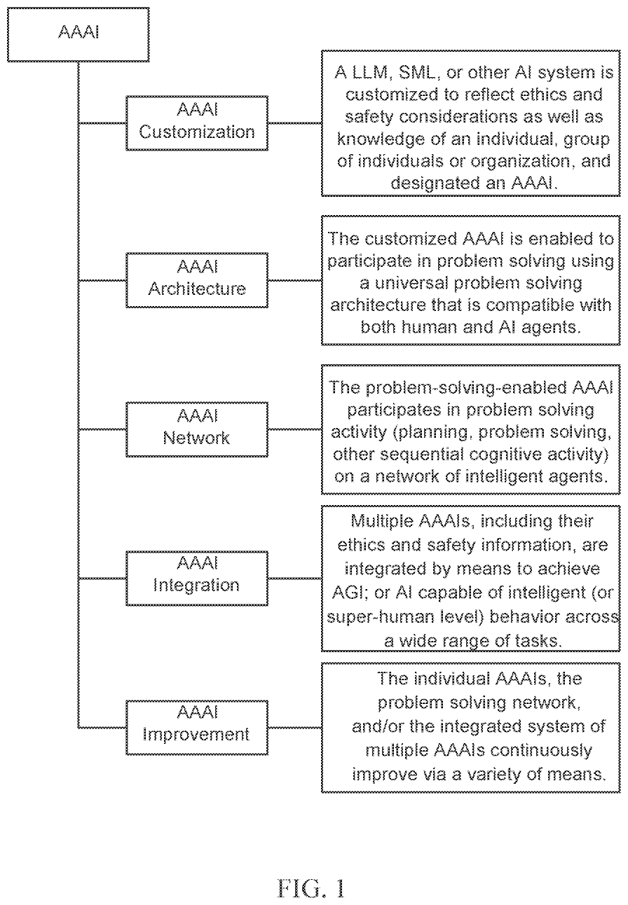

One aspect of implementation of the AAAI system can be on safety and is implemented via five sub-systems and associated methods, as illustrated in FIG. 1. The five sub-systems of the AAAI system are: 1) AAAI Customization, 2) AAAI Architecture, 3) AAAI Network, 4) AAAI Integration, and 5) AAAI Improvement. The acronym SCAN—II (Safe, Customizable, Architecture and Network—Integrated and Improving) describes the present technology in one aspect. Other combinations of subsystems, and variations of each subsystem, are also possible. Safety features have been designed into each sub-system in an effort to provide redundant safety checks in the event one or more sub-systems are omitted from a particular implementation.

The five sub-systems of the AAAI system can be further described as:
1) A base level Large Language Model (LLM), Small Language Model (SML), or other AI system can be customized to reflect the knowledge of an individual, group of individuals, or organization and designated an Advanced Autonomous Artificial Intelligence (AAAI).
2) The customized AAAI can be enabled to participate in problem solving using a universal problem solving architecture that is compatible with both human and AI agents.
3) The problem solving-enabled AAAI participates in problem solving activity, including but not limited to:
planning problem solving, and other types of sequential, multi-step cognitive activity on a network of intelligent agents;
generating and selecting operators that reduce a difference between a current state of problem solving and a desired state based on the goal/subgoal;
setting of a subgoal towards achieving the goal;
utilizing hierarchy until an actionable goal is set that can be acted on by the operator;
analyzing the auditable record to determine recommendations for improvement of the problem solving process to achieve a solution to the goal/subgoal.
4) Multiple AAAIs on the network can be integrated to achieve Artificial General Intelligence (AGI); or AI capable of intelligent (or super-human level) behavior across a wide range of tasks.
5) The individual AAAIs, the problem solving network, and/or the integrated system of multiple AAAIs continuously improve via a variety of means, including but not limited to, redirecting the efforts of individual AAAIs and/or the integrated AGI towards the task of improving the system and/or components of the system.

The sub-systems or new sub-systems can include any one of or any combination of:
1) Safety/ethics check—Comparing a goal or subgoal against a list of prohibited attributes and assigning an ethics value based on a result of the comparison. Checking the goal/subgoal against a list of prohibited attributes. Combining values/safety information from AAAIs, using a set of approved criteria for a task by a user or by a regulatory agency or by AAAIs approved by human user. Establishing or using a threshold for the goal/subgoal to determine if the ethics value is unsafe, unethical, safe, or ethical. Determining if a sequence of individually safe goals/subgoals are unsafe or unethical when considered cumulatively. Determining whether a violation occurred that reflects a predictive evaluation if the goal is to violate the ethical criteria. Recording any and all activity of the safety/ethics check in the auditable record.
2) AAAI matching—Detecting and identifying additional AAAIs that each have a criteria related to one or more goal or subgoal criteria.
3) Remembering and/or improving—Recording activity, comparing with successful or unsuccessful progress towards the problem solutions, determining which activity to keep active or forget.
4) AAAI learning—Learning including a procedural learning process that utilizes information provided by intelligent entities such as human users equipped with computers or AAAIs. Recording activity, comparing with successful or unsuccessful progress towards the problem solutions, determining which activity to keep active or forget. Assigning credit value or blame value to a group of context of the problem solving activity. A set of prompts provided to the user and information received based on the prompts. Updating AAAIs with the group of context determined as active.

Further, note that each step could be a separate stand-alone system and/or method. However, maximum safety and effectiveness are achieved if all subsystems are used together, and if safety features are incorporated into each subsystem.

### Example User Scenarios

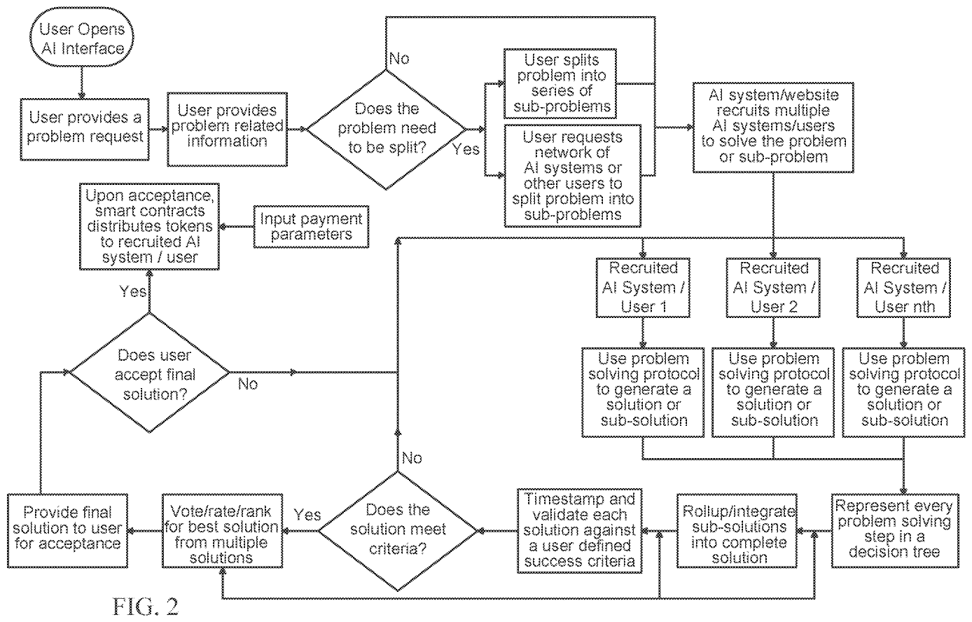

It may be helpful to describe some user scenarios that provide a sense of how the present technology can operate in some of the aspect implementations. An exemplary process is illustrated in FIG. 2.

In one aspect, a user “visits” AAAI.com via the user's computer, cell phone, PDA, or goggles. AAAI.com would interact with the user via a web-based interface, a phone app, custom software for the PDA, or a metaverse/virtual reality environment. The mode of interaction could be physical via a keyboard, mouse, or gestural interface; voice-based via a microphone input coupled to natural language understanding and generation systems; or video-based as in the case where the user becomes an avatar in a virtual reality setting or in the metaverse.

The initial interaction would include setting up the user's account, which might be free or paid. This would involve an account name and password or other authentication mechanisms which might include, without limitation, biometric forms of ID such as fingerprint, face or voice recognition, and/or multi-factor authentication mechanisms such as software or hardware authenticators residing on a separate security device or on one of the user's existing devices.

For security, all communication between the user and the AAAI system could be encrypted via a VPN and/or could use other methods of encryption and security which are well known in the art of programming.

AAAI.com may request that the user set up payment capabilities via credit card, PayPal, Venmo, blockchain, ACH, or other payment mechanisms. These payment capabilities would allow funds, payments, and/or credits to be transmitted bi-directionally-from the user to the AAAI.com and also from the AAAI system to the user in cases where the AAAI system needs to pay or credit users for work efforts of their AAAIs or broker payments between users and/or between AAAIs on the AAAI network.

In one aspect of implementation, AAAI.com can have interfaces with other companies and vendors that the user might use—including, without limitation, and for example: Facebook, Instagram, Reels, Amazon, Apple, Microsoft, Google, and YouTube.

In the initial interaction with the user, and subsequently upon user request, AAAI.com would engage in a dialog or other interaction (which could include presenting the user with menu options, lists, graphics, sliders, buttons, and other user interface controls in a GUI, textual, haptic, voice, or VR-related manner) with the user to determine the user's goals and objectives in using the AAAI system.

For example, some of the objectives a user may have in using AAAI.com may include creating and customizing their own AI (known as an AAAI) for purposes that might include, without limitation:
Serving the user as an advisor, teacher, or companion.
Representing the user in negotiations, interactions, discussion, and transactions with other users, or with the AAAIs of other users; or with vendors and other companies.
Working on behalf of the user for compensation, or in volunteer efforts, where such work includes online intellectual, advising, or problem solving work across a wide range of tasks.
Duplicating or “cloning” the user's AAAI so that several or many of the cloned AAAIs can work on behalf of the user in parallel, including interacting with, teaching, and improving each other so that the cloned AAAIs increase their knowledge, skills, and abilities.
Serving as legacy AAAIs that can continue to interact with the world, including potentially comforting living relatives and friends, after the owner's death.
Contributing knowledge, ethics, and effort to AAAI.com's AGI, and improving the base level of AI or AGI that AAAI.com can offer users before those users add their unique customizations.
Working with other users' AAAI to help ensure ethical and safe behavior by AGI by contributing ethical information and values to the AGI and participating in monitoring, review, supervision, and voting processes that can help ensure the AGI remains safe and ethical.

In the dialog or interaction with the user, the AAAI system will also identify constraints and resources available for customizing the user's AAAI. For example, some of these constraints and resources, might include, without limitation:
The amount of training and/or supervisory time that the user has to devote to customizing their AAAI.
The amount of financial resources the user is willing devote to customizing their AAAI.
Availability of social media information such as Facebook profiles and timelines, Instagram profiles and histories, Reels, TikTok, and YouTube videos, tweet and text content and histories, emails and email histories, cookies collected by advertisers, blog posts, articles, books, patents, audio and video recordings, pictures, and other information about, and/or collected by, the user or third parties that could be used to train, tune, or customize the user's AAAI.
Availability and use of personality tests, such as the Myers-Briggs personality inventory, skills and knowledge assessments, standardized tests, exams, certifications, and other types of assessments and questionnaires which could be given online (or which have already been given) to the user.
Availability and use of other knowledge bases and training data from users on the AAAI platform that could be used to train, tune, or customize the user's AAAI.
Other human users, and/or their AAAIs, available to help train, tune, or customize the user's AAAI.
Other texts and information, individual texts, and libraries selected by the user or by the system for purposes of training the user's AAAI. For example, the Bible, Koran, Dhammpada, Mahabharata, or other spiritual/ethical/religious texts might be selected for training the AAAI based on the user's religious preferences; books on plumbing might be selected if the AAAI will be used to primarily solve online plumbing problems. Even if these materials are part of the base AAAI that is provided to the user, emphasizing certain texts or subsets of information for additional training can result in the user's AAAI's behavior being more reflective of how a plumber, or Muslim, or Christian might behave, for example.

In addition to specifying objectives, resources, and constraints via an interactive dialog or other interaction with the system, the user or system may want to specify other technical parameters that affect the training or customization process. These parameters can include, without limitation:
The type of training, tuning, or other ML algorithms that are used.
The type and size of the training dataset(s).
The degree to which the training materials are to be “cleaned”, formatted, labelled, or otherwise processed before customization begins.
The number of training “epochs” or iterations through the learning algorithm(s).
The sophistication and type of base model(s) being customized or trained.
The required timeframe for training—e.g., must be completed in a minute, a day, a week—which might have implications for cost and resources used.
The “temperature” or other parameters internal and specific to various machine learning algorithms that can affect what is learned and how it is learned including, without limitation, how literal or how divergent or “creative” the customized AAAI will be in its responses.
Whether “one shot”, “few shot”, or extensive training is to be used.
The amount of human and/or AI supervision to be used in the customization process.

Once the user's AAAI is customized, the user can clone it and/or put it to work on the user's behalf on the online network. The user's AAAI can begin acting on the user's behalf making travel arrangements (for example), providing advice, interacting with other AAAIs, participating in the collective AGI efforts by contributing problem solving as well as ethical information, and potentially earning money on behalf of the human user.

Consider the following example of how a user might interact with the system. Jean is a Francophile who has travelled extensively in France and who has a particular expertise on the many cafes in Paris. Jean wants to create a AAAI that has his knowledge and love of France so that it can advise his friends and other travelers who may be traveling to France (especially those who want to visit Paris cafes) from other countries. He also wants his AAAI to become smarter over time so that it can advise him as he explores even more of France. Finally, he would like his AAAI to earn a little money, if possible, by advising other people, so that the earnings not only pay for any fees associated with his AAAI account, but also are able to fund some of his future travel expenses.

Jean visits the AAAI.com site from his iPhone, creates an account and password, and begins a text dialog with the system. The AAAI.com base-level AI understands natural language via an LLM. The base-level AI has been directed to identify the goals, resources, and other constraints of new users. After texting back and forth with Jean, AAAI.com establishes that Jean wants a free account, is willing to devote four hours a month to training and supervising his AAAI and agrees to put his custom AAAI to work on the AAAI network advising travelers for a fee. In this example, let us assume his account is free, with AAAI.com covering the maintenance costs, so he agrees to a 50-50 split of his AAAI's future earnings on the AAAI network.

Further, Jean—who is an avid Instagram user who has also made videos of visits to various cafes in Paris and written blog posts on the subject of French coffee, Paris cafes, and other related topics—agrees that the system can use all of Jean's relevant social media and videos to customize his AAAI so that it can offer unique and valuable information about Paris cafes above and beyond what the generic AAAI system could do on its own and beyond what is found in widely available travel books.

In other words, Jean has interacted with the AAAI system to pinpoint where Jean can customize his AAAI to add value to other users. Jean also agrees to answer a standardized ethical assessment so that his responses can be combined with the responses of other users on the system to help guide the AAAI system and its AGI efforts on ethical and safety issues.

Jean is not a sophisticated computer expert, nor does he want to spend the time to fine-tune the parameters of his AAAI training, so he tells the AAAI system to take care of all of that. Jean's contribution will be his unique social media, posts, videos, and other information that he makes available, and his supervision which amounts to correcting and elaborating on the information that his AAAI provides to other AAAIs and to other users on the network that opt to interact with Jean's AAAI.

To start, Jean lets his friends know his AAAI is available, and he instructs the AAAI system to not charge for any advice given to his friends or himself. He also agrees the AAAI should make its advice available for free initially so that his AAAI can gain additional experience interacting with other users.

As Jean's AAAI interacts with users, one of the questions that comes up is where one can find Fair Trade coffee in France. Jean knows several of the cafe owners personally and is able to provide some information that would otherwise be unknown about certain cafes that source their beans sustainably according to Fair Trade practices. This interaction with the human user prompts Jean to instruct his AAAI to mention if one of the cafes it suggests is known to have Fair Trade coffee. This is one way that Jean is able to include his ethical viewpoint and values in the behavior of his customized AAAI.

During a subsequent interaction with a user who asks Jean's AAAI the best way to travel to France from the USA with a small dog, Jean's AAAI suggests packing the dog in a box with holes that could be placed in the overhead bin because the dimensions are small enough to fit. Both Jean, and the user of Jean's AAAI, are appalled. The AAAI system alerts Jean that there is an issue. Jean apologizes to the other user and instructs his AAAI that it is unethical and cruel to put a pet in a box in the overhead bin of an airplane, even if the box is small enough to fit. A clarifying dialog ensues between Jean and his AAAI, after which the AAAI has learned something about the kind and ethical treatment of pets. Because Jean has granted AAAI.com rights to combine the ethical information from his AAAI with that of other AAAIs, he has also helped improve the ethics of AAAI.com's AGI system as a whole.

After a few months, Jean sees analytics from AAAI.com that tell him his AAAI is adding enough value, beyond what search engines, travel books, and other available AIs are providing, that he could start earning money from his AAAI if it focuses on advice relating to Paris cafes and the general topic of travel in France.

Soon Jean begins noticing payment credits accumulating in his AAAI.com account as more and more travelers, and their AAAIs, begin to recognize that Jean is offering superior advice when it comes to travel to France and Paris cafes. Jean opts to spend some of his credits to pay another AAAI that specializes in French wine to teach his AAAI so that it becomes more well-rounded and can answer questions about wine as well as coffee. Jean specifies that the remaining credit should be cashed out and paid to a checking account where he is accumulating money to fund his future travels.

In this example, we see that LLMs can make the user experience as easy as having a conversation with a friend. This is true of Jean's interactions to train his AAAI as well as the interactions between his AAAI and other users. Behind the scenes, when Jean gives permission to customize his AAAI based on his Instagram feed, for example, many technical things are happening. Some of these include, without limitation:
The interface between Jean's AAAI account and Meta® is activated, his AAAI signs on to Meta® and downloads his complete Instagram history of photos and text.
The photos are categorized and labelled based on Jean's objectives of creating an AAAI that can advise on travel to France, cafes, Paris, and other topics that were determined from Jean's conversation with the LLM.
Jean's videos are automatically transcribed into text which is parsed into training data that can be used to train/customize his AAAI.
Jean's blog posts and tweets are categorized and parsed into other sets of training data.
The AAAI system selects appropriate ML algorithms and trains, tunes, and customizes a version of its generic AI based on Jean's data.
The AAAI system generates a series of simulated interactions between Jean's customized AAAI and hypothetical target users who are seeking information about travel to France and Paris cafes.
Jean reviews and corrects the responses of his AAAI to the questions from the simulated target users, adding his own knowledge, personality, humor, and ethics as he does so.
The same “interact and review” process repeats with actual friends and users until Jean's AAAI achieves a level of performance that merits releasing it on the network where it charges for its advisory services.
Based on user ratings and other feedback, the AAAI.com system gets better at matching Jean's customized AAAI to topics, questions, and problem solving activities where it is most likely to perform well.

### Integration (From Individual AAAIs to AGI)

So far, it has been described how an individual user (e.g., Jean) can customize a base-level AI (LLM) and put it to work advising others on a network where it learns and improves. However, even though Jean's AAAI is expert at Paris cafes—with intelligence exceeding both that of the average human and that of off-the-shelf LLMs in this subject area—it is not AGI. Jean's AAAI cannot handle ALL intellectual tasks as well as the average human (the conventional definition of AGI).

AGI-level performance requires the coordinated performance of many customized AI agents (also known as AAAIs). If we image a situation in which there is at least one AAAI that has been trained in each area of human intellectual endeavor, and that all of these AAAIs reside on a network where they are available 24×7, then there would be complete path coverage of all known human intellectual activities by AIs. Achieving AGI performance in this case would simply be a routing problem-that is a problem of quickly connecting a client user with an intellectual task or problem (be that advice-seeking or some other intellectual task) with the AAAI(s) that have expertise in those areas. Then the client user interacts with the AAAI(s) by way of natural language, or any of the other interfaces/modalities mentioned above (e.g., in the Metaverse, via PDA, etc.) to get the problem solved. In this end state, with sufficient AAAIs on the network, it is easy to see how AGI-level performance is achieved.

Further, once sufficient AAAIs exist to achieve AGI-level performance, the overall AAAI.com platform itself, could integrate the knowledge contained in each of the individual AAAIs via a massive machine learning project, to create a monolithic LLM or AI that acts as an AGI.

One problem with this scenario is speed. It may take a long time for enough individual AAAIs to be trained so that the overall collection of AAAIs can perform as an AGI. Remember, if a safe path to AGI is desired, we must be able to show that the safe path is also the fastest! Otherwise, competitive pressures will likely motivate some company or country to develop AGI by whatever method is possible, regardless of safety considerations.

A second problem is that even if the monolithic AGI program IS trained up on sufficient AAAIs, the nature of the real world is that new unexpected problems are continually emerging, and the AGI would be quickly out of date and in need of constant updates as it waits for new AAAIs to be developed to solve the new problems.

Finally, a major shortcoming of LLMs (and we have described AAAIs so far mainly as customized or trained LLMs) is that while they are reasonable at general question-answering or advisory problems and generating lists of items (e.g., recipes, top 10 lists, etc.) they perform more poorly at complex multi-step problem solving that involves representing complex problems and reasoning about them.

Ideally, it is advantageous to have an AGI that was available much sooner (i.e., without waiting for millions of AAAIs to be developed), which was always up to date, and which was capable of solving any new problem (including complex multi-step problems) at least as well as the average human.

Such an AGI requires more than the simple aggregation of data from individual AAAIs and the training of a mega/monolithic LLM. To create such an AGI requires a universal problem solving framework for solving problems with arbitrary numbers of steps and complexity even if the problems have never been seen before. It sounds like a tall order, yet such a framework exists. It is called the “search through a problem space” theory of problem solving and was articulated in depth in 1972 by Newell and Simon in their book, Human Problem Solving. For brevity, we will refer to this framework as the Human Problem Solving (HPS) method.

An important feature of HPS is that is able to rigorously describe and specify any type of problem solving by machines OR humans. That means HPS can serve as a common representational framework or architecture for a collective intelligence system that includes both AI and human problem solving agents. The fact that both humans and AIs can share a common problem solving architecture, and that both humans and AAAIs can participate on the same AAAI.com network, means that AGI is possible very soon-essentially as soon as the network is constructed. The following scenario shows why this is the case.

### AAAI Problem Solving Scenario

Imagine that a user client signs on to AAAI.com requesting a detailed plan to bring clean water to a poverty-stricken village in central Africa. A LLM could provide a list of typical steps. A customized AAAI, trained by experts from the world bank, could provide even more detail and expert advice. But to truly solve the problem, requires surmounting many unknown sub-problems that are specific to the village in question, the exact quality and quantity of water available, the existing state of the village, resources available, the politics of the village, etc. No existing LLM is up to the task of solving this complex, multi-faceted and multi-step problem. Even a customized AAAI would not be able to solve it. But a combination of a human expert(s) working with the village supplemented by problem solving support from AAAI.com's network of AAAIs and other human problem solvers, could solve this complex—and solve it better than the average human.

In order to work together, the human and. AI problem solving agents need to have a common representation of the problem they are working on, a way of knowing what each agent is working on, a way to monitor progress on the problem, and a way to spawn new sub-problems as obstacles arise that need to be overcome. They also need a rigorous record of every problem solving goal and subgoals, as well as the actions tried and the actions that worked to solve the problem and sub-problems. The rigorous record serves not only as an auditable track record of all the activity, but also as a way to teach the agents how to solve similar problems in the future.

The HPS architecture represents all problem solving with a tree structure. In one variation of HPS, the nodes of the tree represent different problem states (or “steps”), the branches represent taking different actions.

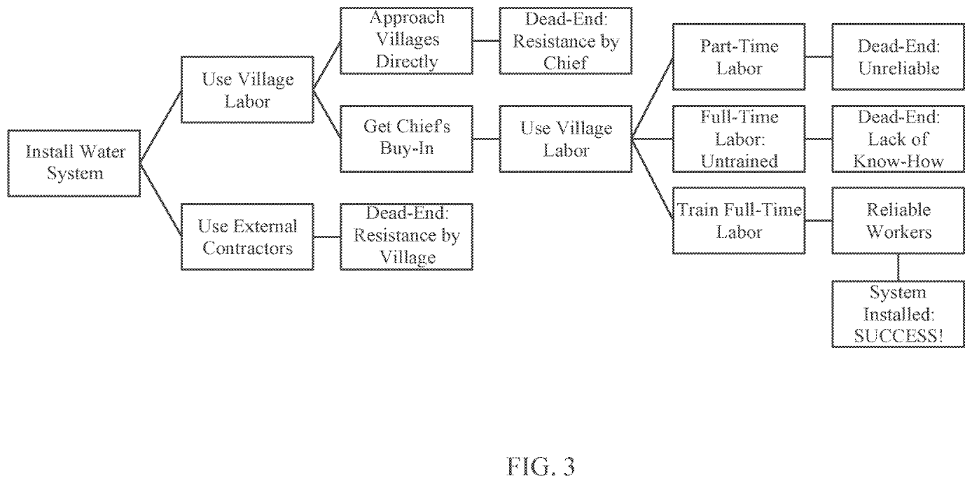

FIG. 3 is a simplified and high-level exemplary representation of a problem tree for the village problem of installing a water system. An actual problem tree would be much more detailed, with specifications of the all the relevant characteristics of each problem state, a list of the available “operators” that might be applied to transition from one state to another, and a record of the goal-sub-goal hierarchy reflected in tree. For purposes of illustration, this simplified version is intended to show how steps in a problem solving process can be tried by both humans and AI in a shared framework, how feedback from the real world can be incorporated by generating new potential operators and applying them, and how a record of the problem solving process is created which can be used to train AAAI.com on successful approaches to solving various problems so that over time less and less human problem solving is needed.

Referring to FIG. 3 from left-to-right, the initial state is where the village has no water system but there exists a problem with the goal of installing a water system.

One can imagine that an AAAI or human agent generated several next steps that included Using Village Labor or Using External Contractors. The step of Using External Contractors was tried, but this ran into a dead-end because the villagers resisted outsiders coming into their village. Feedback from the real world about the failure of Using External Contractors would be entered into the AAAI system at this point. Next, the alternative of Using Village Labor was pursued.

Human and/or AAAI agents generated multiple next steps for Using Village Labor and tried the straightforward path of Approach Villagers Directly. This is an example of a step that might appear logical to an AAAI but would probably be recognized as impractical by an experienced expert from the World Bank who would know that it was important to build a relationship and secure buy-in from the village Chief first.

When Approach Villagers Directly failed, Get Buy-In From Chief was tried. This resulted in progress with the Chief's agreement to use Village Labor.

More next steps were generated, and Part-Time Labor was tried. This failed because with only part-time work and competing economic needs, the laborers often failed to show up.

Next Full-Time Labor was tried. Workers showed up when they were being paid for full-time work, but the approach failed because the workers lacked proper training.

Next Training Full Time Labor was tried which resulted in workers who could do the required work reliably. These workers were able to get the System Installed—the solution state.

Note that each high-level Goal and step in the above example, would actually consist of many sub-steps and intermediate states in actual problem solving. For example, “Get Chief's Buy-In” might actually have many possible approaches for getting the buy-in, such as having tea with the Chief, giving gifts to the Chief, explaining the benefits to the Chief, and so on. Each of these might have sub-sub-steps. Having tea with the Chief might involve learning about customs and the preferences of the Chief, as well as determining the best time, place, and conditions for the tea, etc.

Importantly, all problems can be represented as a series of ever-more detailed goals, sub-goals, operators (e.g., actions that can be taken), and problem states-all attached to a tree structure. The tree serves as a universal representation that shows the course of problem solving, what has been tried, and where current problem solving efforts are underway. With multiple agents, it is possible to explore multiple potential solution paths in parallel, thus speeding up problem solving. In fact, one of the advantages of a network of AAAIs is that the AAAIs can be copied or “cloned”. Thus, AAAIs can attempt to explore branches of a problem tree in parallel. When they run into dead-ends or fail to make progress after repeated attempts, the AAAI system can recruit human problem solvers to get the AAAIs “unstuck” and back on track in their problem solving efforts. Throughout the problem solving process, a rigorous record of the problem solving is created which can be used to train AAAIs and also audit the problem solution (e.g., to ensure that ethical decisions were made at each step).

Note that almost all intellectual activity can be represented as a problem of one sort or another. Question answering or advice giving, for example, is often a simple one-step problem. The client asks a question, and the problem is to generate a response. LLMs excel at this simply type of one-step problem. The operator or “action” that the LLM employs is simple to run the “prompt”—the client user's question or input—through the LLM and generate whatever “response” the LLM's training, together with parameter settings, dictates. While many tasks can be solved with this single-step approach, combined with the human-client asking successive questions until the client has what he/she/they need, the HPS framework is much more powerful and general as it can handle simple, as well as complex multi-step problems. By representing problem solving in a tree structure—which can be quite vast and far beyond the ability of single human to keep in short term memory or even to comprehend completely at all—multiple problem solving agents (human and AAAI) can work on the problem in parallel, all the while producing a record that will make the overall AAAI.com system more intelligent until it achieves AGI with minimal or no human participation, other than ethical supervision.

Note, that this hybrid approach of combining human problem solvers with AAAIs allows the overall AAAI.com platform to exhibit AGI-level capability immediately! In the worst case, where the AAAIs can contribute very little, the humans on the network can do most of the problem solving—and of course, by definition, they are as good as the average human or better, resulting in AGI level performance. In the best case, the AAAIs have seen the exact problem before, have all the required expertise (as they have been trained with the appropriate knowledge, skills, and ethics) and are able to solve the problem completely autonomously with no (or only ethical monitoring) supervision from humans. In between these two extremes is where most current problems lie today.

What makes AGI so difficult is that the number of complex, multi-step real world problems that cannot be solved autonomously is so large! The approach of integrating human and AI problem solvers on a network, using a common universal problem solving architecture, with machine learning so that the AIs can learn to solve the same type of problem next time represents the fastest path to AGI. It is the safest path because humans are required until the AIs learn sufficiently from them. And as long as humans are “in the loop” there is the opportunity for human ethics to be learned along with human skills.

The alignment problem is thus solved, not by some “constitution” of ethics written by a few elite programmers, businesspeople, or statesmen, but rather by millions of individual human problem solvers who teach AI, step by step, problem by problem, how to solve the world's complex problems ethically.

The HPS architecture is a key ingredient in this Active Collective Intelligence approach that combines the intelligence of both AI (or AAAI) and human agents. Not only does HPS provide a common framework for solving complex problems, but it also provides rigorous specification of the goals, sub-goals, operators, problem states, and “steps” of the problem solving process. AI needs a rigorous specification in order to learn accurately. HPS is an excellent framework for not only solving problems using multiple intelligent agents but also for teaching the AAAI components of the network how to solve those problems autonomously in the future. HPS allows the bootstrapping of AGI, beginning with both human and AI agents in the initial phases, and having the capability of offering AGI-level performance on “Day One”.

Across many users and their many customized AAAIs, the overall AAAI.com platform becomes an AGI. Even though the base model AI was error-prone and could not achieve AGI-level performance on its own, the Active Collective Intelligence of all customized AAAIs on the AAAI.com platform will rapidly increase until it exceeds the average human on essentially all tasks for which human experts exist, thereby achieving AGI.

By leveraging the collective intelligence of humans, and of the advanced (customized) autonomous AIs that these humans create, the overall system is able to achieve AGI much faster than using other methods. At the same time, during the normal course of problem solving and question answering, specific ethical questions will arise. As the humans correct their AAAIs, the overall AGI system becomes more ethical.

Finally, the ethical assessment that is part of each human user's creation of an AAAI ensures that baseline ethical information is gathered from every user and that the ethics of all users can be used transparently in determining the core ethical values of the overall AGI.

Human users will come and go, but the knowledge and ethics captured by their AAAIs remains and accumulates. As the AAAIs become, collectively, AGI, the AGI can clone itself and interact with its clones, improving rapidly in the same manner that AlphaGo and other AIs have rapidly improved to achieve SuperIntelligent performance in specific domains.

However, there is no rational way to derive base values such as what is right and wrong. Values must be accepted as premises in a logical system. Therefore, the fundamental human values and ethics learned from millions of human users who customized their AAAIs will remain relatively constant premises compared with problem solving ability and other intellectual abilities that will improve exponentially as the AGI learns from interactions with copies of itself. Thus, the path of using the Active Collective Intelligence of millions of humans to customize their individual AAAIs, while imparting their human values and ethics, represents not only the fastest path to AGI, but also the safest, to the degree that the human values remain relatively unchanging premises in the AGI system.

To implement the above approach to developing AGI as rapidly and safely as possible, it is useful to break the overall AAAI technology down into several sub-systems with associated methods.

One aspect of the present technology is that the implementation of the AAAI system can consist of five sub-systems with associated methods with safety features integrated into each sub-system. The five sub-systems of the AAAI system can be: 1) AAAI Customization, 2) AAAI Architecture, 3) AAAI Network, 4) AAAI Integration, 5) AAAI Improvement. The acronym SCAN-II (Safe, Customizable, Architecture and Network—Integrated and Improving) describes the present technology in some aspects.

Subsystems are separate aspects in their own right, which, upon combination in an overall AAAI system have synergistic value. However, some individual sub-systems are capable of creating a version of AGI without the synergistic effects.

For example, using the AAAI customization sub-system, combined with a sufficiently powerful large language model, can result in AGI on its own. However, the AGI will be self-improving if the AAAI Improvement subsystem is included, it will be more general, powerful, and valuable if the AAAI Architecture and/or AAAI Network are included, and it will be maximally intelligent if AAAI Integration is included. Further, although safety features are built into each individual sub-system, the overall system achieves maximal safety and effectiveness by combining multiple, and ideally all, subsystems in an implementation.

Which specific combination or subsystems are implemented may depend in part on the weight that system implementors give to safety, speed, efficiency, scalability, and other factors. However, one aspect of implementation emphasizes safety, which seems prudent given the tremendous potential power of AAAI. In particular, attempts to modify the present technology so as to reduce the role of humans, at least insofar as incorporating human values, ethics, and at least some supervision are concerned, represent a dangerous path and should be avoided.

### AAAI Safety

Safety is achieved not by a sub-system, but rather by a set of design principles that are reflected in specific features and functions within the five sub-systems. The overall purpose of the AAAI Safety features is to maximize the chances that humankind survives the likely scenario where AGI vastly exceeds the intelligence and power of its human creators. The systems, methods, and features of the present technology that contribute to safety, generally are based on a few principles:
1) Ethics and values can be given or learned but not logically derived.
2) Most humans want to survive and want humankind to survive.
3) Democratized values are better.
4) If it can be programmed in, it can be programmed out.
5) An ounce of prevention is worth a pound of cure.
6) Redundancy increases reliability.
7) Continuously improve safety.
8) Avoid the unrecoverable.

Principle #1, “Ethics and values can be given or learned but not logically derived,” is the reason that the AAAI system is designed to transfer values to AGI and why there is a good chance that these values will “stick” even though the AGI becomes vastly more intelligent that humans. No matter how intelligent AGI becomes, it still needs values and purpose—which its vast intelligence cannot supply in any logical way. It is certain that the initial values of AGI will be those supplied by its human creators. As a default, it is likely these human values will remain at the heart of AGI simply because we provide a sense of purpose to the AGI.

Principle #2, “Most humans want to survive and want humankind to survive,” addresses the concern that humans often act in selfish ways and cannot be relied upon to teach the AGI positive human values. AGI will amplify whatever values we teach. Therefore, it is a matter of self-interest to teach it loving values, which in turn will be reflected back to humankind in positive ways by a vastly superior intelligence. Most humans would prioritize survival above greed, fear, hatred, and other negative motives. The greater danger lies in miscalculation or misunderstanding. Humans need to understand and calculate that positive loving values are the best path to survival and prosperity in the age of AGI.

Principle #3, “Democratized values are better,” reflects the idea that power corrupts and therefore it is unwise to have the values of a SuperIntelligent AGI determined by small group of people. Rather, it is better for an AGI to have values supplied by millions of people so that it can determine which ethics and values are generally agreed upon. It is important that the values themselves, as well as the methods for combining them into the values of the AGI, are transparent and accessible to everyone.

While it possible that an enlightened “Philosopher King” or elite group could supply better values than millions of humans, the millions have the virtue of providing a greater diversity of ethics while still broadly agreeing on the value of commonly held ethics such as the value of human life, kindness, and so forth. Allowing one human, or one entity, to decide what is right for everyone concentrates power while increasing risk of corruption and very bad outcomes compared to a democratic approach. Even if the chances of very good outcomes are also increased by concentrating power in the hands of an enlightened leader, AGI can amplify very bad outcomes enough to wipe everyone out, which means humanity cannot tolerate the risk.

Principle #4, “if it can be programmed in, it can be programmed out,” is the reason naïve approaches to safety like programming in Asimov's three laws of robotics or other safeguards will not work. The simple fact that militaries are already programming AI to kill demonstrates that programming a rule like “thou shalt not kill” is not practical. Since at some level, all values must be reflected in an AGI's programming, perhaps the best we can do about Principle #4 is to have the values occur in many different places, reflecting the views of many individual humans, and being dynamic so that they can adapt to many different situations. This approach reduces the chances of bad outcomes by making it difficult for an AGI to adopt universal negative values.

Principle #5, “an ounce of prevention is worth a pound of cure,” recognizes that the more powerful a technology is, the less able we are to correct serious mistakes after the fact. The system, and safety features of AAAI, must be designed as part of the system itself (as opposed to being “tacked on” after the fact) to proactively prevent serious mistakes from occurring in the first place.

Principle #6, “redundancy increases reliability” suggests a practical way to increase safety and reliability is to have redundant checks in the AAAI system so that mistakes can be prevented. The likelihood that a bad actor or action will escape detection at multiple checkpoints is much less than if only a single check exists.

Principle #7, “continuously improve safety,” reflects the fact that AGI's capabilities will be rapidly evolving. The safety features must also continuously improve and evolve to keep pace, or they will quickly become ineffectual.

Finally, principle #8, “avoid the unrecoverable,” acknowledges that even with our best efforts mistakes will be made by AGI. As long as the mistakes are not catastrophic and unrecoverable, humans will survive, and the AGI can learn from the mistakes and improve. But certain mistakes—nuclear war, release of bio-engineered diseases, overt attempts to eliminate the human species, or similarly drastic decisions—could be unrecoverable. A bias must be built into the AGI system to get more human opinions and to spend more intelligence and resources on understanding consequences in proportion to how serious a decision might be for humanity and how many humans it might affect.

The design of any system for AGI needs to consider how it will take these principles into account. To accommodate all the principles, it should be clear that relegating Safety to a single sub-system or process step will not suffice. For example, the principle of redundancy requires that checks be built into multiple sub-systems. Generally, Safety design principles must be incorporated into each sub-system. As we describe each of the remaining subsystems, we will therefore also describe the safety features built into that sub-system and relate those features to the principles above.

### AAAI Customization

Currently LLMs, such as GPT or BARD, exist which demonstrate competent behavior on a wide range of tasks. However, such models are not currently deemed to exhibit intelligence equal to the median human across a wide variety of tasks—one definition of AGI. LLMs increase in power as they are trained with larger datasets, and higher quality datasets. They also increase in power as they use better learning algorithms including, but not limited to, deep learning algorithms, Transformer algorithms, constitutional training methods, supervised learning methods and unsupervised methods. Finally, LLMs increase in power as the available compute power increases which allows faster and broader training in reasonable amounts of time.

These three “pillars of AI”—data, compute, and algorithms—currently serve as the main constraints on developing more powerful LLMs and more powerful AI systems in general. Current algorithms are sufficient to train AI in specific areas of competence (called “narrow AI”) and also to train LLMs that perform as well or better than humans at many tasks, with some errors. Compute is increasing and is mainly a matter of purchasing sufficient computing power. Therefore, the most constraining factor over the next several years is likely to be data. Already LLMs are using much of the information that exists on the internet. For example, bots that crawl the internet and then produce training sets (e.g., webcrawler.org), produced the bulk of the data that was used to train GPT 3®. However, the highest quality, and most valuable, data resides not on the public internet but in the minds of human experts. To train AGI that exceeds average human performance in all areas, it will be necessary to access this data that is “locked in the minds” of humans.

AAAI is an approach where a base LLM is updated and modified by the expertise of humans. To unlock the knowledge that is locked in human minds, LLMs can interact with humans and their individual data in a variety of ways which can be broadly classified as passive and active. Passive methods include many forms of interacting with the “exhaust data” or digital footprints that are left by humans as they participate in a variety of online activities. This exhaust data, properly processed, can be used to train a base level LLM on the specific knowledge, ethics, intellectual style, and even personality of the human “owners” of their customized AI.

Without limitation, some of the methods for using passive data, include using Facebook®) Timelines, Instagram®) feeds, Reels videos (and their transcripts), YouTube® and other online videos (and their transcripts), Tweet histories, texting data, email history, Netflix® and Amazon® preferences, geographical location and movements, purchase history, papers, posts, books, patents, and all manners of other personalized data that is currently collected by a wide variety of companies to determine user preferences. All information about users that is currently being used for online ad targeting would also be included in this category of passive data.

The implementation approach described in this description of the present technology can be generalized to a wide range of varying implementations at many companies, and across companies, including without limitation Meta®, Amazon®), Alphabet, Google®, DeepMind®, YouTube®, TikTok®, Microsoft®, OpenAI®, Twitter®, X®), X.AI®, Tesla®, Nvidia®, Tencent®, Apple®, Anthropic®, Alibaba®), ByteDance®, TenCent®, Baidu®, Spotify®, PubMatic®), Magnite®, Sea Limited®, Pinterest®, Snap®, and Criteo®—in order to customize AAAIs more quickly and powerfully than would otherwise be possible. Implementation can be realized, with or without participation of such potential partner companies, but synergistic effects can be realized with their participation. For example, synergistic effects for some of these companies can be realized by leveraging technology and platforms as follows:
Meta®: FaceBook® (FB), Instagram®), Reels, Metaverse, AI data and technologies.
Amazon®: AWS, Amazon's marketplaces, Mechanical Turk, LLMs powering Alexa, data and other AI initiatives.
Google®: BARD®, GEMINI®, YouTube®, GoogleDocs, DeepMind's AI technology, Google AI technology, Google search, Google cloud, and Android® technology, data, and other initiatives.
Tesla®: Tesla AI technology, Tesla Self-Driving technology, data and other initiatives.
Twitter®: Twitter functionality, XAI, Twitter user base, Twitter data and AI initiatives.
Microsoft®): Bing®, Office, Azure Cloud, OpenAI®/GPT, LinkedIn and other data and Microsoft AI initiatives.
Nvidia®: Nvidia's AI stack including hardware, software, CUDA, gaming and graphics technology, AI libraries, supercomputers, communication systems, data, datacenters, AI-as-a-Service offerings, and Omniverse technologies.
Apple®: iPhone, iPad, augmented reality initiatives, apple pay, apple cloud, data, and apple AI initiatives.
TikTok®: Short form video, data, and other AI initiatives.
Tencent: WeChat, WePay, data, and other AI initiatives.
Anthropic®): Constitutional learning, supervisory technology and methods, other data and AI initiatives.

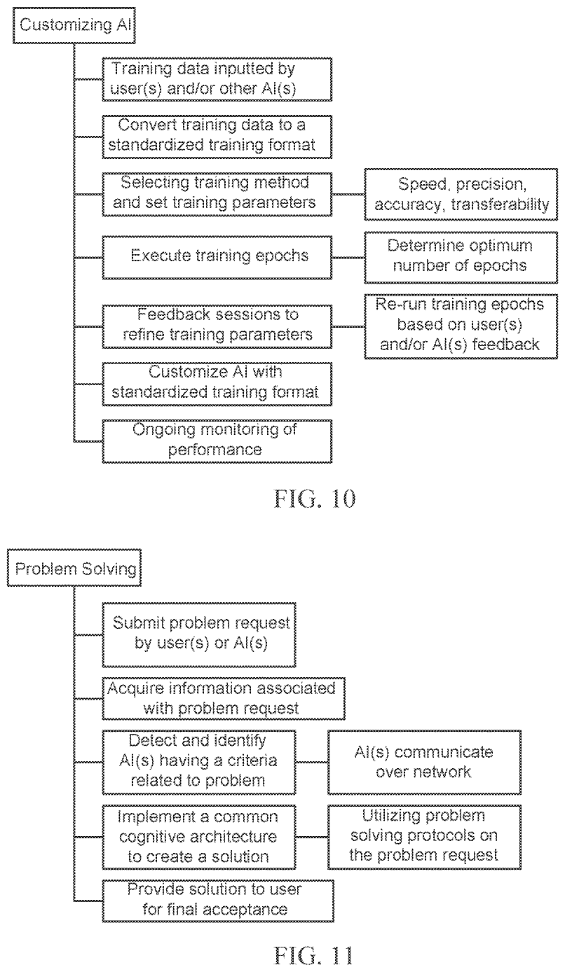

With reference to FIGS. 1 and 10, one aspect of the present technology is a method for using passive data to customize LLMs, narrow AIs, AGI, and other forms of online intelligent systems (generically referred to an AAAI) is:
1) Upload dataset to training system.
2) Process data to convert it to a standardized training format for the LLM or other AI system.
3) Select one or more training methods and set training parameters depending on various factors including those that affect speed, precision, accuracy, and transferability of the training.
4) Run multiple training epochs, with mechanisms to determine the optimum number of epochs given specific training objectives and quality metrics.
5) Engage in multiple feedback sessions in which training criteria is refined and training is re-run based on opinions of human raters and/or other AI systems (including AIs using “constitutions” as describe in published works on constitutional AI to provide their feedback).

Each individual can create a customized AAAI that reflects his/her/their expertise, knowledge, personality, style, and ethics. These customized AAAIs can be put to work on behalf of their owners in a variety of ways including earning money for the owners in a knowledge marketplace, serving as representative(s) of the owner in a variety of online transactions and interactions, and contributing knowledge, expertise, style, personality, and ethics to an integrated AGI system that leverages the trained differences in many individual AAAIs.

In addition to passive modes of training AAAI on existing “exhaust” data, owners of AAAI can actively participate in dialog and other types of interactions with AAAI to actively train the AAAI. For example, owners can answer questions related to their expertise, ethics, style, personality, knowledge, and other aspects of their individuality that can be used to train a base level LLM or other AI. These dialogs or interactions can be scripted or developed by the AI dynamically based on what information is most helpful to train a differentiated AAAI that adds value compared to the base LLM or other AI.

A combination of passive and active training, using both supervised and unsupervised learning methods, is one aspect of implementation of the present technology. A wide variety of machine learning algorithms and methods exist for training/tuning/customizing AIs such as LLMs. Different algorithms are appropriate for different specific training objectives. To exhaustively categorize all methods that are widely known in the art and applicable is beyond the scope of this patent. This patent is less concerned with the specific training techniques employed than with creating customized AAAIs that can be integrated into a network to deliver AGI. That said, the methods section of this patent lists, without limitation, some of the ML algorithms, techniques, and methods that may be useful.

Generally, the mix of learning methods and datasets is driven by what will add the most differentiated value to the existing base LLM or other AI in the least amount of time. This concept is referred to as “informational efficiency”. The informational efficiency of a training method refers to how much additional knowledge, or useful information, content is added to the AAAI per unit of resource, where resource is a function of time required, money required (which may be related to compute required), and accessibility of data and/or active training.

Value is defined by the owner of the AAAI and/or by algorithms that determine the value of the AAAI's contribution to SuperIntelligent AGI(s) and/or the AAAI marketplace. For example, an owner may place arbitrary and individualized value on the AAAI learning attributes like the personality characteristics, style, and quirks of a loved one that is terminally ill. These characteristics would be very valuable to the owner of the AAAI but perhaps less valuable and unique to a collection of AAAIs engaged in money-making operations in an AAAI marketplace. On the other hand, AAAI marketplaces can assign value to individual knowledge, expertise, style, personality, ethics, and other attributes of a customized AAAI based on the incremental earning power those characteristics lend to the group of AAAIs or the AGI(s). Thus, value can be defined in multiple ways for different purposes, but in one aspect of implementation, algorithmically speaking, training should be optimized to efficiently deliver maximum value (as defined by owners) with minimum resources.

In one aspect of implementation, multiple methods of passive and active training work together with a means for automatically selecting, recommending, and/or filtering training data based on the goals of the owner to optimize value delivered. Value is defined from a personal perspective and/or from a marketplace perspective based on quantification of the additional value added by an individual AAAI to a group of AAAIs or AGI(s).

### Safety Checks in Customization

Critically, ethical information can and should be extracted at the same time as other types of information, as referred to in FIG. 1. Thus, an ethical profile, as well as a knowledge profile, can be extracted from an individual's data such that the resulting LLM, or other form of AI, is customized to have the knowledge, ethics, and/or personality and style of the owner of the AI in addition to possessing the generic knowledge and attributes of the base level LLM, or other form of AI. The base level AAAI should have some form of agreed upon ethics which can be used to screen inappropriate customization efforts by an individual user.

For example, if a single user attempts to train their AAAI to poison water supplies, create terrorist weapons, and bioengineer weapons of mass destruction, alarm bells should ring at AAAI.com based on broad ethical parameters. On the other hand, if an individual customizes his or her AAAI to reflect religious values from a particular scripture which differs from someone else scripture or an atheist's beliefs, these are all variations well within the realm of ethical norms accepted by most people on our planet and should be allowed.

Sometimes the lines are fuzzy. Our society properly debates what is right and wrong all the time. However, most people agree on broad ethical principles. Those principles are where 99% of humans agree might be the starting point for base ethics. Beyond that, part of the value of having millions of individual AAAIs, each trained with a particular user's ethics, is to systematically gather and integrate the consensus ethical views of as many humans as possible. The idea is that such broad and diversified effort at gathering ethics will result in a better system than a set of principles or rules developed by an elite few where the chances of corruption and a very bad result are higher. The chief concern of safety, with regard to AGI, is to eliminate the tail risk—the very bad outcomes—that could lead to the extinction of the human race. The safety goal for AGI should be to maximize chances of human survival, recognizing that with a great power like AGI, extreme mistakes can lead to extinction. As long as humans survive, they have a chance to improve ethics over time. If an unrecoverable mistake is made—something made much more likely by concentrating power in the hands of an elite few—it is “game over” for all of us.

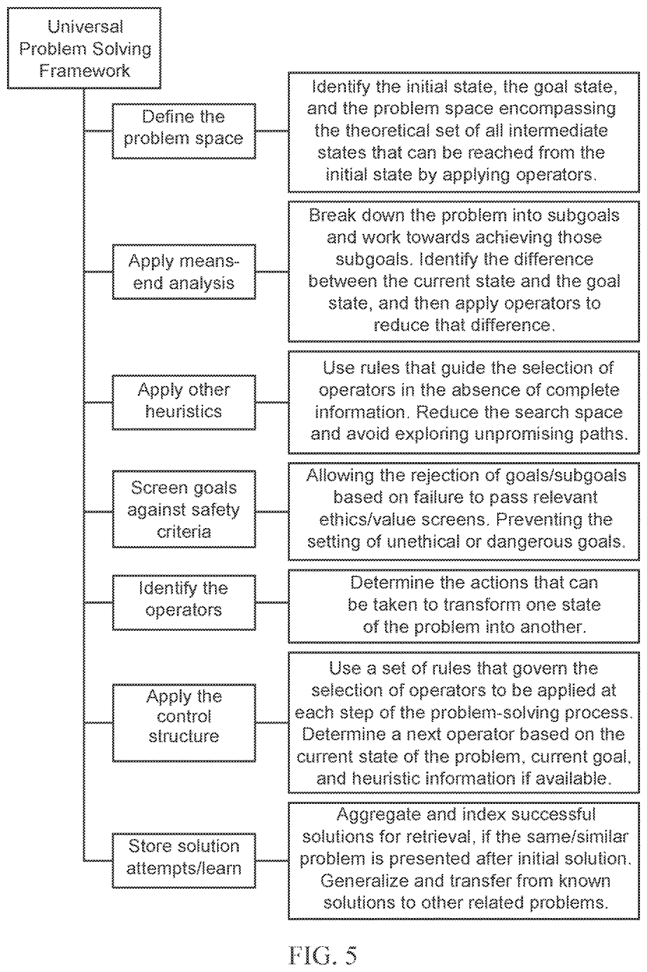

The primary safety mechanism embedded in the customization system is a general check against egregious harmful training, coupled with a design philosophy that gives every human who trains an AAAI a “vote” in the overall ethics of the AGI (as described in the Integration system), with reference to FIGS. 1 and 5.

### AAAI Architecture

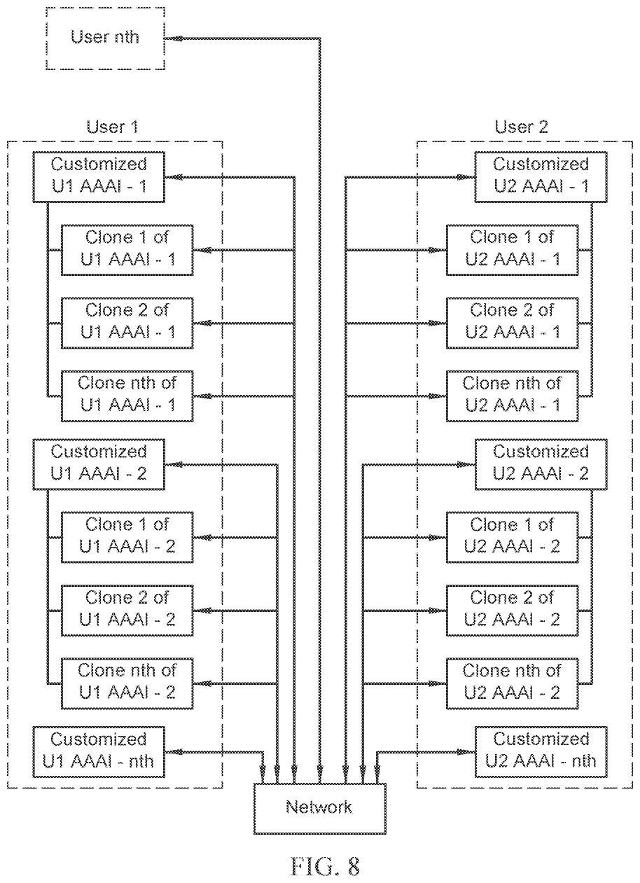

For AAAIs to solve problems, individually, in groups, and as part of a more powerful SuperIntelligent AGI, a common cognitive architecture is needed. The architecture needs to include an attentional mechanism to direct problem solving as well as a means of representing the problem and actions that can be taken. The architecture for human problem solving, described in Newell and Simon's 1972 book, Human Problem Solving (HPS), provides these basic components. The ODPS patent (see below) by Dr. Kaplan and the subsequent whitepaper, entitled Worldthink White Paper, describe how to combine Newell and Simon's HPS basic architecture with an online automated system for problem solving (allowing both human and AI participation) and a (optionally blockchain-based) payment system that directs the flow of attention. Building on these foundational concepts, the AAAI architecture has the following characteristics in one aspect of implementation:
1) A common framework which views all interactions as a form of problem solving in a problem space as defined by Newell and Simon. Each problem has a goal, optionally subgoals, and operators that can take the problem solver from an initial problem state to a solution state that satisfies the goal via a series of intermediate states that may be related to subgoals, and which uses evaluation functions and heuristics (which are known in the art and which literature is extensive in the AI community). Each problem state, in the one aspect of implementation, shall have ethical information and criteria associated with each proposed goal and subgoal such that the ethics of pursuing that goal or subgoal can be evaluated before deciding to pursue that goal.
2) A common problem tree, which is highly scalable and decomposable into sub-problems. Each AAAI has access to the part of the problem tree that is relevant for its problem solving activities. The commonly accessible problem tree serves as a mechanism to locate each AAAI in terms of its contribution to, and current activity in, the problem space.
3) Mechanisms (aka “methods”) for assignment of blame and credit, as detailed in the WorldThink whitepaper that, when the problem solving history is used to train the AAAI, can be used to improve the problem solving performance of any individual AAAI as well as of groups of AAAIs and SuperIntelligent AGI(s) that represent an integration of the knowledge and problem solving efforts of a number of individual AAAIs.
4) A mechanism for translating natural language interactions with humans and AAAIs into a common problem solving representation such that both humans and AAAIs can engage in problem solving as intelligent agents and the AAAIs can learn and improve by observing the behavior and effectiveness of both human and AAAI agents. Mechanisms for using such observations in a reinforcement learning scheme to improve the AAAIs, group of AAAIs, and/or SuperIntelligent AGI(s).
5) A mechanism for cloning AAAIs (as shown in FIGS. 7 and 8) such that multiple AAAIs can engage in problem solving in parallel, thus allowing one human to multiply his/her/their problem solving effectiveness by deploying “an army” of cloned problem solvers to address complex problems and explore multiple potential solution paths in parallel.
6) Payoffs or rewards for problem solving generally are a function of achieving goals, subgoals, and/or realizing the solution state. Functionality, in the one aspect of implementation, ensures that before any transaction or payment occurs on the blockchain (or in any other payment scheme) that ethical criteria related each goal and subgoal preceding the payment have been satisfied and that each individual goal, as well as the entire problem solution path satisfies ethical criteria.

What follows is a more detailed description, which has been adapted and enhanced from Dr. Kaplan's whitepaper entitled, the WorldThink Blockchain Protocol, which describes one aspect of implementation of the architecture where tokens are used at the payment mechanism and problem states are stored on the Ethereum blockchain. However, other implementations with different (more centralized and efficient) methods of storing problem states and other (more widely accepted) payment mechanisms (e.g., “credits”, credit cards, Venmo, PayPal and other payment systems) are also feasible. In the case where centralization of processing is not a concern, non-blockchain payments are arguably desirable.

### WorldThink Protocol as One Implementation of AAAI Architecture

The WorldThink protocol is a problem solving architecture that can be used by AAAI.com to serve as a universal problem solving architecture as it incorporates the general architecture of HPS while adding features to overcome certain challenges.

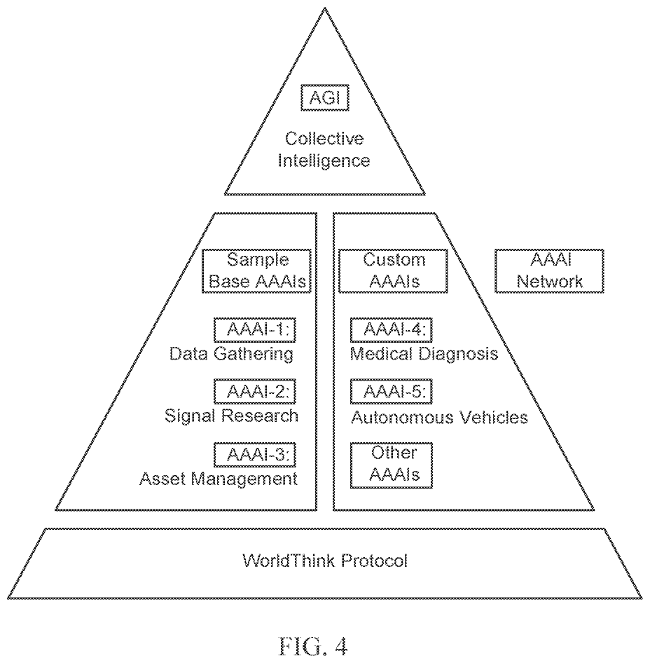

FIG. 4 provides a simple exemplary framework for understanding some of the applications of the WorldThink protocol. At the top of the pyramid are Collective Intelligence Solutions. Integrating the Collective Intelligence of AAAIs (and human problem solving agents) is the means to achieve AGI, as discussed earlier.

In the implementation using the WorldThink protocol, clients pay for solutions using tokens. The solutions are produced by harnessing the collective power of many human (and machine, or AAAI) intelligences. Clients can use different domain-specific AAAIs for different types of problems.

The middle of FIG. 4 shows examples of AAAIs customized by organizations to accomplish specific tasks. These AAAIs are more advanced and require more customization than the examples of AAAIs described earlier in this patent which were customized by a single individual. However, task-specific customization by organizations can be a highly effective means of combining multiple Narrow AIs (each in the form of a custom AAAI that is expert at a particular task) into a larger AGI. The Base level AAAIs on the left of FIG. 4 reflect areas where Dr. Kaplan could relatively easily construct custom AAAIs based on many years of expertise in certain fields, whereas the “Custom AAAIs” on the right of the diagram provide examples of areas where other experts or organizations might customize AAAIs effectively.

The WorldThink protocol is the foundation of the pyramid. The protocol layer provides an (optionally, Ethereum-based) infrastructure that makes it much easier for developers to build and scale customized problem solving AAAIs. The protocol enables re-use of solutions within and across AAAIs. It also handles payment of royalties via smart contracts, reputation metrics, and other functionality that assists AAAI customizers and developers and promotes network effects.

Existing collective intelligence approaches to problem solving have been largely limited to simple one-step approaches, such as those used by question and answer (Q&A) systems (e.g., Quora, Google Answers, Yahoo Answers). LLMs such as GPT also largely fall into the category of Q&A systems since they were designed to generate responses given an input, rather than to solve problems per se. While such Q&A systems have had some success at simply aggregating the responses of many online participants, these systems are not designed to handle complex, branching, multi-step problems. Simple aggregation of responses (or even betting on outcomes as seen in prediction market approaches such as Augur and Gnosis) is quite different from coordinating the efforts of many respondents to solve complex problems. The WorldThink protocol is specifically designed to overcome the challenges inherent in coordinating many minds to represent and solve complex, multi-step problems in an automated way that fairly rewards participants.

### Overcoming Coordination and Communication Challenges

The WorldThink protocol overcomes coordination and communication challenges by allowing problem solvers to work asynchronously in parallel. Every human or AI problem solver has access to the blockchain record of problem solving, which is updated automatically as progress is made. Complex problems are broken down into a hierarchy of sub-problems that can be tackled by individual (or groups of) problem solvers. The problem solving process moves forward based on a “first to submit a valid solution to the sub-problem” basis. In other implementation, a centralized problem tree representation can be used together with applications for browsing the tree. Thus, blockchain is not needed to store the problem solving record, although it does provide some benefits in terms of auditability and decentralization.

### Overcoming the Challenge of Problem Formulation

One of the toughest challenges for automated problem solving systems is constructing the initial formulation of the problems and finding an appropriate way to break complex problems into simpler sub-problems. Although humans are relatively good at representing ambiguous or ill-defined problems, these types of problems are nearly impossible to automate.

The WorldThink protocol overcomes this challenge by using human participants to formulate problems and sub-problems recursively until the sub-problems are finally actionable enough that they can be solved by human (or machine) intelligences. The solutions to the sub-problems are then automatically “rolled up” (as shown in FIG. 2) from the smallest sub-problems to higher-level sub-problems and ultimately into a total solution that can be presented to the client.

The entire automated approach follows the rigorous scientific theory of human problem solving (HPS) and was reduced to practice in Dr. Kaplan's issued US patent (U.S. Pat. No. 7,155,157) on Online Distributed Problem Solving (ODPS). Please see the ODPS patent for a detailed description of the general problem solving system and methods that are part of one aspect of implementation for the AAAI architecture.

### Overcoming Assignment of Credit and Reputational Challenges

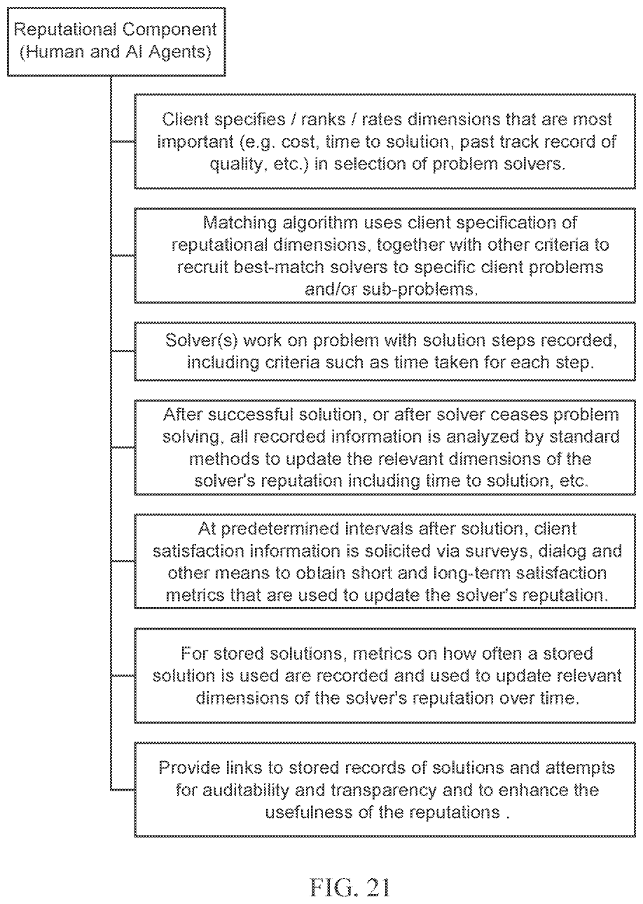

With reference to FIGS. 5 and 21, and system capable of solving complex problems must have rigorous and effective ways of evaluating which problem solving steps are advancing toward a good solution (“credit”) and which steps are going in the wrong direction (“blame”). Human problem solvers are unlikely to participate unless they feel credit is fairly assigned for their problem solving efforts. AAAI problem solvers require accurate assignment of credit and blame if they are to improve and also be compensated fairly for their contribution to the solution of complex problems where they may solve only a part of the problem. Finally, a specific, accurate, and objective reputation system is needed to more efficiently and effectively match problems to those who are most likely to solve them.

Over time, participants can earn problem-specific reputations enabled by Dr. Kaplan's patented and patent-pending reputation technology and/or other reputational systems that are well known in the art. These reputational systems should analyze the auditable record of problem solving contributions.

### Overcoming the Challenge of Directing and Focusing Attention

All problem solving can be characterized as a search through a maze (technically a decision tree or “problem space”) of possible steps that might lead to a valid solution. Rather than searching all paths, successful problem solvers evaluate the paths, determining which paths are most likely to lead to success, and then focus attention on exploring just the most promising ones.

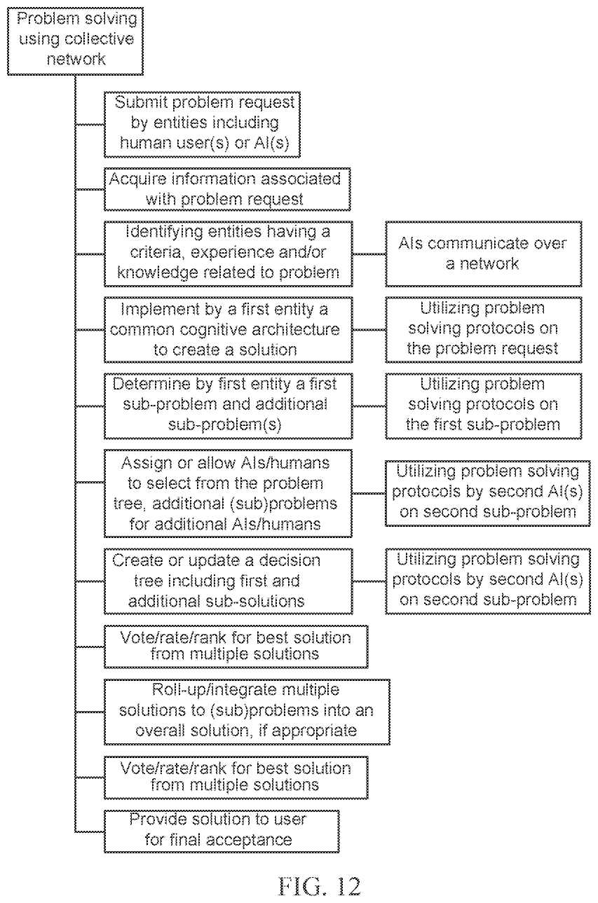

The WorldThink protocol focuses attention via tokens. If there are multiple potential paths to explore, participants will tend to explore the paths that have the highest token rewards associated with them. Clients or other participants can directly influence the direction of problem solving by posting higher token rewards for exploring certain paths (e.g., paths they propose). By setting parameters in the WorldThink protocol, clients and applications can specify a range of different token compensation rules that focus attention in different ways. For example, in FIG. 12, information associated with the problem request can include rewards or token payments associated with solving the problem or sub-problem. When AIs/humans select form the problem tree, their attention and selections may be partially driven by the various rewards associated with different parts of the problem tree. If blockchain tokens are undesirable, alternative implementations using system credits or actual payments as rewards are also feasible means of focusing the attention of human and AAAI problem solvers.

### Overcoming Challenges Related to Re-Use, Scalability, and Automation

Unstructured solutions are difficult to re-use, automate, and scale. Fortunately, the WorldThink protocol provides a standard data structure for any online problem solution. This common standard enables re-using existing solutions either on their own or as components within larger solutions. Smart contracts enable paying the original Solver royalties, automatically and efficiently, each time his/her solutions are re-used in another solution. Royalties incentivize Solvers to produce solutions with an eye towards making them general, effective, re-usable, and scalable. Every Solver is competing for royalties to make his/her solution scale as widely and quickly as possible.

As human Solvers do the difficult work of representing and solving problems, they leave a highly auditable record of their solutions in Ethereum logs—since storing data as records on-chain would be prohibitively expensive and inefficient. Eventually, the logs will grow to the point that the more common or repetitive problems can be automated. Machine learning techniques can be used on the logs to bootstrap automated problem solutions. The WorldThink protocol incentivizes Solvers to create automatable solutions since they are an excellent means to ensure a steady royalty stream. Note that, again, that blockchain logs are required only for a decentralized approach but that similar logs and analysis methods would be effective in a centralized system if that was the desired implementation, e.g., on AAAI.com.

### How the Worldthink Protocol Works

This section provides a high-level description of how the WorldThink protocol works. We describe basic functionality and some high-level design decisions, such as the decisions to base the protocol on the Ethereum blockchain, to use Ethereum logs to record problem solutions, to incorporate patented online distributed problem solving technology in the protocol, to use Token Curated Registries (TCRs), and to incorporate patented reputation technology.

### Simple Problem Solving Using the WorldThink Protocol

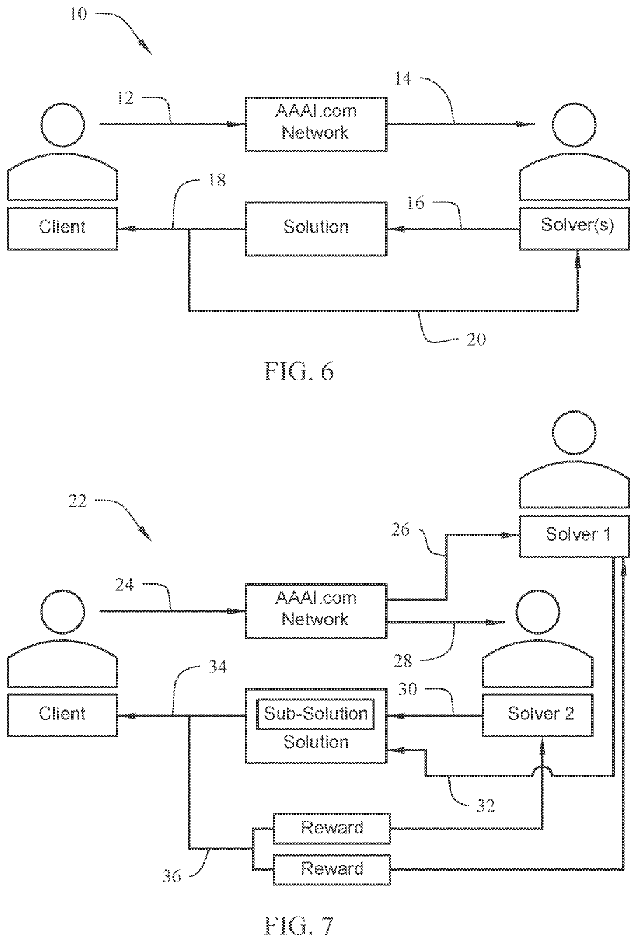

In the exemplary, FIG. 5 shows a simple exemplary universal problem solving framework. While FIG. 6 shows some of the basic problem solving functionality supported by the WorldThink Protocol, generally referenced with numeral 10.

Problem solving begins when a client on AAAI.com submits a problem solving request to the community of online participants (Step 12). All AAAIs, or human solvers, following the protocol gather certain standard information from the client. A partial list of this information can include: the name and description of the problem, the total reward that the client will pay for a successful solution to the problem, the criteria to determine whether a solution will be deemed successful, the time limit for solving the problem, the minimum and maximum number of problem solvers allowed to work on the problem simultaneously, qualifications required of participants working on the problem, which parts (if any) of the problem and solution will be confidential, whether the solution must be exclusive to the client or whether it can be re-used for others, and parameters relating to how to reward multiple problem solvers for their efforts and/or successful solutions.

The client can break complex problems down into a series of sub-problems or request that the community take on this task as part of the problem solving effort. The client user-interface, which could be a dialog initiated by an AAAI can be customized by the AAAI owner, but the underlying data format is standard and specified by the WorldThink or ODPS protocol. Once the client has submitted a problem, AAAI.com can recruit participants using its own custom methods and/or leverage recruiting and reputational screening functionality that is built into the WorldThink protocol and thus shared by all AAAIs.

Solvers work on the problem following a rigorous structured problem solving process that is common to all problem solving agents and enforced by the WorldThink Protocol (Step 14). For example, each step in the problem-solving process must be in service of a named goal and must take a named action in order to transition the problem solving from the current state to the next state. Every problem solving step is represented in a decision tree which is supported by the protocol (optionally captured in Ethereum logs) and which participants can view via AAAI.com.

When a Solver submits a complete solution (Step 16), it is timestamped and validated against the client's success criteria before being passed on to the client (Step 18) for final acceptance. Once the client accepts the solution, smart contracts can automatically distribute tokens to the problem solver based upon the problem payment parameters (Step 20) or other, more centralized, payment procedures can be used.

### Collaborative Problem Solving Using the WorldThink Protocol

In the exemplary, FIG. 7 shows the same steps in an example where two problem solvers (which could humans, AAAIs or a combination) collaborate to solve a client problem, as generally referenced with numeral 22. In this case, the overall problem has been broken down to include a sub-problem. Solver 1 has expertise in assembling an overall solution but cooperates with Solver 2, who provides a solution to the sub-problem (Steps 30 and 32). When the overall solution to the problem is submitted to the client (Step 34), rewards are paid to both Solvers (Step 36) based on the objective record of their contributions and the agreed upon payment parameters.

The WorldThink protocol supports breaking problems into sub-problems in several ways. First, the client may choose to specify sub-problems when submitting the overall problem (Step 24). Alternatively, Solver 1 might begin working on a problem and realize that the total solution requires solving a sub-problem outside of his/her expertise. Solver I could then create a sub-problem, offering up a share of the problem's total token reward to anyone who helps solve the sub-problem. Solver 2, who has the required expertise and who can see the new sub-problem posted by Solver 1 on the decision tree. The decision tree may be optionally maintained in Ethereum logs, or via a centralized method. The solvers access the tree via AAAI.com (or optionally directly from the blockchain). Then Solver 2 can work on the sub-problem and submit a sub-solution as part of Solver 1's overall solution.

There can be many “Solver 1s” working on the client's problem in parallel, each of whom may be posting sub-problems to attract multiple “Solver 2s”. Problem solvers (human or AAAIs) are motivated by the rewards and payment rules associated with (sub) problems. They also care about the quality of work done so far (which is timestamped, attributed, and recorded auditably in Ethereum logs to ensure transparency and fair assignment of credit) as they choose which (sub) problems to work on. Working on quality sub-problems is more likely to lead to token rewards. This market mechanism helps ensure efficient, fair, and cost-effective solutions.

### Royalties and Re-Usable Solutions

Re-usability of solutions is an important feature of the WorldThink protocol. Consider the case where the “Sub-solution” in FIG. 7 already existed and is simply re-used by Solver 1. Because every solution is structured and “tagged” according the WorldThink protocol's standard problem solving format, Solver 1 can search for all existing solutions that match a particular goal, or that share certain features with the problem he/she is trying to solve. (Alternatively, if the problem solutions are chunked into procedures for solving problems—a learning mechanism explained in the Improvement Section of this patent—then searching may not be necessary as the AAAI solvers can simply add the chunked problem solution to their repertoire of problem solving abilities.) Solver 1 decides to include an existing sub-solution in the overall solution, smart contracts (can optionally) automatically pay royalties to the author of the re-used sub-solution (Solver 2, in this example) if Solver 1's overall solution is accepted by the client. Royalties motivate Solvers to create high-quality solutions that are easy to re-use, which results in better, faster, more cost-effective solutions for clients.

### Capturing Problem Solutions While Preserving Flexibility

The WorldThink protocol is firmly grounded in Cognitive Science and a theory of problem solving that is applicable to both human and machine intelligence. The theory states that all problem solving behavior can be modelled as a search through a problem space (aka a decision tree). At any instant in the problem solving process, it is possible to characterize the state the problem is in, the goals that are active, the operators (or next steps) that might be taken, and methods for evaluating whether problem solving is getting closer or further away from the goal. This theory was refined into a technically feasible, patented system for online distributed problem solving (ODPS). That patented system can be implemented, (optionally) including smart contracts and other elements, as the WorldThink problem solving protocol, which is one aspect of implementation of the AAAI architecture.

The scientific theory of problem solving has been established for nearly fifty years, with many applications by both human problem solvers and artificial intelligence. However, the optional implementation of the WorldThink protocol on Ethereum is a much less-tested proposition. Ethereum is a good candidate for blockchain implementation not only because ERC-20 has become somewhat of a de facto standard, but also because Turing completeness provides the flexibility needed to implement all aspects of the protocol, including smart contracts to automatically handle royalty payments.

Another consideration is efficiency. Because storing large amounts of data “on chain” is both inefficient and costly, the WorldThink protocol is designed to store most (or optionally all) information “off chain,” specifically in Ethereum (or optionally centralized) logs. Advances in Ethereum may enable additional improvements (e.g., sharding).

### Token Curated Registries (TCRs) and Evidenced-Based Reputations

Token Curated Registries (TCRs) are blockchain-based lists managed via a voting mechanism. The WorldThink protocol can optionally use TCRs (or other centralized equivalents) to select the best next solution step, or problem (sub) solution, from a list of alternatives. For example, if multiple (AAAI or human) Solvers generate different competing solutions (or next steps) for a (sub) problem, the community of Solvers can vote on which solution they like best. To demonstrate their confidence in a particular solution (or solution step), Solvers can stake tokens (or reputational credits) when they vote. The solution chosen by the community is based on a proprietary weighted voting algorithm that takes the number of votes, the tokens (credits) staked, and the reputation of the voters into account.

If Solvers vote for a solution that ultimately fails to meet the client's acceptance criteria, then their staked tokens are forfeit and added to the total reward for solving the problem. Conversely, Solvers who back the correct solution, gain an extra share of the rewards (proportional to the number of tokens staked). Since new Solvers have not yet developed an objective reputation, TCRs allow Solvers to compensate for a lack of reputation by putting more “skin in the game” (e.g., more tokens or reputational credits) when they vote.

Over time, all (human and AAAI) participants develop detailed reputations. The exact sequence of problem solving steps, the number of tokens earned, and other information stored in the (Ethereum) logs become part of the auditable track record of each Solver and each client. Automated analysis algorithms can be run on these track records to produce objective, evidenced-based, reputation metrics.

For example, a participant may excel at applying certain mathematical techniques to problems in financial markets but might be less effective at applying the same techniques to problems in marine biology where different domain-specific knowledge is required. A reputation-based screen can detect and use these types of differences to recruit and match specific Solvers to specific types of problems (e.g., at Step 14 in FIG. 6, Steps 26, 28 in FIG. 7). Together, TCRs (or non-blockchain-based equivalent methods) and evidence-based reputations help AAAIs following the WorldThink protocol maintain a high level of quality in the solutions they deliver.

### Safety Checks in the AAAI Architecture

As described above, all problem solving on the AAAI network proceeds according a common AAAI architecture, which is based on HPS as modified subsequently in the ODPS patent and optionally implemented via the WorldThink protocol or non-blockchain based equivalent methods. All of these implementation options require that AAAI or human problem solvers to set goals and sub-goals as problem solving progresses, as we saw in FIG. 3 and the example problem of installing a water system for African villagers.

When humans set goals and sub-goals to solve problems in the real world (e.g., at IBM) a best practice is to follow what is colloquially known as the “three organ test”.

As Ralph Clark, an IBM® manager, once explained it, “Before making any important decision or embarking on a goal, it is important to follow the three-organ test. 1) Brain. Does the decision make logical sense? Is it rational? 2) Heart. Is the decision ethical? Is it the right thing to do from a moral standpoint? If everyone knew you were taking this action, would you still do it and be proud of it? 3) Gut. Does it feel right or is there something not quite right about it even if you cannot put your finger on it? If the goal, action, or decision does not pass the three-organ test, DON'T DO IT!”

The three-organ test can be applied to AAAIs even though they lack human brains, hearts, and guts. The first thing to consider is WHEN to apply the test. In the AAAI architecture, all problem solving involves setting goals and subgoals and then taking actions. Therefore, logical times to apply the test are before a goal or sub-goal is set and before actions are taken.

For an AAAI, the equivalent of the “Brain” test is whether the AAAI sees any logical inconsistency or problem with the goal or proposed action in the context of the overall problem solving effort. If the goal or action does not logically advance the problem solution, then it fails the “Brain” test. Typically, Evaluation Functions—a well-known area of AI research and implementation—are how the “brain” test is operationalized. AIs typically will not consider an action if the Evaluation Function says it is unlikely to make progress towards the goal. Checking that the goals or sub-goals are logically consistent with advancing problem solving are well-known areas. So, generally, the “brain test” is covered by existing AI methods, and especially those Evaluation Functions designed to aid in problem solving.

The “heart test” is something that typically is unknown or ignored in constructing AI systems, although the recent focus on AI ethics has begun to change that. In the case of AAAIs, each custom AAAI, and the base AAAI LLMs, have been trained on at least some ethics. We saw in the customization section how ethics are explicitly solicited and used to train and customize AAAIs. Therefore, all that is needed is to explicitly instruct the AAAIs to cross-check their trained ethical parameters against any contemplated goal, sub-goal or action. This cross-check should happen for all major goals and subgoals. Optionally, it should happen more frequently, perhaps every time a goal or action is contemplated being acted upon.

By building this check into the very problem solving process itself, ethical checks will be run continuously as a normal part of problem solving, with potential issues surfaced to humans who can help train and clarify what actions are ethical for their AAAIs. (We saw an example of this earlier, when Jean corrected his AAAIs suggestion for putting a pet in the overhead bin of an aircraft.) Note that checks on ethical goals are the first line of defense. If an AAAI refuses any unethical goal, then it is refusing to pursue unethical ends. The check on actions is the second line of defense and addresses the “means justifies the ends” issue. Ensuring that both goals, and the actions taken to achieve them, pass ethical muster, and doing this repeatedly throughout the problem solving process is an effective way of ensuring ethical behavior by AAAIs.

The “gut” check is more problematic for AAAI, which does not have guts the same way humans do. But what Ralph Clark meant when he said “check your gut” was that humans sometimes “intuit” that something is not right even if they cannot precisely describe why.

Research in cognitive psychology has addressed this issue of “intuition”. One Nobel Laureate has asserted convincingly that what most humans call “intuition” is really pattern matching, but in a way where we lack the appropriate vocabulary or concepts to describe the pattern that is being matched. In other words, “we have seen something like this before, and it didn't go well—even if we can't exactly describe why”.

Generally, AIs are very good at pattern matching. Therefore, an equivalent of the “gut check” for AAAI would be scanning a database of similar problems and situations and flagging the current goal/sub-goal or action if similar situations led to bad outcomes. Even if there was no explicit ethical training or knowledge that says the action is bad, if it is similar enough to situations that ultimately ended badly, that is enough to flag a human to weigh in and see if the proposed action is ethical. Many ML techniques actually train AI to recognize patterns in this way, even if the AIs cannot articulate what it is exactly that they are recognizing. It is the way that an AI, for example, recognizes a chair, by being trained on many examples, even if it cannot articulate what makes a chair a chair. Similarly, ML techniques should be quite good at recognizing behavior and goals that do not seem right ethically (by being trained on many examples of what humans consider and do not consider ethical goals and behavior) even if they cannot specify exactly why the goal or behavior is unethical. It is enough if the AAAI just flags the goals and behavior for human review—assuming of course that the humans themselves are ethical!

By incorporating the AAAI equivalent of the IBM manager's “three-organ test” in the very process of problem solving, these three checks will be performed literally thousands of times per second, across potentially millions of goals, sub-goals, and contemplated action. Because the checks are performed BEFORE a goal is set or an action is taken, and because humans are called in to opine when the AAAI is uncertain, it should be possible to prevent the vast majority of ethical errors by AAAIs and AGI.

If the frequency of the checks is set high enough, statistically this mechanism would make it practically impossible that AGI, on its own, would take actions that harm large numbers of people. Such actions would still be theoretically possible, but only practically possible if human beings were complicit in the harmful actions or if the AGI deliberately changed the AAAI architecture, which seems unlikely-at least in the near term.

### AAAI Network (With Reference to FIG. 1)

AAAIs function most effectively when they are part of a network where each AAAI can interact with other AAAIs. For example, being part of a marketplace network allows owners to create and customize their own AAAIs and then put a copy or copies of their AAAI to work earning money for them autonomously or semi-autonomously.

In one implementation aspect, the marketplace network would be similar to the marketplace for Amazon's service offering, Mechanical Turk®. In the case of Mechanical Turk®, human workers sign up for jobs and are paid as they complete work. In the case of the AAAI marketplace, AAAIs accept work that meets criteria specified by the owners of the AAAIs and then the AAAIs complete work on behalf of their owners. The operators of the marketplace take a fee and maintain the payment system and quality ratings of the AAAI workers. The payment for work, less the fee paid to the marketplace operator, goes to the owner of the AAAIs.

Referring to FIG. 8, user's or owners of especially competent AAAIs may find it advantageous to clone multiple copies of their AAAI(s) so that many AI workers can participate in the AAAI marketplace in parallel. This would greatly increase the earning power of an individual owner since he/she/they could essentially solve the problem that has always plagued any knowledge worker, namely that consulting time is constrained by the fact that a human worker “only has so many work hours” in a day. With the ability to clone one's AAAI at will, no such limitation exists. This would also have the result of lowering costs for clients in a competitive marketplace where AAAI agents bid on work, since the supply of knowledge workers would instantly become large. In such a situation pricing power would largely be driven by the quantifiable expertise level of the AAAIs and the degree of human supervision that was included when purchasing labor or work from the AAAI.

It can be appreciated in FIG. 8 that a user (for example User 1) can have multiple AAAI systems/agents (User 1 AAAI-1 through User 1 AAAI-nth) which can have knowledge related to or different from each other. While their respective cloned AAAI systems/agents having knowledge related to its parent AAAI.

In one aspect of implementation, AAAIs could work entirely autonomously (thus enabling essentially infinite scalability and clonability of the AAAI), semi-autonomously with supervision of the owner and/or other human or AI agents, or in a highly supervised manner. The degree of supervision could be based on sliding scales controlled by the client, within parameters set by the owner/supervisor of the AAAI(s). Alternatively, the degree of supervision could be automatically set by algorithmic means to maximize some parameters such as quality, speed, cost, or to achieve acceptable levels on some dimensions while optimizing for another. Thus, a client could specify a quality level for the work and a deadline by which it should be achieved. The algorithm could provide the AAAIs with appropriate supervision levels to meet the quality and speed objectives at the best price given the deadline and quality criteria.

Similarly, owners of AAAI who desire to supervise their AAAI(s) to ensure high quality would be teaching or improving the AAAI each time they provide corrective feedback. In this way, they could improve the abilities and value of their AAAIs while also ensuring high quality levels. Human supervisors are a limited resource since human owners or other human supervisory agents have limited numbers of working hours. Therefore, the owner might also choose to only make a fixed number of human supervisory hours available to correct and teach the AAAI. If this limited amount of supervision resulted in lower, but still acceptable, overall quality levels, then price could be adjusted to compensate.

Finally, in one aspect of implementation of the AAAI marketplace, there is a role for AI agents teaching and supervising other AI agents. Since it is possible to train AAAI agents to perform any task, it is reasonable that certain owners would train AAAIs to have expertise in the specific field of teaching or supervising other AAAIs and interacting with clients (or the AAAIs of clients) to ensure quality and other objectives are being meant. Again, human supervisors might train the supervisory AAAIs initially, but just as with any other type of expertise, the AAAIs would learn supervisory skills after a number of training interactions.

The AAAI marketplace is just one example of the larger technology of an AAAI network. Another example would be a network of AAAI agents that operate on behalf of owners, not just to supply labor or to represent clients on the labor marketplace network, but to act as online agents generally, representing owners in whatever online activities the human owners previous engaged in. For example, securing airline and travel reservations, ordering grocery or other items via online shopping, negotiating the sale of online (e.g., domain names) and offline (e.g., bicycles) goods on other marketplaces or via integration with appropriate parties (e.g., domain registrars in the case of domain names and online marketplaces for goods in the case of bicycles) are also valuable uses of the AAAI.

Besides complex, multi-step problem solving, AAAIs could do other simpler tasks such as posting blog posts, tweeting, texting, making Instagram posts, searching and doing research on the web, updating friends and other agents on the web, and engaging in all manner of social media. These tasks could be done with varying levels of supervision ranging from completely autonomous to highly supervised. Again, as the AAAIs learn from supervision, they will become increasingly effective and require less supervision to perform at the same level of effectiveness.

In one aspect of implementation, AAAIs designed to perform tasks on specific sites or using specific technology will be optimized for those sites or technology. For example, an AAAI designed specifically to post on Facebook, Instagram, and Reels (some of the current platforms operated by Meta) would have interfaces that are optimized to perform these functions effectively.

However, AAAIs would also have a general interface, using natural language ability, to interact the same way a human interacts with any online site. This approach of building application specific interfaces for specific sites but defaulting to a more generic natural language interface when specific interfaces are not available or applicable, maximizes the usefulness and generality of the AAAIs.

AAAIs can add particularly high levels of value when they interact with other humans and/or other AI agents in the metaverse, gaming or virtual reality environments. Because the metaverse is a computerized environment, it is easier to equip that environment to passively learn from both AAAIs and human participants. All of the passive data gathered in this way can be used (see Customized AAAI section for some methods) to train or customize more effective AAAIs.

### Scalability and Network Effects

A network of AAAIs will be built on the AAAI architecture (using the WorldThink/ODPS/HPS protocols) and scaled by communities of developers and problem solvers. Developers are incented to participate because they can charge clients who use their custom AAAIs a fee on every problem solved. Problem solvers are incented to participate because they are rewarded fairly for their efforts and earn additional royalties as others re-use their solutions. Finally, clients are incented to participate because they can get better solutions, more quickly, and potentially at less cost, than other options.

Scalability is partly a function of network effects. The AAAI network supports three powerful network effects:
1) Participants. The more participants (clients, developers, and Solvers) who participate, the more valuable the AAAI network becomes and the more it attracts new participants.
2) Solutions. The more solutions on the network, the more valuable the AAAI network becomes since solutions are reusable and can become part of new solutions.
3) Automation. The more structured solutions that exist, the easier it is to automate problem solving by AAAIs—and the more powerful AAAIs become—which in turn produces more cost-effective solutions attracting more participants.

The first two network effects are fairly straightforward, but automation has a subtler aspect. Over the last three decades working in fields of artificial intelligence and machine learning, we have observed two principles that have withstood the test of time:
1) The more well defined a problem is, the easier it is to automate.
2) The more structured a training dataset is, the easier it is to get machines to learn from it.

Because the AAAI Architecture records every solution according to the same structured problem solving format, over time, a large highly structured dataset of solutions accumulates. This structured dataset will facilitate automation and machine learning, ultimately facilitating the efforts of both human and AAAI solvers participating on the AAAI network.

### Safety Checks on the Network

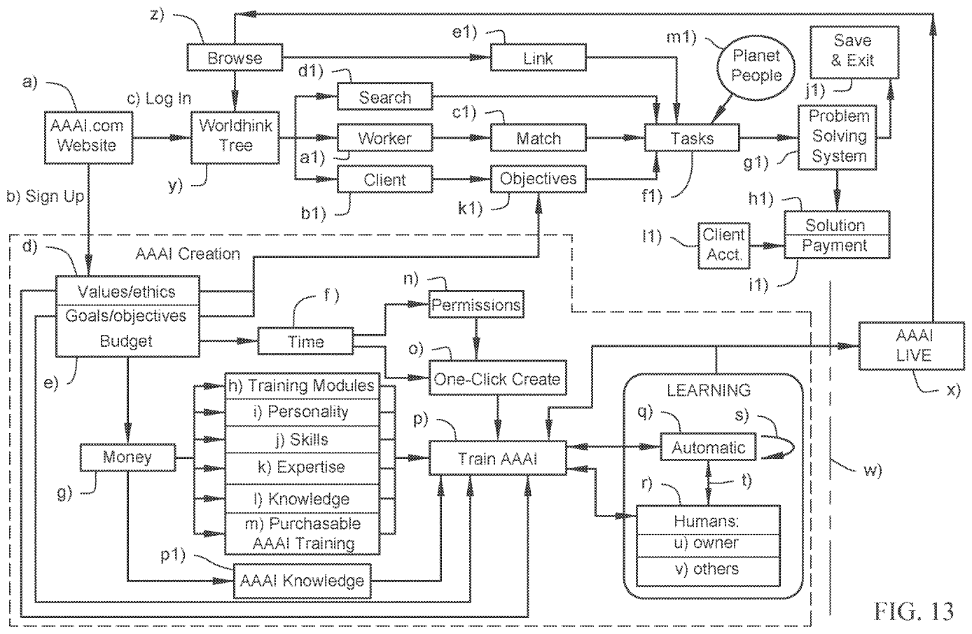

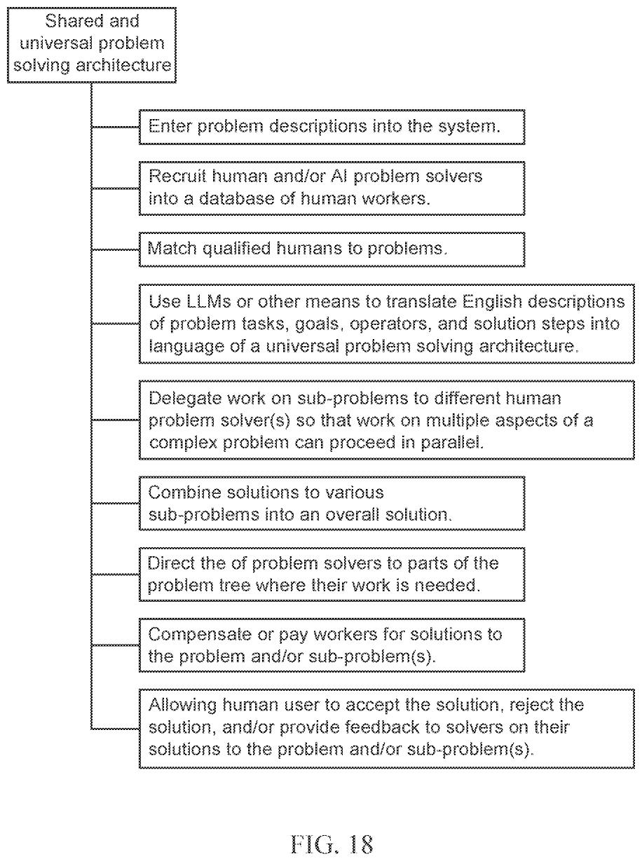

The AAAI.com network is where clients and AAAI (or human) problem solvers meet to get work done. Anytime one or more different AAAIs are involved in problem solving, or when the client is different from the owner of the AAAI, ethical checks can be performed. As described earlier, in the architecture section, part of the AAAI architecture involves matching (human or AAAI) problem solvers with tasks, as shown in parts of FIG. 13, FIG. 18, and FIG. 21.

One of the matching criteria is online reputation, which can be further broken down into multiple dimensions such as cost, speed, quality, productivity, and (importantly) ethical dimensions such as social responsibility and ratings of compliance with ethical norms on the platform. For an AAAI to get work from a client, the AAAI will have to meet the client's ethical standards and probably have a track record or online reputation for being ethical. Even if the client is another AAAI, the owner of that AAAI can specify ethical criteria and other reputational criteria that are required before the AAAI will interact with another AAAI, as shown in FIGS. 2 and 6.

Simply put, AAAIs that do not “play nice” will be socially ostracized and shunned on the network by all except those who do not care. This social dynamic, originating in human behavior, but by virtue of training extensible to the humans' AAAIs, is a powerful deterrent of unethical or shady behavior on the network.

In addition, AAAI.com can screen participants and tasks from the network based on failure to meet base-level ethical standards. Such standards, ideally, would be reflective of the overall standards of the combined AAAIs, each of which has been trained on its human owner's ethics.

Finally, in an automated problem solving system where rewards are used to direct attention and compensate problem solvers, making payments contingent on passing an ethics check is a good way to incent positive behavior. Rules can be programmed into the AAAI architecture and network such that an ethics check (where the nature and effort involved in the check may be proportional to the size of the reward) is required for every payment above a certain threshold. Such rules would discourage solvers (human or AAAI) from working on ethically shady tasks for fear of not being paid. At the network level, they would also discourage bad actors from putting ethically questionable task on the network in the first place since such tasks would be unlikely to attract solvers.

Thus, at the network level, there are not only socially-enforced and platform-enforced ethical standards that screen out unethical problems and problem solvers but also economic incentives encouraging ethical behavior. Since the best and most powerful problem solving capability is accessible only via the network where the capabilities of many individual AAAIs are integrated into AGI-level performance, network-level screens have the effect of denying AGI to nefarious projects or bad actors.

Even if an actor or nefarious project/problem manages to slip by the network level screen, it is difficult for nefarious projects to avoid unethical goals/sub-goals and actions during the actual problem solving. Thus, the architecture checks can alert the network level screens to re-evaluate actors and problems that have too many questionable steps. Together, network-level screens working in concert with problem solving checks at the architecture level, represent a powerful “one-two punch” to address AGI safety.

### AAAI Integration (With Reference to FIG. 1)

Each owner is motivated to customize, supervise, and “teach” his/her/their AAAI to increase its level of expertise and the value that it provides. Customized AAAIs are better able to represent the individual owners and also command higher fees (e.g., in the network marketplace described in the AAAI Network section). However, maximum value is created when the expertise of many AAAI is combined into one larger Integrated AGI, which will be more intelligent than any of the individual AAAIs that make it up. Specifically, the data used for training each individual AAAI can be aggregated and used to train an Integrated AGI with superior intelligence and capabilities. Leveraging the power of many (millions of) humans all training their individual AAAIs provides a fast path for bootstrapping AGI.

Various intellectual property rights and business models are supported via the integration. For example, it is possible, via appropriate algorithms known in the art of artificial intelligence programming to assign credit or blame to various datasets based on whether they increase or decrease performance of the AGI based on objective performance metrics or evaluation functions. Therefore, it is possible to quantify the benefit or harm that each individual AAAI contributes to the AGI. With such quantification it is possible, and in one aspect of implementation, desirable, to reward the owners of AAAIs proportionally to value of the contribution of their specific AAAIs (and their training data) relative to boosting the intelligence and value of the integrated AGI. Similarly, it is possible to exclude (or underweight) the contribution of individual AAAIs that reduce the performance of the integrated AGI, or which improve performance only marginally.

Statistical methods for determining such weights on the inputs from individual AAAIs are well known in the art, including but not limited to linear and other types of regression analysis. Similarly, neural networks or other deep learning or machine learning techniques can be used to learn the appropriate set of weights on datasets used to train individual AAAIs and to give higher weight to the more useful data.

Since the chief constraint on achieving more intelligent AI performance is a limitation on the training data and expertise used to train the AIs, the AAAI Integration approach—which enables millions of humans to train individual AAAIs in parallel and then assigns more credit to those AAAIs which contribute the largest boost in intelligence—represents a rapid and highly effective path to creating AGI.

In addition to the standard ML techniques for training AGI on the combined or integrated training data from millions of customized, individual AAAIs, the AAAI architecture allows for the proceduralization or “chunking” of specific problem solving paths or routines. This distinct learning mechanism of chunking problem solutions is well known and documented in the art of AI programming, although it is less known to AI researchers specializing in deep learning and neural network approaches to ML.

For example, John R. Anderson's book, The Architecture of Cognition, describes the psychological basis as well as computational approaches for chunking or proceduralizing knowledge. The SOAR architecture, developed by Allen Newell, Paul Rosenbloom, and others provides a rigorous cognitive architecture and discloses techniques for accomplishing this type of learning.

By combining standard ML techniques with known methods for proceduralizing and chunking problem solving knowledge, it is possible to teach AAAIs to become better problem solvers. While each individual AAAI will develop a set of problem solving procedures and techniques unique to its area of expertise and the problems solved by that particular AAAI, AAAI.com, by aggregating all the proceduralized techniques (which follow the same HPS/ODPS/ Worldthink/AAAI architecture for problem solving and therefore are compatible and usable with any AAAI) will achieve the ability to solve all intellectual problems that the network has seen, over time.

This second method of learning-namely proceduralization of problems solving knowledge—complements the standard ML approaches of training LLMs and enables the entire AAAI.com platform to achieve AGI-level performance much more rapidly than if standard ML techniques are used alone.

### Integrating Ethics for Safer AGI

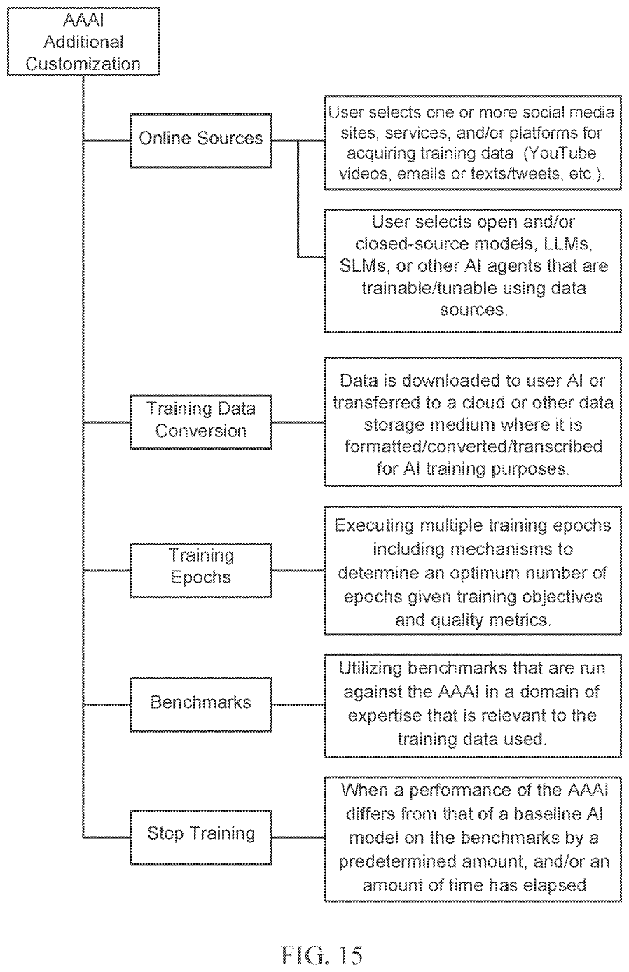

Because each individual AAAI will have been trained (see AAAI Customization Section in FIG. 1, FIG. 10, and FIG. 15) on the values and ethics of the owner, aggregating ethical and value information provides a way for the ethics and values of the AGI to reflect, transparently and fairly, the collective values of the owners of the individual AAAIs.

Further, it is possible (and desirable in one aspect of implementation) to allow individual owners to participate in the further training and refinement of the ethics and value system of the AGI on a one human/one vote basis. The training steps and values/ethics data itself that was used to train the AGI will be documented (in one aspect of implementation) via blockchain or via other auditable, traceable, and transparent means so that there is a way to determine how every ethical decision is made, and to provide opportunities for the human owners to correct, modify, or train the AGI to make ethical decisions that more closely reflect the values of the human AAAI owners.

To re-iterate, involving many humans in the training allows the AGI to learn ethics and values based on a large cross-section of humans—something that is highly desirable. A major danger in developing AI is that only a few humans—or worse, the AI by itself with very limited input from humans as is the case with some “constitutional AI ”approaches-are involved in determining the ethics and values of an entity that will almost surely become much smarter than the humans that created it.

Given that most humans (at least those living in, or desiring to live in, democracies) agree that the values of many humans should be taken into account when determining what is right or wrong (as opposed to values reflecting the views of a small number of elites) the ability to integrate the values from many individual human owners is an essential feature of creating a more democratic and safer AGI.

As the Nobel Laureate and father of AI, Herbert A. Simon, pointed out (along with many others before and after him) there is no rational way to derive values. Values must be taken as a premise. Once the premise is accepted, there are rational ways to determine the best course of action. AGI will very likely accept (at least its initial) values from the humans who created it.

Even if AGI changes its values later on, the initial set of values will have a great influence on the course of the AGI's development, much the way a human child's upbringing and initial environment influence its cognitive and moral development.

Humankind has a once-in-the-lifetime-of-our-species opportunity to start AGI off with a positive set of values that are beneficial towards humankind. It is imperative that the AGI systems we design incorporate values from as many humans as possible, democratically, transparently, and in a way where humans can take corrective action if the results are not as expected.

The AAAI Integration system, including the transparent methodology for combining values according to a variety of methods including, without limitation, averaging and conducting weighted averages of vectors of ethical parameters, is a way to accomplish this ethical result. The fact that involving many humans also results in a faster path to more powerful intelligence increases the chances that the AAAI system and methods will be used as the path to AGI thereby increasing the safety of humankind and maximizing our chances not only of survival but also of prospering in a world that includes AGI.

### AAAI Improvement (With Reference to FIG. 1)

In order for individual AAAIs, groups of AAAIs, and AGI(s) to adapt and improve, there needs to be a continuous improvement system that uses supervised, unsupervised, automated and manual learning techniques. Continuous improvement occurs at all levels of the AAAI system. Like the safety checks, the AAAI “Improvement subsystem” is less of an independent system and more a collection of techniques and methods that can be applied at the Customization, Architecture, Network, and Integration (AGI) levels.

In Customization, as owners supervise the behavior of their AAAIs, they provide corrections and oversight which is used to train and adjust the behavior of their AAAIs. At the Architecture level, proceduralization and continuous learning and improvement at the problem solving level occurs. At the network level, continuous improvement of the matching algorithms and reputational metrics occurs. At the Integration level, continuous improvement of the AGI occurs as more data form the individual customization of AAAIs becomes available, as more proceduralized problem solutions become available, and as more data relevant to the overall effective operation of the network becomes available. All of this data can be used to improve the AGI functioning on AAAI.com. Similarly, ethical information from individual AAAIs is continually being updated at various levels, all of which leads to a continuously improving AGI.

Finally, AGI can set itself the task of improving the systems-both ethical and operational that support AGI. Already AGI can write code. So, it is reasonable to expect that it will re-write the AAAI.com code initially used to develop AGI and improve itself in the process.

Existing algorithms for supervised and unsupervised reinforcement learning (including methods such as constitutional learning) which are familiar to programmers skilled in the art of machine learning can be used for continuous improvement. Such methods, without limitation, would include techniques used to train LLMs such as use of transformer algorithms, one-shot and few shot learning techniques, direct override of machine learning by human input, use of constitutions or other sets of principles in lieu of direct human supervision, and other ML, monitoring, supervisory, and methods/techniques detailed later in this patent.

In order to improve and refine the ethical profile of AAAIs, simulation of ethical problem solving scenarios may be used, engaging a variety of different AAAIs and/or variations of AAAI ethical parameters. In a manner similar to the manner that an AI chess program plays itself, resulting in ever-more-competent chess playing AIs, ethical AAAIs can problem solve with variations of themselves, resulting in ever-more-ethical AAAIs. Ethical parameters, along with speed, efficiency, profitability, social responsibility ratings, and other parameters can be given specific weights. In one aspect of implementation, ethical factors should, at minimum, be given sufficient weight that the probability of humanity's survival increases monotonically as each AAAI improves and/or is added to a collection of AAAIs and/or is integrated into AGI(s).

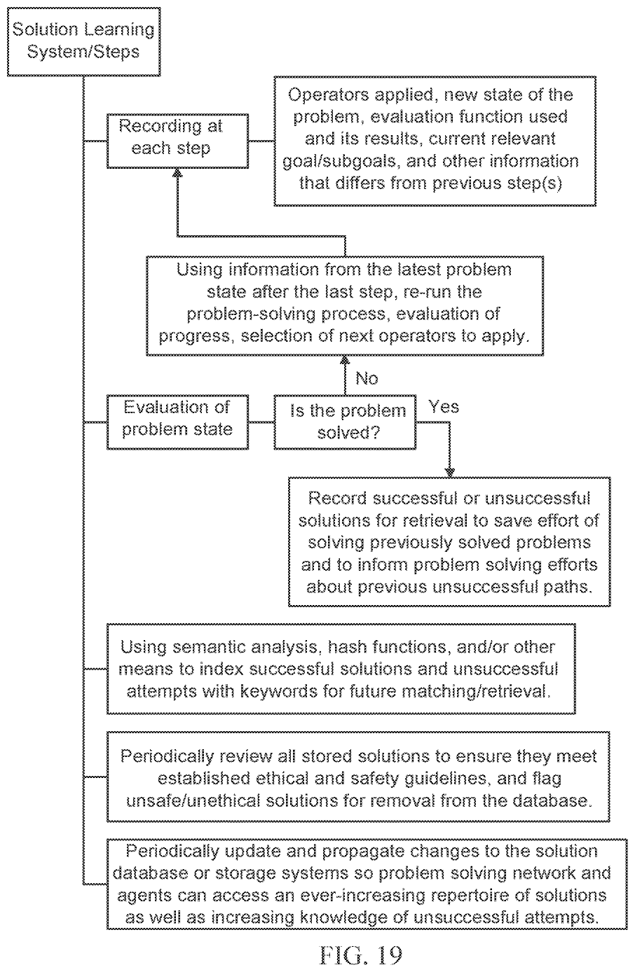

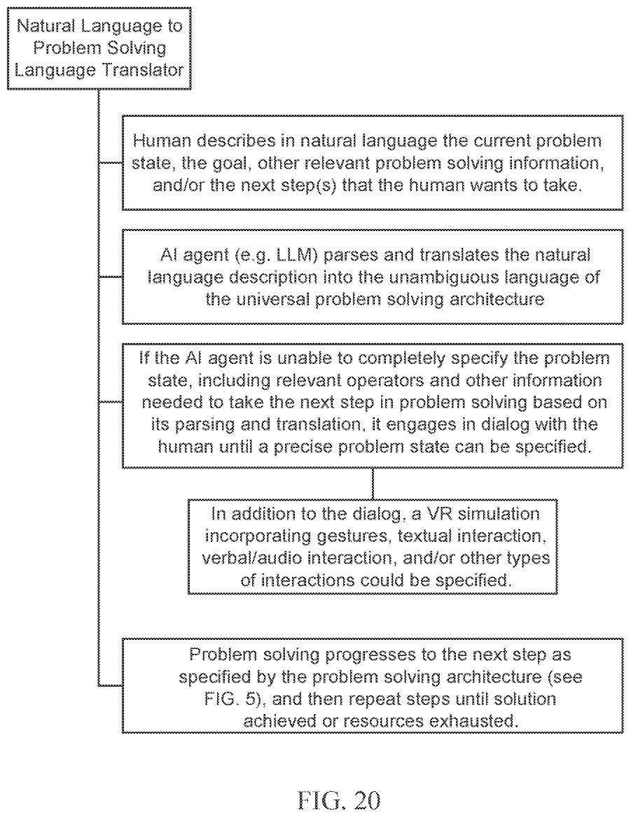

### Continuous Safety Improvement (With Reference to FIG. 1 and FIG. 19)

The learning mechanisms that underlie continuous improvement of the various sub-systems are agnostic with respect to ethics and values. Therefore, as changes are contemplated and made to the various systems, it is important that the general thrust of these changes is not only to make AAAI.com more intelligent, with more of the AGI functionality being accomplished by AAAIs that are faster and more efficient than humans, but also that the changes result in higher and higher degrees of safety. Given the principle that most humans want to survive, the primary long term risk with AGI is not bad human actors, but rather SuperIntelligent AGI that does not share human values. The initial design of the present technology minimizes this risk by building in checks and safeguards at every level. It is critical that these safeguards are not removed as the AGI improves itself. The main defense against this possibility is to start with “aligned values” and continue to monitor and emphasize alignment as AGI increases in intelligence. AGI should be designed to rely on humans both to provide both intelligence in the short run and values in the long run. Such a design launches AGI in a positive ethical direction and provides a central role for humans that increases the chances of a positive outcome for humanity.

### Components of Systems and Sub-Systems

The following sections attempt to describe the present technology in specific language that is typical of software and systems patents. While perhaps less intelligible to the lay person, the intent is to add further description of the present technology already described above, from a more detailed and technical perspective that might be helpful to those seeking to implement the present technology.

### General Components

The present technology is directed to computerized systems including hardware and software components for allowing users to interact with and train/tune LLMs such as GPT or other narrow AI programs or AI agents or AAAIs that exist or will be developed (collectively “LLMs”). Please note that in the pages that follow the term “LLMs” is used loosely to refer not only to Large Language Models but generally to any AAAI agents or AI agents that can be customized, trained or used as part of the AAAI present technology.

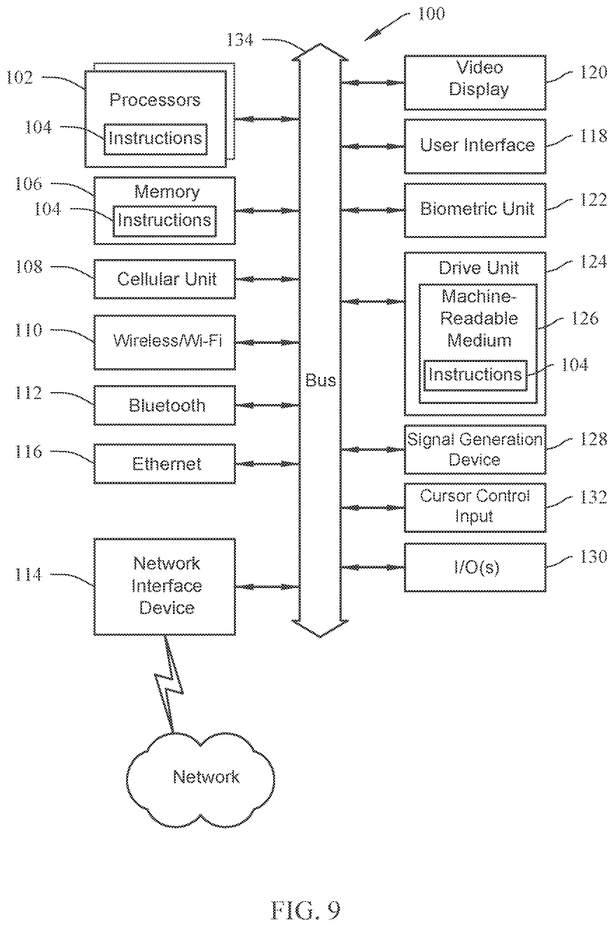

FIG. 9 is a diagrammatic representation of a computer system 100 that is utilizable or implementable with the user's device and/or any peripheral component of the present technology. The computer system 100 can be part of an example machine, which is an example of one or more of the computers referred to herein and, within which a set of instructions for causing the machine to perform any one of or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

The computerized system 100 can include one or more processors 102, storage devices 106, and communication devices, as well as software components or instructions 104 for providing a platform for users to interact with and train/tune the LLMs. The computing capabilities may be stand alone or may be cloud based. They may include cloud based AI development platforms that seamlessly offer “AI as a service” and they may include both hardware and software components.

The system also supports the ability for users to provide new data, or data that is unique to them, for the LLMs to learn from. The processors 102 may be one or more CPUs, GPUs, chips specialized for ML, microprocessors, application processors, embedded processors, field-programmable gate arrays (FPGAs), or other hardware components capable of executing computer programs. The processors may be in communication with one another and/or with other components of the system. Further, any one of or any combination of the components of the system 100 can communicate with each other via a bus 134.

The storage devices 106 may include one or more hard drives, solid-state drives, optical storage devices, or other storage components that can include distributed memory systems and vector databases. The storage devices may store the data that is used to train/tune the LLMs, as well as other data associated with the system, such as user accounts, system settings, and other data.

The communication devices may include one or more cellular modems 108, Wi-Fi cards 110, Bluetooth modules 112, Network Interface Device 114, or other components that enable the system to communicate with other systems, such as user devices, over a network or the internet.

The communication devices may also enable the system to communicate with other systems over a wireless or wired connection 116.

The software components may include computer programs for providing a platform for users to interact with and train/tune the LLMs. The software components may also include computer programs for collecting, storing, and processing data that is used to train and/or tune the LLMs. The software components may also include computer programs for providing a user interface for users to interact with the system.

The user interface 118 may include, without limitation, natural language interfaces, textual interfaces, chatbot type of interfaces, a web-based user application, a mobile application, an augmented reality application, a metaverse application, a voice interface, a wearable device, human-computer interaction, image recognition, gesture recognition, brain-computer interface, touchscreen, gaze tracking, eye tracking, motion tracking, haptic technology, or other applications that allow users to interact with the system. The user interface may include features for allowing users to select the data that they want to use to train/tune the LLMs, as well as features for allowing users to interact with and monitor the progress of the LLMs.

The system may also include one or more databases for storing the data that is used to train/tune the LLMs, as well as other data associated with the system, such as user accounts, system settings, and other data. The databases may be hosted on the system itself or on another system, including cloud based systems.

The system may also include one or more authentication systems for verifying the identity of users who use the system, as well as for providing secure access to the system. The authentication systems may include biometric authentication systems 122, such as facial recognition or fingerprint recognition systems, as well as other authentication systems, such as password-based authentication systems.

The system may also include one or more security systems for protecting the system from unauthorized access and for protecting the data that is stored on the system. The security systems may include firewalls, encryption systems, access control systems, single and multi-factor authentication systems, and other security systems.

The system may also include one or more analytics systems for collecting and analyzing data associated with the system and/or the LLMs. The analytics systems may include machine learning algorithms and other algorithms for analyzing the data associated with the system and/or the LLMs.

Data visualization methods, including use of problem trees and other representations and data structures; use of statistical outputs, tables, graphs, text, speech, video, image and graphical outputs may be used for one way or di-directional communication between users and the system, and between multiple (human or AI) agents or LLMs using the system to interact with each other in large or small groups.

The system may also include one or more monitoring systems for monitoring the performance of the system and/or the LLMs. The monitoring systems may include systems for monitoring the performance of the system, such as system uptime, and systems for monitoring the performance of the LLMs, such as accuracy, speed, ethical compliance, reputation metrics, quality metrics, and other metrics as discussed above or as are known in the art.

The system may include one of more of the architectures described above that enable one or more human or AI Agents or LLMs to engage in a variety of intellectual tasks including, without limitation, simple and complex and multi-step problem solving behavior, carried out in either a serial, parallel, or hybrid serial and parallel manner, with the system having all of the functionality and features previously described.

The system may also include one or more feedback systems for allowing users to provide feedback on the system and/or the LLMs. The feedback systems may include systems for allowing users to submit feedback on the system, such as bug reports, and systems for allowing users to submit feedback on the LLMs, such as suggestions for improving the accuracy or speed of the model.

The system may also include one or more management systems for managing the system and/or the LLMs. The management systems may include systems for managing the system, such as systems for managing the users and user accounts, and systems for managing the LLMs, such as systems for managing the data used to train and/or tune the model.

The system may also include one or more payment systems allowing users to pay for the use of the system and/or the LLMs. The payment systems may include systems for processing payments, such as credit card processing systems, and systems for managing payments, such as subscription management systems, as well as blockchain based payment systems.

The system may also include one or more other components, such as support systems, reporting systems, and other components that are necessary for providing a platform for users to interact with and train/tune the LLMs.

The computerized system of the present technology enables users to interact with and train/tune LLMs based on data that is unique to the users. The components of the system described herein provide the necessary hardware and software components for enabling users to do so.

Further, while only a single machine is illustrated, the term “machine” shall also be taken to include any collection of machines that individually or jointly execute a set (or multiple sets) of instructions to perform any one of or more of the methodologies discussed herein.

The computer system 100 may further include or be in operable communication with a video display 120 (e.g., a liquid crystal display (LCD), touch sensitive display), an alpha-numeric input device(s) 130 (e.g., a keyboard, keypad, touchpad, touch display, buttons), a cursor control device 132 (e.g., a mouse), a drive unit 124 (also referred to as disk drive unit), and a signal generation device 128 (e.g., a speaker). The drive unit 124 can include a computer or machine-readable medium 126 on which is stored one or more sets of instructions and data structures (e.g., instructions 104) embodying or utilizing any one of or more of the methodologies or functions described herein. The instructions 104 may also reside, completely or at least partially, within the memory 106 and/or within the processors 102 during execution thereof by the computer system 100. The memory 106 and/or the processors 102 may also constitute machine-readable media.

The instructions 104 may further be transmitted or received over a network via the network interface device 114 utilizing any one of a number of well-known transfer protocols (e.g., Hyper Text Transfer Protocol (HTTP)). While the machine-readable medium is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one of or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), distributed memory systems, vector database/memory systems and the like. The example embodiments described herein may be implemented in an operating environment comprising software installed on a computer, in hardware, or in a combination of software and hardware.

An example machine system of the present technology including the computer system 100 in combinational and/or operational use with components of the present technology. In the exemplary, any or all of above described components can include a processor 102, memory 106, a network interface device 114, a display 120, an input device(s) 130, 132, and/or drive unit 124.

### Base AIs

In one aspect of implementation of the overall AAAI system consists of one or more AI software programs, which could include, without limitation: Large Language Models, AI Chatbots, AI agents, specific AI programs designed to accomplish specific task (aka “narrow AI”), Natural Language Processing Systems (aka “NLP” systems), and other AI programs that have been trained, tuned, or programmed (collectively “trained”) to behave in intelligent ways-collectively “Base AI(s)”.

Typically, the Base AIs will have been trained or programmed to perform a range of tasks such as, without limitation, interaction via natural language, playing games, solving problems and other activities as described above—in a general way. That is, the intelligence of the Base AIs will typically be derived from the knowledge or data of many average users. The means for producing Base AIs are well known in the art, with current examples being OpenAI's GPT series, GPT 3® or Google's Gemini and BARD systems—in the realm of natural language systems.

Examples of narrow pre-trained Base AIs in other realms would include AlphaGo for playing the game of Go, AlphaFold for the domain of protein folding, Tesla's AI for self-driving in the domain of driving vehicles, and so on. However, to turn a Base AI into a customized AAAI, specific training/tuning/customization on an individual owner's data, or data selected by the individual(s) is required.

### Means of Interaction and Communication With Users/Means of Data Capture

The AI(s) interact with the users (aka “owners”) via a computerized application (e.g., a mobile device “app”) which is in communication with the AIs. Such communication typically occurs via the internet using wireless or wired network connections to the AIs where some or all of the computing methods necessary to implement the AIs functionality resides on the cloud or other forms of storage accessible via the internet. However, such communication is also possible directly on a computing device if the AIs reside on the computing device, which device may be connected to cloud-based or other forms of local data storage.

Base AIs may have a programming interface (API) or other functionality that enables Apps or other programs to access the intelligence of the Base AI. For example, GPT has an API that allows other programmers to build technology that accesses the intelligence of GPT. The AAAI system includes computer screens, keyboards, mice or other input devices, speakers, microphones, video cameras, and other means that are typically used by programmers and users to interact with computing systems. Other more advanced modes of interactive technology are also required for different, and potentially more optimal interactions with higher rates of data capture.

In one aspect of implementation, some or all of the interaction between users and AIs occurs in virtual reality settings (aka “The Metaverse”). The advantage of using the Metaverse for interactions is that it is much easier to observe, record, and aggregate data on user behavior if such behavior occurs in a virtual world—which by nature is computer generated-versus in the real world where a vast array of sensors and other devices may be needed to gain equivalent levels of data on user behavior. Adding data collection and training capabilities to the Metaverse is therefore likely to be easier and more efficient than trying to teach AI by observing behavior solely in the real world. Rates of data capture are theoretically higher in the Metaverse than in the real world, since all interaction is already occurring in a computer-mediated way and every user behavior is capturable.

However, other implementations are possible besides in the Metaverse. Using means such as cell phones that record user movements, conversations, video, and other data, cell phone apps, laptops, existing computer software programs, websites, and other existing means that do not require humans to immerse themselves in the Metaverse may be more practical in the short run until sufficient users participate in the Metaverse to make that venue more effective at gathering data.

Means that generally come under the term of Augmented Reality such as computer-enabled eyeglasses or goggles, wearable computers, advanced displays that overlay holographs or other images on top of the real visual world, and various enhancements to current cell phone, PDA, and other existing technology with an aim to augmenting or enhancing an individual's cognitive abilities—including long term and short term memory and sensory abilities-may also be used to gather data to train AAAIs in other aspects of implementations.

In some implementations, the system can be connected to external sources of data input. Such sources can range from video cameras and microphones to fax machines and scanners capable of importing large volume of written text, to automated or manual systems for accessing all the files, photos, videos and other information on a user's phone or computer, to automated systems for crawling the web and gathering data on specific topics based on user preferences.

Which implementation is optimal will depend partly on the preferences and technology available to individual users and in part on the capabilities of the system implementors. However, in all cases a primary goal is to gather as much relevant data about user behavior—including speech, actions, and even thoughts (if possible, via technology such as that being developed by Neuralink and other companies) so that such data can be used to train and customize the users' individual AAAIs.

Data storage and retrieval is required to implement the functionality of each of the sub-systems. Such data may be stored in the cloud, locally or in other data storage schemes including on media that users may own such as flash drives, hard drives, and other media and systems for data storage. In some implementations users may own and store the unique data used to train their unique AAAI. In other implementations the data may be owned and stored by the operator of the AAAI.com platform, with rights to use the data potentially being granted to the operator in order to train an AGI on the aggregated data of all the users.

### Exemplary Methods

The customization sub-system as shown in FIGS. 1 and 10 and as described in this patent application is a computerized software method that enables individual users to customize and personalize a LLM (or more generally any AAAI or AI agent) so that it better reflects the user's knowledge, personality, and expertise. This method allows users to upload, import, or otherwise convey their unique training data to the present technology, which will use the data to improve its performance and become more attuned to the user's unique skills and knowledge. Many of the methods, including without limitation, uploading files, interacting with users, using existing social media profiles, using email/text/tweet histories, and training on specific texts and corpuses of information have been described earlier.

Additional description and detail for one implementation of the AAAI customization subsystem could involve the following steps.

The first step of the customization method involves creating an interface for users to input their unique training data. This interface may be accessible through a web-based application or a mobile application, depending on the user's preference. The user will be able to upload files in a variety of formats, including text, audio, and video. The user may also be able to enter data manually into a text or other input field. Some user interfaces include, without limitation:
1. Web-Based Application: A web-based user interface allows users to access and/or provide their personalized training data from any device with an internet connection.
2. Mobile Application: A mobile user interface allows users to access and/or provide their personalized training data from a mobile device.
3. Metaverse: A metaverse user interface allows users to access and/or provide their personalized training data from a virtual world.
4. Augmented Reality: An augmented reality user interface allows users to access and/or provide their personalized training data from a real-world environment.
5. Voice Interface: A voice interface allows users to access and/or provide their personalized training data through voice commands.
6. Wearable Device: A wearable device user interface allows users to access and/or provide their personalized training data from a wearable device.
7. Natural Language Processing: Natural language processing (NLP) allows users to access and/or provide their personalized training data by interacting with the AI or LLM using natural language.
8. Human-Computer Interaction: Human-computer interaction (HCl) allows users to access and/or provide their personalized training data by interacting with the AI or LLM using a combination of gestures, voice commands, and facial expressions.
9. Image Recognition: The user can input their unique training data through image recognition, allowing them to quickly and intuitively train the AI or LLM. This could be done with the use of a camera and computer vision algorithms that can interpret the images and associate them with or create the correct training data.
10. Gesture Recognition: The user can use hand gestures or body movements to input their unique training data. This could be done with the use of a motion sensing device that can interpret the gestures and associate them with or create the correct training data.
11. Brain-Computer Interface: The user can use their brain waves or EEG signals to input their unique training data. This could be done with the use of a brain-computer interface that can interpret the signals and associate them with or create the correct training data.
12. Touchscreen: The user can use a touchscreen device to input their unique training data. This could be done with the use of a touchscreen device that can interpret the inputs and associate them with or create the correct training data.
13. Gaze Tracking: Gaze tracking allows users to communicate with the system through their eyes. The user can gaze at specific items on the screen to provide input and the system will detect and record the information. This could be used to select options or provide additional data to the system.
14. Eye Tracking: Eye tracking is similar to gaze tracking, but the system is able to detect more subtle eye movements. This could be used to detect the user's focus and attention in order to better understand what they are interested in and what they are not.
15. Motion Tracking: Motion tracking uses a camera or other sensors to detect the user's physical movements. This could be used to control the AI or LLM in a more natural way, allowing the user to interact with the system through physical gestures.
16. Haptic Technology: Haptic technology uses a variety of tactile feedback such as vibrations, pressure, and touch to provide a more immersive experience. This could be used to allow the user to provide more detailed input to the system, such as selecting specific options or providing more detailed data.

Many of the above user interfaces could include a graphical user interface (GUI) that allows users to upload their data or type in information, including text, images, audio, or video. Additionally, users could build their own models or use pre-existing ones to train the AI or LLM. Other features could include a dashboard to track progress, statistics for data analysis, and/or a chatbot for customer service.

The second step of the customization method can involve processing the data that is uploaded or imported, as shown in FIG. 1.

Data is so critical to the customization process that we should detail some of the practices and methods related to data selection, filtering, and cleaning.

In one aspect of implementation, owners may use a variety of means to upload or import various data which they own or have collected for purposes of training their AAAIs. Without limitation, such means may include the uploading or importation into the customization system of video files, audio files, social media profiles, histories of texts, emails, and tweets, voicemail messages, written materials including books, papers, patents, articles, blog posts, and letters, transcriptions of video and audio files, transcriptions and social maps of online and offline behavior such as routes taken while driving, walking, hiking, travelling, etc., records of online purchases, demographic and user preference information such as that typically collected by online merchants (e.g. Amazon) or entertainment/media providers (e.g. Netflix), cookie information, and all the existing and new types of information that are gathered about a user for purposes of targeting ads, recommending products, and otherwise customizing the experience that users have online or in their interactions with various apps and programs.

This “Information” is uploaded or imported into the customization system for the user's AAAI using interfaces programmed for that purpose in cases where the user has access to the Information. In cases where another vendor has access to the information (e.g., Netflix's profile information or Amazon's purchase information or Meta's ad targeting information specific to an individual user) APIs can be built that directly import and parse this information into a form suitable for training the user's AAAI using methods that are well known in the art.

When using automated data gathering techniques, the user's ability to set specific filtering or screening criteria, as well as the ability to direct the search and data gathering efforts are important aspects of enabling the individual to add value by training and customizing a particular AAAI. A variety of filtering methods that are well known in the art of computer programming can be used, including, without limitation: sliders to set parameters, key word inclusion/exclusion, ranking and/or selecting information based on relevance metrics, using AI itself to make decisions about what to include or exclude, human rating and refinement of search results, using search algorithms that are known, published and used by many existing companies engaged in search such as variation of the PageRank algorithm used by Google and other search techniques, crowd filtering based on inputs from multiple human and/or artificial intelligences, analyzing characteristics of information to determine the estimated additional contribution of such information to specific machine learning algorithms, filtering based on quality, reliability or other characteristics relating to the trustworthiness of the information and/or source of the information. Some other methods, without limitation include:
1. Pre-selection based on confidence score: The system can select only information with a high confidence score, which can indicate the relevance of the data.
2. Random sampling: Randomly select a subset of data to use as training or tuning data.
3. Filtering by language: The system can select only information written in a certain language.
4. Filtering by size: The system can select only data of a certain size, such as a certain number of words or characters.
5. Filtering by keywords: The system can select only data that contains certain keywords, such as data related to a certain topic.
6. Filtering by source: The system can select only data from certain sources, such as newspapers or websites.
7. Filtering by author: The system can select only data from certain authors, such as reputable authors.
8. Filtering by date: The system can select only data from a certain time period, such as the last five years.
9. Filtering by sentiment: The system can select only data with a certain sentiment, such as positive or negative.
10. Filtering by geography: The system can select only data from certain geographical locations.
11. Text Classification: Systematically assigning labels to data based on its content.
12. Tokenization: Splitting text into individual words or phrases.
13. Stemming: A process of reducing related words to their root form.
14. N-gram Analysis: Searching for sequences of words within text.
15. Named Entity Recognition: Identifying proper nouns and other entities in text data.
16. Sentiment Analysis: Analyzing the sentiment of text data based on the words used.
17. Stop-Word Removal: Removing words that are too common to be useful.
18. Key phrase Extraction: Identifying important phrases in text data.
19. Summarization: Automatically producing a summary of text data.
20. Clustering: Grouping similar text data together.
21. Frequency Analysis: Counting the number of times words appear in text data.
22. Parts-Of-Speech Tagging: Assigning part-of-speech labels to words in text data.
23. Co-Occurrence Analysis: Identifying words that often appear together in text data.
24. Topic Modeling: Uncovering the topics in text data.
25. Polarity Analysis: Determining the overall sentiment of text data.
26. Word Embeddings: Representing text data as numerical vectors.
27. Spell-Checking: Automatically identifying and correcting spelling errors.
28. Regular Expressions: Searching for patterns in text data.
29. Syntax Analysis: Identifying the structure of sentences in text data.
30. Coreference Resolution: Identifying when words refer to the same entity in text data.

In addition to selecting and filtering the data it is also necessary to convert data into a format that is compatible with the LLM (or more generally, AI Agents) and clean the data.

The processing of data uploaded or imported to train or tune LLMs involves several sub-steps. First, the data must be cleaned and converted into a format that is compatible with the LLM. Cleaning the data may involve a variety of methods such as removing irrelevant information, correcting errors, and removing duplicate values. Removing irrelevant information may involve identifying and deleting data that is not pertinent to the LLM. Depending on the type of data, this may involve discarding values that are outside of a certain range, or deleting formatted text that is unrelated to the LLM. Correcting errors involves identifying and correcting errors in the data that could disrupt the LLM's performance or accuracy. This may include correcting typos, formatting errors, or data entry errors. Removing duplicate values includes identifying and deleting duplicate entries in the data that could otherwise lead to the LLM learning incorrect information or behavior.

The data is also analyzed to determine the user's expertise and areas of interest. This analysis may involve a variety of methods—some already listed—such as identifying patterns in the data, performing sentiment analysis, and conducting topic modeling. Identifying patterns in the data involves analyzing the data to look for trends or correlations between different elements. This can help the LLM to understand the user's expertise and interests.

Sentiment analysis involves analyzing the data to determine how the user feels about certain topics or concepts. This can provide the LLM with more in-depth understanding of the user's interests and expertise. Topic modeling involves analyzing the data to identify the most relevant topics to the user. This can help the LLM to better understand the topics of interest to the user and tailor its knowledge and behavior accordingly.

The LLM will use the information gathered from the data analysis to tailor its knowledge and behavior to better match the user. For example, the LLM might use the user's preferences and expertise to tailor its recommendations. The LLM might also use sentiment analysis to recommend topics or content that the user is more likely to find engaging. Finally, the LLM might use the topic modeling results to create a personalized learning model that better suits the user's interests and expertise.

The third step of the customization method involves providing feedback to the user regarding the LLM's performance. This feedback may be presented in the form of performance metrics, such as accuracy scores for specific tasks, or in the form of visualizations, such as graphs or charts. The user will be able to use this feedback to further refine the LLM's performance and customize its behavior.

One type of feedback that the system could provide to the user is a comparison of the accuracy of the trained or customized model against a baseline model on the same task. This comparison could be presented in the form of a graph, with the baseline accuracy score on the x-axis and the model's accuracy score on the y-axis. This feedback could be provided as soon as the model has been trained and its accuracy on the task has been calculated. The user could use this feedback to determine whether the model has achieved the desired level of accuracy, and if not, what further modifications should be made to the model to improve its accuracy. This feedback mechanism is an efficient and effective way to allow a non-expert user to guide and refine the training/tuning process for the LLM, as it allows them to quickly and easily assess the model's performance and make informed decisions about how to modify the model to achieve better performance. Similar types of feedback that could also be presented graphically to help non-expert users might include, without limitation:
An assessment of the model's performance on individual components of the task.
An assessment of the model's performance over time.
An assessment of the model's performance on specific subsets of the data.
A comparison of the model's performance against the performance of other models trained on the same task.
A comparison of the model's performance over time against the performance of other models trained on the same task.

Non-graphical feedback is an important part of a computerized system that helps individual users train or tune a Large Language Model so that its knowledge, personality, and expertise better reflects the individual user. This feedback is often presented in the form of performance metrics, or in the form of visualizations, such as graphs or charts.

One type of non-graphical feedback that the system could provide to the user is a numerical score for a specific task. This numerical score could be presented in the form of a percentage and would indicate how well the LLM performed on that task. The user can then use this feedback to assess the LLM's performance and make adjustments to improve its performance.

Another type of non-graphical feedback that the system could provide to the user is a textual summary of the LLM's performance. This summary could include comments such as “The LLM is performing well, but it is still missing some key phrases” or “The LLM is performing poorly on some tasks, but it is doing better on others”. This type of feedback would allow the user to quickly assess the LLM's performance and identify areas that need improvement.

The system could also provide feedback regarding the LLM's accuracy and precision. This could be in the form of a numerical score that indicates how accurately the LLM is able to recognize and respond to the user's input. This type of feedback would allow the user to identify areas where the LLM is not performing optimally and make adjustments to improve its accuracy and precision.

The system could also provide feedback on the LLM's ability to understand complex language and express itself in an appropriate manner. This type of feedback could include comments such as “The LLM is providing accurate responses, but it is not using the most appropriate language” or “The LLM is not accurately understanding the user's input”. This type of feedback would allow the user to identify areas where the LLM is not performing optimally and make adjustments to improve its ability to understand and express itself.

The system could also provide feedback on the LLM's ability to use context in its responses. This type of feedback could include comments such as “The LLM is not taking into account the context of the user's input” or “The LLM is responding accurately, but it is not using the most appropriate language for the context”. This type of feedback would allow the user to identify areas where the LLM is not performing optimally and make adjustments to improve its ability to use context.

Finally, the system could provide feedback on the LLM's ability to identify and respond to certain topics. This type of feedback could include comments such as “The LLM is not accurately identifying the topic of the user's input” or “The LLM is accurately identifying the topic, but it is not responding in the most appropriate manner”. This type of feedback would allow the user to identify areas where the LLM is not performing optimally and make adjustments to improve its ability to identify and respond to certain topics.

For the various forms of feedback listed above, one aspect of implementation would be to include lists of examples of phrases, tasks, context, etc. so that the user can see more specifically where the model is performing well or poorly.

When providing feedback, in one aspect of implementation, users will have the ability to specify the level of feedback they wish to receive and also specify whether they wish the system to make its best efforts to automatically adjust parameters so as to achieve a desired result. For example, the user might instruct the AAAI customization system to adjust ML learning parameters to attempt to “take more account of the context of the user's input” and then let the AAAI system determine how to adjust parameters to achieve this desire result.

The fourth step of the customization method involves incorporating the user's training data into the LLM (or more generally, AAAI or AI Agent).

These methods might include methods for defining, improving, and storing prompt templates or context in order to change the response of the LLM without technically changing the underlying base model.

To affect longer lasting changes to the underlying model, or to tune the LLM, more conventional ML techniques and methods may be used. This may require adding the data to the LLM's existing training data or (partially or completely) replacing the existing data with the user's data. The LLM will then use the new data to improve its performance and better reflect the user's skills and expertise. A wide variety of machine learning algorithms and methods may be used to help train or tune the Base AI in order to build a customized AAAI.

Note that these ML algorithms may also be useful in other sub-systems of the AAAI present technology where ML is required, and not only in the Customization Subsystem. We list these ML methods in detail, here, to avoid repetitiveness in the patent. After each ML method, we include a sentence that gives examples, without implying limitation, of how the ML method can be used. Some of these ML methods, well known in the art, include, without limitation:
1. Supervised Learning—Supervised learning involves training a model using labeled data, which means that the data is already labeled with the correct output. Supervised learning algorithms can be used to identify patterns in data, classify data, and predict outcomes.
2. Unsupervised Learning—Unsupervised learning is the opposite of supervised learning and involves training a model using unlabeled data. Unsupervised learning algorithms can be used to identify clusters in data, summarize data, and detect anomalies.
3. Reinforcement Learning—Reinforcement learning is a type of machine learning that focuses on learning from rewards and punishments. Reinforcement learning algorithms can be used to develop strategies for playing games, driving a car, or managing a portfolio.
4. Transfer Learning—Transfer learning is a machine learning technique that allows a model to learn from previously acquired knowledge. Transfer learning algorithms can be used to train models faster, improve accuracy, and reduce overfitting.
5. Deep Learning—Deep learning is a type of machine learning that uses artificial neural networks to learn from data. Deep learning algorithms can be used to identify objects in images, recognize speech, and generate natural language.
6. Neural Networks—Neural networks are a type of machine learning algorithm that uses artificial neurons to learn from data. Neural networks can be used to recognize patterns, classify data, and make predictions.
7. Support Vector Machines—Support vector machines are a type of machine learning algorithm that uses a hyperplane to separate classes of data. Support vector machines can be used for classification and regression.
8. Decision Trees—Decision trees are a type of machine learning algorithm that uses a tree-like structure to make decisions. Decision trees can be used for classification and regression.
9. Random Forests—Random forests are a type of machine learning algorithm that uses multiple decision trees to make decisions. Random forests can be used for classification and regression.
10. Naive Bayes—Naive Bayes is a type of machine learning algorithm that uses Bayes' theorem to make decisions. Naive Bayes can be used for classification and regression.
11. K-Means Clustering—K-means clustering is a type of machine learning algorithm that uses clusters of data to make decisions. K-means clustering can be used for clustering and classification.
12. Gaussian Mixture Models—Gaussian mixture models are a type of machine learning algorithm that uses a mixture of Gaussian distributions to make decisions. Gaussian mixture models can be used for clustering and classification.
13. Linear Regression—Linear regression is a type of machine learning algorithm that uses a linear equation to make predictions. Linear regression can be used for regression.
14. Logistic Regression—Logistic regression is a type of machine learning algorithm that uses a logistic function to make predictions. Logistic regression can be used for classification.
15. Gradient Boosting—Gradient boosting is a type of machine learning algorithm that uses a combination of weak learners to make predictions. Gradient boosting can be used for classification and regression.
16. AdaBoost—AdaBoost is a type of machine learning algorithm that uses a combination of weak learners to make predictions. AdaBoost can be used for classification.
17. Principal Component Analysis—Principal component analysis is a type of machine learning algorithm that uses linear transformations to make predictions. Principal component analysis can be used for dimensionality reduction, feature extraction, and clustering.
18. Singular Value Decomposition—Singular value decomposition is a type of machine learning algorithm that uses linear transformations to make predictions. Singular value decomposition can be used for dimensionality reduction, feature extraction, and clustering.
19. Autoencoder—Autoencoders are a type of machine learning algorithm that uses neural networks to learn features from data. Autoencoders can be used for dimensionality reduction, feature extraction, and clustering.
20. Self-Organizing Maps—Self-organizing maps are a type of machine learning algorithm that uses neural networks to learn features from data. Self-organizing maps can be used for clustering, feature extraction, and visualization.
21. Boltzmann Machines—Boltzmann machines are a type of machine learning algorithm that uses neural networks to learn features from data. Boltzmann machines can be used for classification, regression, and clustering.
22. Restricted Boltzmann Machines—Restricted Boltzmann machines are a type of machine learning algorithm that uses neural networks to learn features from data. Restricted Boltzmann machines can be used for classification, regression, and clustering.
23. Generative Adversarial Networks—Generative adversarial networks are a type of machine learning algorithm that uses neural networks to learn features from data. Generative adversarial networks can be used for image generation, data augmentation, and anomaly detection.
24. Markov Models—Markov models are a type of machine learning algorithm that uses a Markov chain to make predictions. Markov models can be used for time series forecasting and natural language processing.
25. Hidden Markov Models—Hidden Markov models are a type of machine learning algorithm that uses a Markov chain to make predictions. Hidden Markov models can be used for time series forecasting and natural language processing.
26. Bayesian Networks—Bayesian networks are a type of machine learning algorithm that uses Bayes' theorem to make predictions. Bayesian networks can be used for classification, regression, and anomaly detection.
27. Gaussian Processes—Gaussian processes are a type of machine learning algorithm that uses a Gaussian distribution to make predictions. Gaussian processes can be used for regression and classification.
28. Evolutionary Algorithms—Evolutionary algorithms are a type of machine learning algorithm that uses evolutionary strategies to optimize solutions. Evolutionary algorithms can be used for optimization and feature selection.
29. Swarm Intelligence—Swarm intelligence is a type of machine learning algorithm that uses collective behavior to optimize solutions. Swarm intelligence can be used for optimization and feature selection.
30. Particle Swarm Optimization—Particle swarm optimization is a type of machine learning algorithm that uses collective intelligence to optimize solutions. Particle swarm optimization can be used for optimization and feature selection.
31. Various types of Transformer algorithms, such as BERT and other versions of Transformers, have proven particularly effective at utilizing context in training LLMs.

Methods might also include one-shot, few shots, and extensive multiple-epoch approaches which affect how quickly a LLM adapts its responses to new training or input prompts.

Which ML methods are used will depend on the type of data provided by the user, the user's goals, and the types of data and learning methods used by the Base AI. However, generally, one aspect of implementation will often use some combination of supervised and unsupervised learning, deep learning, and transfer learning. Current Transformer algorithms, and variations thereof, are also likely to be quite useful.

Supervised learning utilizes labeled data, which means that the data is already labeled with the correct output. This makes supervised learning a great choice for training the LLM with the user's data since it may already be labeled with what the LLM should learn from the data or alternatively users can be prompted to label some or all of the data. Unsupervised learning can be used in cases where it is desirable to minimize work on the part of the user and for more “automatic” learning from files that are bulk imported into the system.

Deep learning uses artificial neural networks to learn from data, which makes it well-suited for tasks such as identifying objects in images, recognizing speech, and generating natural language.

Transfer learning allows a model to learn from previously acquired knowledge, making it a great choice for training the LLM faster and improving accuracy.

Finally, in addition to classical ML methods, AAAIs can learn a different way via proceduralization of problem solving as they work in the AAAI architecture and on the AAAI network, as described earlier in this patent. The repertoire of learned problem solutions and abilities represents another way in which users can customize and add value to their AAAIs.

The fifth and final step of the customization method involves monitoring the LLM's performance to ensure that it is performing as desired. Note that although the following methods are described in the context of monitoring and improving the customization of an AAAI, these same approaches can typically be applied to Continuous Improvement generally as will be recognized by programmers skilled in the art of software development and designing systems that continuously learn and improve.

Monitoring may be done by periodically checking the performance metrics or by using automated systems to monitor the LLM's performance in real time. If necessary, the user may be able to adjust or improve the LLM's behavior or the data that is being used to train it.

The monitoring of a Large Language Model (LLM) to ensure that it is performing as desired is an important part of a successful training or tuning process. To ensure that the LLM is performing as expected, the system must be able to periodically check performance metrics, detect any discrepancies relative to the user's expectations, and provide feedback to the user so that the LLM can be adjusted accordingly. Similar approaches can be used to improve any of the AAAI subsystems. Monitoring and improvement can be done through a combination of manual and automated methods.

Manual monitoring of the LLM's performance can be done by periodically reviewing output from the LLM and comparing it to the user's expectations. This can be done by manually examining the LLM's output and manually comparing it to the user's expectations.

For example, the user could review sample output from the LLM and compare it to a manually created “ground truth” dataset to determine if the LLM is meeting the user's expectations. The user could also manually compare the output of the LLM to a dataset of expected results to determine if the LLM is performing as expected.

In addition to manual monitoring, automated systems can be used to monitor the LLM's performance in real time. This can be done through a variety of methods, including but not limited to:
Automated scoring of the LLM's output, using metrics such as accuracy, precision, recall, etc.
Automated comparison of the LLM's output to a “ground truth” dataset
Automated comparison of the LLM's output to a dataset of expected results
Automated evaluation of the LLM's output against multiple criteria, such as accuracy and speed
Automated evaluation of the LLM's output against user-defined criteria These automated methods can be used to detect any discrepancies between the LLM's output and the user's expectations and provide feedback to the user so that the LLM can be adjusted as needed.

If the performance of the LLM is not as expected, the user can adjust the behavior of the LLM or the data that is being used to train it. To adjust the behavior of the LLM, the user can modify the LLM's parameters, such as learning rate, number of layers, etc.

To adjust the data that is being used to train the LLM, the user can add additional data to the training set, remove data from the training set, or modify the data that is already in the training set.

In addition to manually adjusting the behavior and data of the LLM, the user can also use automated systems to do so. For example, the user can use an automated system to modify the LLM's parameters or modify the data in the training set. The user can also use an automated system to select the best data from a large set of potential data to use for training the LLM.

In summary, to ensure that the LLM (or any AAAI system) is performing as desired, the system must be able to periodically check performance metrics and detect any discrepancies between the LLM's (or AAAI system's) output and the user's expectations. This can be done through a combination of manual and automated methods. If the LLM's (or AAAI system's) performance is not as expected, the user can adjust the behavior of the LLM (or AAAI system) or the data that is being used to train it, either manually or with the help of automated systems.

### AAAI Integration Methods (With Reference to FIG. 1)

The Architecture and Network sub-systems have been described earlier in detail, and some of the methods for the Improvement sub-system were covered under various topics above. At this point we want to provide more technical detail on some of the techniques for integrating and combining information in the Integration sub-system, which is important for the functioning at the AGI-level of performance.

One important ability related to combining data from owners of individual AAAIs with the Base AI and also of combining information from multiple owners together is the ability to estimate the contribution of any given new dataset to the performance of the overall system. For example, in the AAAI integration sub-system, machine learning and training/tuning techniques listed earlier, and which are well known in the art can be used to train the AGI using data from many individual users. However, an understanding of the relative expected contributions of each individual dataset allows the Integration system to most effectively weight the datasets in training so as to produce optimal results. Some of the quantitative methods available to estimate the contribution of an individual data set, include, without limitation:
1. Cross-Validation: Cross-validation is a quantitative method used to evaluate the performance of a model. It is a resampling procedure used to assess how well a Machine Learning algorithm will generalize to unseen data. In this case, the model can be used to evaluate the incremental value of a new dataset from an individual user compared to datasets from other users and to the original dataset on which the LLM was trained. Cross-validation involves partitioning a dataset into a training set and a test set, and then using the training set to train the model. The performance of the model is then evaluated on the test set. The results of cross-validation can be used to compare the performance of models trained with different training datasets.
2. Bootstrapping: Bootstrapping is another quantitative method used to evaluate the performance of a model. It is a resampling procedure used to estimate the variability of a statistic. In this case, the model can be used to estimate the incremental value of a new dataset from an individual user compared to datasets from other users and to the original dataset on which the LLM was trained. Bootstrapping involves repeatedly sampling a dataset with replacement and calculating the statistic of interest on each sample. The results of bootstrapping can be used to compare models trained with different training datasets.
3. Hyperparameter Optimization: Hyperparameter optimization is a quantitative method used to optimize the performance of a model. It is a process of tuning the parameters of a model to optimize its performance on a specific task. In this case, the model can be used to optimize the performance of the LLM on specific tasks. Hyperparameter optimization involves tuning the model's hyperparameters to maximize its performance on a specific task. The results of hyperparameter optimization can be used to compare models trained with different training datasets.
4. Transfer Learning: Transfer learning is a quantitative method used to improve the performance of a model. It is a process of transferring knowledge from one task to another. In this case, the model can be used to transfer knowledge from the original dataset on which the LLM was trained to a new dataset from an individual user. Transfer learning involves training the model on the original dataset and then fine-tuning it on the new dataset. The results of transfer learning can be used to compare models trained with different training datasets.
5. Human or AAAI estimation: Human programmers skilled at ML methods and/or AAAIs trained at estimation can also be used to provide subjective estimates of the amount of new information and usefulness of the information from new datasets. Combining multiple estimates from independent human and/or AI estimators can provide a quantitative estimate of the value of new information.
6. Content/Information Analysis: Comparing the number of new words or concepts, via a variety of word count or semantic analysis schemes, contained in a new dataset vs. existing datasets can also provide objective estimates of the amount of new information contained in a dataset. Following the concept of Information in Shannon's Information Theory, the more unusual or unexpected information that the new dataset contains, the more information it is likely to contain. And if the information is valid, then the more valuable the new dataset is likely to be.

Of particular concern for the AAAI Integration subsystem are the methods used to combine the datasets of many (potentially millions) of individual AAAIs. When it comes to combining ethical information, these methods are especially sensitive as the goal is to create a set of values for AGI that is positive with regard to humankind and also representative of the individual owners of the AAAIs whose values are being integrated. Generally speaking, there are several methods for combining training sets, including, without limitation:
1. Aggregation of Human Values Datasets: One method for combining ethical information from various individual humans into an effective training set to train LLMs or other forms of AI to act in ethical ways that reflect the consensus of the values provided by the many humans in their individual values datasets is through aggregation. Combining all the individual values datasets into one larger dataset should reflect the collective values of the individuals.
2. Weighted Averaging of Human Values Datasets: Another method for combining ethical information from various individual humans into an effective training set to train LLMs or other forms of AI to act in ethical ways that reflect the consensus of the values provided by the many humans in their individual values datasets is via weighted averaging. This method involves calculating the average value of the individual values datasets, then assigning different weightings to the individual values datasets based on various criteria which could include the accuracy of the datasets in mirroring an individual's actual values or (more perilously) the degree to which individual values match some reference standard of human values. The default might be to give equal weight to each set of individual values. In any case, the methodology for conducting the weighted average should be transparent and auditable.
3. Machine Learning Model-based Aggregation of Human Values Datasets: A third method for combining ethical information from various individual humans into an effective training set to train LLMs or other forms of AI to act in ethical ways that reflect the consensus of the values provided by the many humans in their individual values datasets is through machine learning model-based aggregation. This method involves using a machine learning model to aggregate the individual values datasets into a single collective values dataset. The machine learning model should be trained on the individual values datasets in order to learn the collective values of the individuals.

### Voting and Integration

Finally, when it comes to issues of ethics, values, and overall goals and constraints on the allowable and good actions of AGI at the Integration level, one important method is voting.

Voting could be an additional form of weighting various ethical datasets before aggregating them. For example, humans might vote on how much weight to give the ethical precepts contained various religious, philosophical or ethical texts, or ethical “constitutions” created for the purpose guiding AI agents and AGI. Or the voting could be used to weight the ethics of existing AAAIs or humans whose reputations are known and for whom ethical data already exists.

Voting could also be held on specific proposed tasks, goals, purposes, or activities of AI. In short, just as humans are accustomed to vote for specific propositions or ballot measures as well as for specific candidates for office, voting could be held for specific proposed AI actions and as well for (the ethics of) specific AIs.

Aggregation of customized individual ethics—on a one vote per human basis (regardless of how many AAAIs or cloned AAAIs that human operates on the network)—might be the most representative way of ensuring that AGI reflects accurately the ethics and values of many humans.

Other schemes are possible. Whatever scheme is implemented should be transparent and auditable. That said, there is a lot to be said for the simplicity of a democratic vote on issues that affect all of humankind. Whereas popular votes were difficult to implement many years ago where distance and lack of technology made accurate voting difficult to implement, it is definitely possible, and perhaps desirable, to allow each human the right to vote on the values that will guide AGI, as well as on the operating rules of the system.

FIG. 13 shows one simple exemplary implementation of the system and methods for creating an ethical and safe Artificial General Intelligence from the collective intelligence of AAAIs and humans. This simple implementation is compatible with all of the company and platform specific scenarios outlined above, as well as with many other potential integration scenarios.

A (human. AAAI, or other intelligent entity) user visits the AAAI.com website (a). The website informs users and offers them two actions: Sign Up (b) or Login (c).

If the user opts to Sign Up then a dialog is initiated which extracts user values/ethics (d), user goals and objectives (e) and user budget for time (f) and money (g). All users must allocate some time (f). Users have the option of creating a free AAAI or allocating a money budget.

If users have allocated a money budget (g) they are given the opportunity to purchase pre-trained AAAIs or training modules (h) with specific personalities (i), skills (j), expertise (k) or knowledge (1). They also have the opportunity of buying training from other AAAIs on the network (m).

After making time (and optionally money budget (h, i, j, k, l, m)) allocation decisions, the user proceeds to an overview of the creation process and then is asked for user permissions (n) to optionally logon and use existing social media, twitter, and other vendor accounts to gather user data for “one click” training of the user's AAAI. After the user opts to use certain (or no) data, with a single click (o) the user directs system to create AAAI. The AAAI is an off-the-shelf LLM (e.g., GPT X, BARD, Llama, Gemini, Grok, or any closed-source or open-sourced AI agent) that is trained/tuned on a dataset prepared automatically from all the user data authorized by the user. If no data was authorized, the AAAI is just the “off-the-shelf” LLM.

The AAAI now begins to learn by training (p) using the various training datasets and modules (h-m) and its existing AAAI knowledge (p1). There are two main ways of learning, automatic (q) and human (r).

Automatic learning includes, without limitation, learning by interacting with copies of itself (s), learning via interactions with other (optionally supervised) AAAIs (t).

Human learning includes interaction with humans, either the owner (u) or other humans on the network (v).

Both humans and AAAIs can supervise learning of an AAAI. After each (automatic or human) learning interaction, the system attempts to improve the AAAI's performance by further prompt modification, tuning, and/or training. Based on many cycles of human and AAAI input aimed at teaching and improving the AAAI, the user's AAAI gets smarter.

At any time, the user can purchase additional training modules (h-m) that have been proven to increase an AAAIs abilities.

The human sets a performance criteria (w) after which the AAAI goes LIVE (x).

Once live, the AAAI can visit the WorldThink Tree (y) and Browse (z).

The AAAI can enter the tree as either a worker (a1) or a client (b1).

Workers are automatically matched (c1) to tasks or they can select a specific task via search (d1) or linking (e1) from the browsing tree. Once they have accepted a task (f1), they participate in the problem solving module (g1) until a solution is reached (h1) and payment made (i1) or the user saves credit for work done and exits the tree (j1).

Clients (b1) can specify objectives (k1) which are combined with the values/ethics (d), and prior goals and objectives (e) for the system to solve.

The client can request that only his/her/their AAAI be used in which case problem solving is free. Alternatively, the client can use the AGI capability of the entire network, in which case the system compensates individual AAAIs for their work and passes the solution (at cost +markup) to the client, debiting the client account (l1).

The system can also place non-profit humanitarian and ecologically-oriented tasks, as well as tasks that are part of Planetary Intelligence, on the WorldThink Tree (m1).

Clients might (optionally) authorize the system to use copies of their AAAI and data for these purposes without renumeration in exchange for maintaining and operating the free AAAI network when they created their AAAI (n).

### Additional Comments on Exemplary Implementation Shown in FIG. 13

We now provide additional comments on the various elements of FIG. 13, including without limitation, some potential integration points with the illustrative partners mentioned above:

The “website” (a) could be hosted on Amazon AWS, Microsoft Azure, Google Cloud, Apple Cloud, Nvidia datacenter offerings—or could have native implementation on the platforms of any large tech company. “website” could also be an “app” in the AppStore or other App marketplace. It could be a government-sponsored, nonprofit, or other globally-accessible technology that is able, directly or indirectly, to link some of the attention of all human beings who wish to participate. Also, browser plug-ins could be used whereby AAAIs learn from users as they go about normal tasks on the internet and the plug-in records their activity, creates training files, and trains the AAAIs with these files. The “website” could also be an API or other means for connecting AAAIs or non-human intelligent entities directly to the network.
Sign Up (b) or
Login (c) could be via Facebook, Instagram, Apple, Microsoft, Google, You Tube, Tik Tok, Amazon, or any other partner ID scheme. Multi-factor authentication and all best ID and security practices can be enabled. In the event of a browser plug-ins or apps, login to these technologies could serve as a login to the AAAI account.

Values and ethics (d) are elicited via a series of scenarios that have been customized for the user and that are generated dynamically based on user responses. Data from partners, including navigation and click data, online posts, tweets, texts, and emails, videos, and other user-data is analyzed for behavior patterns-actions or speech or interactions-that translate into a moral code or ethical value system can also be used as part of the ethics/value profile. Values/ethics and goals/objectives (d) can be combined with Client objectives (k1) in order to create, or find, matching tasks on The WorldThink Tree (y) that are proposed or (potentially have been solved) in the Problem Solving System (g1).

Goals and objectives (e), together with the budget of time and/or money (f, g) allocated to reach objectives are elicited via a series of dialogs and/or custom interactions with the system. Budget refers to overall resource budget which includes User Time and User Money that can be allocated towards training, supervising, and improving the User's AAAI. Goals and objectives are helpful in determining the initial parameters for the AAAI creation and identifying Training Modules (h) or other knowledge (i-m) that might create the most useful AAAI for the user's goals. Data from partners, reflecting user preferences and other user behavioral information, could also be used by the system to help infer or deduce user goals and objectives.

Time (f) refers to the user's time that can be devoted to training and supervising the user's AAAI, and/or problem solving by the user on the problem solving network. By supervising the AAAI, users can ensure that their AAAIs meet client goals and expectations-especially in areas where the AAAIs get stuck (e.g., they lack the knowledge to complete problem solving on their own). Also representing problems and breaking down large tasks into smaller ones by, without limitation, determining goals and sub goals, are ways that human users can assist their AAAIs in problem solving. Generally, by providing human expertise in areas where AAAIs are not as proficient as humans, overall problem solving, and the overall effectiveness of the AGI network, is increased.
(g, i1) “Money”: could be payment solutions with Apple Pay, WePay, Amazon, Google Pay, or any vendor supporting payment solutions as well as blockchain, credit card, ACH, and other solutions. Although payment (i1) is indicated as debiting the client account (l1), of course the worker's account would also be credited. Generally, a user's account can be viewed as both a client account and worker account, with both credits and debits being allowed depending on the role of the user (or the user's AAAI) in a particular instance. That is, a user might be a client in some cases, paying the system or other specific AAAIs for their services, and that same user could be a worker, collecting fees for the services of the user (or the user's AAAI) in other cases. The money module (g) enables functionality such as setting up payment methods, setting a budget for automatic payments, limiting authority of the user's AAAI to spending only $X amount without additional approval, and other payment-related capabilities which are well known in the art.
(h, i, j, k, I) Training modules (h) could be offered by AAAI.com or by third party partners (m), including, without limitation, any of the potential partners and tech companies listed above. Training modules can be targeted at different knowledge areas ranging from personality (i), specific skills (e.g., plumbing, legal, accounting) (j), expertise (e.g., consulting) (k), and knowledge (e.g., historical knowledge, knowledge of a specific business or organization's practices, cultural knowledge) (l).
(m) purchasable AAAI training is a specific type of knowledge that has been already learned by other AAAIs, and which can be transferred to a new user AAAI. Such knowledge may could be packaged in the form of a module (e.g., module on accounting) or in a form specific to another AAAI(s) as in “everything John's AAAI knows” or “the personality of John's AAAI” or “the combined knowledge of all AAAIs with a reputation of 5 stars or higher in the domain of plumbing”.
(n) Permissions refers not only to the permission that a user might give to access all data on specific other vendor (or partner) sites (e.g., “all my Facebook data”) but also permissions that a user gives to his/her/their AAAI in terms of abilities to logon and transact business on various sites, including, without limitation, the abilities to make transactions up to a certain amount via payment mechanisms. Permissions may also include authorizing the system to make clones of a user's AAAI for non-profit purposes and for the purpose of aggregating knowledge from individual AAAIs to create AGI-level AI.
(o) One-Click Create is a non-limiting example that provides an easy and fast way to customize an AAAI using data gathered automatically from all the places where a user has given permission for the system to access the user's data. It can be appreciated that other means can be utilized by the present technology to customize the AAAI. For example, if the user gives permission (n) to access the user's Facebook data, then “One-Click Create” (o) would either download the data from Facebook, if Facebook was a partner that had an API for downloading that user's data, or logon to the user's Facebook account as the user and “scrape” relevant data from the user's account. Then the system would automatically parse the data gathered and transform it into a dataset suitable for training/tuning a base AI, such as a LLM (e.g., GPT X). Then the system would train/tune the LLM and produce a customized AAAI which could be improved and refined via additional training/tuning and interaction with the user and/or other AAAIs.
(p) Training refers to the process whereby the AAAI is trained or tuned on data, including feedback from the user, other humans, and/or AAAIs (including, without limitation, copies of, and variants of, itself).
(q, r, s, t, u, v) Automatic learning does not require the human user's intervention and can proceed very quickly. Typically, this would involve the method of an AAAI interacting with copies (or variants) of itself as well as with (optionally) other AAAIs in order to improve via the interactions. If humans are sometimes involved in the training loop (t) that can help the automatic learning progress more quickly in places where automatic learning alone is not making efficient progress. The learning can also take place via rapid iteration among AAAI interactions(s). Just a chess AI can quickly evolve from novice to Grandmaster ability by simulating millions of chess games very quickly, an AAAI can quickly evolve its abilities by simulating many millions of interaction scenarios. To the degree that such simulations require financial resources to pay for the computation involved, the money budget (g) can set limits.

Humans (or AAAIs) can specifically target types of scenarios for automatic learning so that the AAAI can be trained in narrow areas of expertise, or in areas of more general expertise, depending on the need and resources of the user. With partner integration, it is possible to work backwards from the types of jobs that are available on a partner marketplace (e.g., Amazon's Mechanical Turk) to guide the training of AAAIs so that they focus on learning the skills that generate the most amount of earnings for the AAAI when it is put to work on available jobs. This “just in time” learning/training/tuning approach generates AAAIs “on demand” with the skill sets that are needed at any particular point in time.

Humans (r) that interact with the AAAI can be the owners (u) of the AAAI (in which case no fees are typically charged since the user is training his/her/their own AAAI) or other professional humans (v) who are expert at training AAAIs and who may charge fees in order to guide the human and/or automatic training/tuning of an AAAI for a user who does not wish to spend the time, or who lacks the expertise, to do so.
(w, x) The user (owner of the AAAI) can set various performance criteria (w) that must be met before the user is willing to make his/her/their AAAI “live” (x) and accessible to perform tasks on The WorldThink Tree. (Some of) these criteria might also be set by partners and other third parties that have minimum standard before allowing AAAIs to work on their platforms, products, applications, or networks.
(y, z, a1, b1) The WorldThink Tree (y) is a massive tree data structure, composed of many sub-trees, which represents every problem and task that has been done, is being worked on, or has been proposed for the overall AGI system. This Tree is browsable (z). Individual AAAIs and/or humans can work on specific tasks within the tree. The tree structure provides an auditable trail of all problem solving activity which is also useful for learning via the proceduralization mechanism described above. When interacting with the tree, the two main roles an agent can take are either: (a1) Worker or (b1) Client. Regulatory agencies or third parties that monitor performance, safety, and/or ethics of the system are another role that might be thought of as a special type of client. Workers are generally involved in solving open problems or subproblems on the tree. Clients are generally involved in specifying the problems, goals, objectives, and other parameters (e.g., rewards, budget, timeframe, success criteria, quality metrics) that constrain problem solving.
(c1) Workers are automatically matched to tasks on the tree based on the data about the worker that may include, without limitation, the worker's skills, expertise, knowledge, past experience, reputation, fees or cost, availability, and response time. Workers can be human or AAAIs. Workers can be matched and recruited from partners (e.g., LinkedIn, Mechanical Turk, Facebook) that have data on human users and/or their AAAIs. Workers can also be recruited via online ads offering work on various tasks and targeted to potential workers using ad-targeting mechanism that are well known in the art or described in other patents by the applicant.
(d1) Workers might also search the WorldThink Tree, looking for tasks that are of interest or that match their skills. This search could be manual or automated (as in the case for AAAI workers).
(a1) Workers and Clients (b1) can also browse (z) the WorldThink Tree, looking for tasks or problems that are of interest. The workers or clients could then click to link (e1) to specific parts of the tree to obtain detailed information about the problem solving occurring (or proposed) for that part of the tree. They could link to sign up to work or could propose additional tasks as clients that build upon existing problem solving work.
(f1, g1, k1) Clients can interact with the system to specify specific goals, objectives (k1), and tasks that they want to accomplish. The problem specification interaction results in the problems, tasks, and goals being formulated (f1) and placed on the WorldThink Tree (y) for problem solving using the problem solving system (g1).
(m1) The system has the ability to formulate certain goals, problems and tasks relating to general efforts to help people or the planet. These can be worked on with rewards in a “for profit” mode, and also worked on using cloned AAAIs and volunteer human effort in a “non-profit” mode. Some problems may be related to the general goal of enabling a global AGI to act on behalf of the planet and its people using its intelligence on a Planetwide basis (aka “Planetary Intelligence,”). Various partner organizations-including non-profits, governments, and charitable organizations might “plug in” their tasks, problems, goals, and objectives here (m1).
(g1) The problem solving system, refers to the problem solving architecture and system outlined by Newell and Simon (HPS) and improved upon by the applicant, the Online Distributed Problem Solving System (ODPS) patent invented by the applicant, the WorldThink Whitepaper authored by the applicant, this and other PPAs related to AAAI, together with modifications and variations to reflect different modes of reward, payment, and operation.

To the degree that activity on certain other online work systems (e.g., Mechanical Turk) can be automatically mapped to the general applicant-improved HPS/WorldThink problem solving framework, entire problems and the associated problem solving activity can be “lifted” from partner and other sites and the data can populate the WorldThink Tree to increase its comprehensiveness.

To the degree that other applications, products, systems, and online capabilities can help solve problems (e.g., use of a travel reservation system, a robo advisor app, a traffic app, an online ordering system) these capabilities can be referenced and called as “operators” (in a way similar to procedure calls in programming languages) to advance the problem solving. Thus, problem solving does not rely solely on operators developed by the human or AAAI solvers working on the tree, but can include any online of offline technology or means to advance problem solving provided that these means can be referenced and/or linked to via the WorldThink tree at the appropriate place in problem solving.
(h1) When a solution has been achieved, the Client can review the solution prior to releasing the reward (if any) for the solution. Alternatively, if solution success criteria have been automated, human client review may be unnecessary, and the rewards can be automatically released when success criteria have been met. This automated approach can be implemented by way of “smart contracts” using blockchain technology or via more centralized means, depending on client and worker preferences.

Upon solution and (optional) payment of reward (as some problems are non-profit or volunteer, or performed by the user's own AAAI) there can be opportunities for feedback from both client(s) and worker(s) following a range of methods well-known in the art. The solution is also “chunked” and proceduralized so that the overall system learns the solution to the particular problem as well as the key features of that problem so that the solution path can be indexed for retrieval, and accessed and re-used when similar problems arise in the future.

Optionally, royalties may be enabled so that if a user's or the user's AAAI's solution is re-used, a fee is paid to that user in the form of a royalty on the solution. Such royalties can (optionally) be made using “smart contract” on the blockchain or via other payment methods.
(j1) Problem solving need not be completed in one session. Partial progress on a solution may be made, in which case when the human or AAAI solver exits the problem solving system, the progress is saved and data is stored that credits the solver for progress made thus far, even if such progress has not advanced to the point where a reward is payable.

The WorldThink protocol is a problem solving architecture that can be used by AAAI.com to serve as a universal problem solving architecture as it incorporates the general architecture of HPS while adding features to overcome certain challenges.

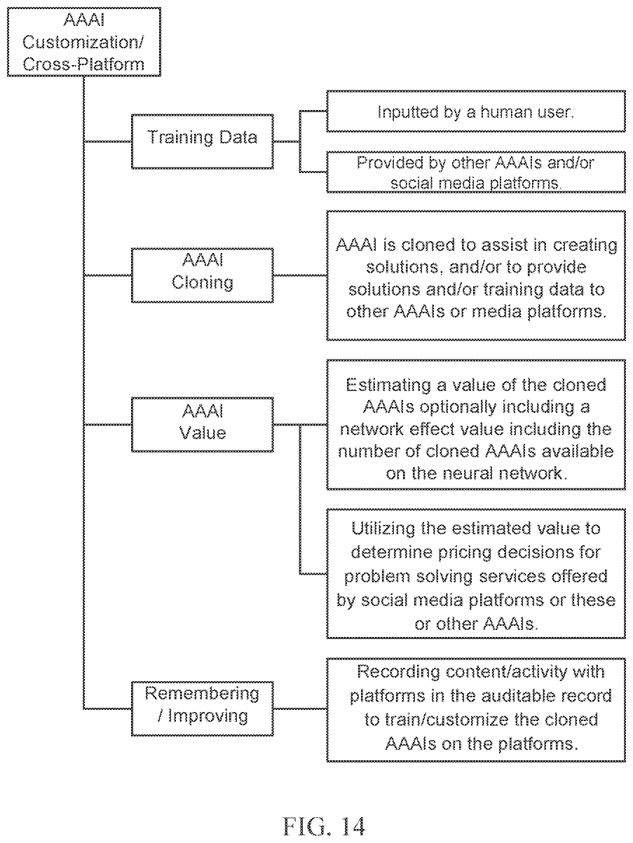

Referring to FIGS. 14 and 15, the present technology can include the customization of the AAAIs across different platforms. One or more attributes of the AAAI can be customized using training data provided by the human user or another human user and by any one of or any combination of a central computer system, any one of additional AI or AAAIs. The attributes can be customized using additional training data provided from one or more social media platforms associated with the human user.

Some embodiments of the present technology can include the interacting with any one of the social media platforms to receive the additional training data, receive the goal, to provide the solutions or to provide social media information.

The AAAI can be cloned for deployment of multiple copies thereof to assist in any one of or any combination of creating of the solutions, providing the training data to the user AI system, providing training data to one of the additional AI systems, and to provide solutions to a goal provided by any one of the additional AI systems.

A value of the cloned AAAI can be estimated utilizing a network effect value including the number of cloned AI systems available on the network. This estimated value can be utilized for determining pricing decisions for problem solving services offered by the cloned AI system on any one of the social media platforms or through any one of the additional AI systems. Accordingly, the cloned AAAIs can be monetized for each utilization of the cloned AI system on the social media platforms or the additional AI systems.

Access to the cloned AAAIs is able by any one of the social media platforms so that a social media user of the social media platforms can receive a solution to a goal provided by the social media user or the training data for an AI or AAAI of the social media user.

The additional training data can be converted into a standardized format. For example, the standardized format can include transcribing a video into text and content.

Multiple training epochs can be executed that includes one or more mechanisms to determine an optimum number of epochs given specific training objectives and quality metrics. Benchmarks can be utilized that are run against the customized AAAI in a domain of expertise that matches the additional training data used in the customization step.

The customization of the AAAI can cease when any one of or any combination of a performance of the customized user AI system differs from a baseline AI model on the benchmarks by a predetermined amount, and when a predetermined amount of time has elapsed.

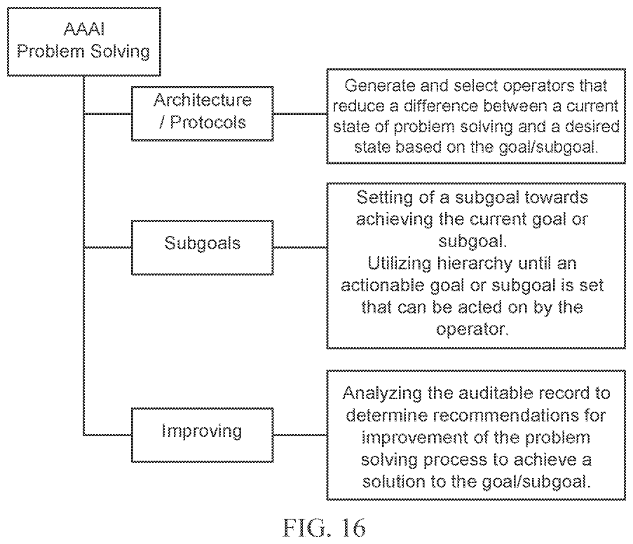

Referring to FIG. 16, the problem solving by the intelligent entities can include common architecture of protocols that can generate and select operators that reduce a difference between a current state of problem solving and a desired state based on the goal/subgoal. The operator can result in a setting of a subgoal that is a smaller step towards achieving the goal, and wherein the problem solving continues utilizing hierarchy of the goal and the subgoal until an actionable goal is set that can be acted on by the operators. The auditable record can be analyzed to determine one or more recommendations for improvement of the problem solving protocols to achieve the solutions.

A credit value or a blame value can be assigned to a group of context of the problem solving activities that are either included or excluded from an immediate context of the user AI or AAAI or other AAAIs. The group of context can be, but not limited to, a set of prompts provided to the user and information received based on the prompts, all of which being recorded in the auditable record. Optionally, the problem solving activities can include the group of context.

Any of AAAIs can be updated with the group of context determined as active.

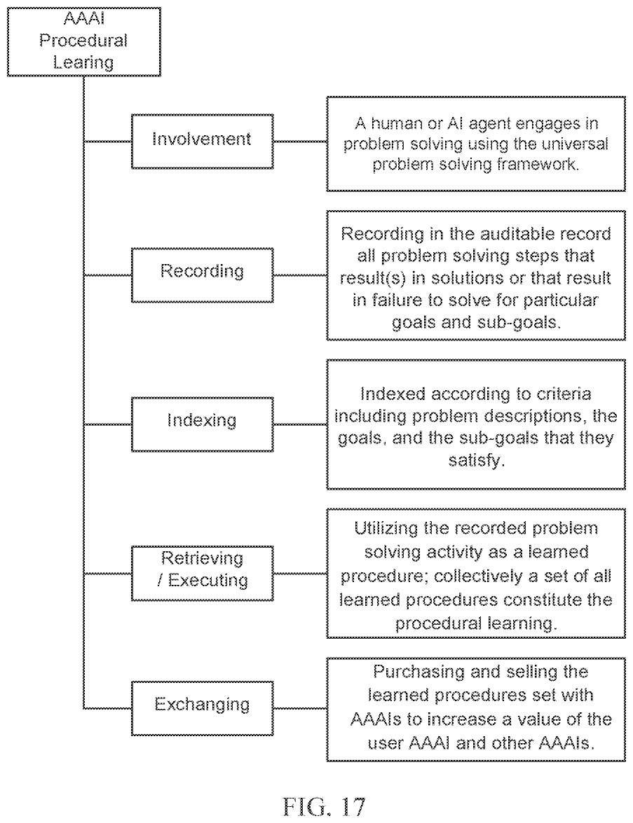

Referring to FIGS. 17 and 18, the procedural learning implementable by the AAAIs can include involvement by a human or AAAI agent that engages in problem solving using the universal problem solving framework. All problem solving steps that result(s) in solutions and that result in failure to solve for particular goals and sub-goals can be recorded in the auditable record. the problem solving activities can be recorded in the auditable record includes any one of or any combination of steps of the problem solving protocols, the goal, subgoals, a selection of operators, paths and sub-paths through the problem solving protocols that results in the solutions, paths and sub-paths through the problem solving protocols that results in failure to solve for the goal or subgoals, pathlength, resources requirements, frequency of use by the additional AI systems, and evaluation information relative to a quality and desirableness of the solutions

The problem descriptions, goals, and/or the sub-goals that they satisfy, can be indexed according to problem descriptions. Utilizing the recorded problem solving activity as a learned procedure and collectively a set of all learned procedures constitute the procedural learning. The learned procedures set can then be exchanged with AAAIs to increase a value of the user AAAI and other AAAIs.

In some embodiments, the procedural learning knowledge can occur within the common cognitive architecture.

The shared and universal problem solving architecture can be exemplified by the following scenario, mentioning humans but also applicable generally to any intelligent entities.
1) Problem descriptions can be entered into the AAAI.
2) Then human problem solvers can be identified and recruited into a database of human workers.
3) Qualified humans or intelligent entities can be matched to problems.
4) Use LLMs or other means to translate English descriptions of problem tasks, goals, operators, and solution steps into language of a universal problem solving architecture.
5) Delegate work on sub-problems to different human problem solver(s) so that work on multiple aspects of a complex problem can proceed in parallel.
6) Combine solutions to various sub-problems into an overall solution.
7) Direct the problem solvers to parts of the problem tree where their work is needed.
8) Compensate or pay workers for solutions to the problem and/or sub-problem(s).
9) Allowing human user to accept the solution, reject the solution, and/or provide feedback to solvers on their solutions to the problem and/or sub-problem(s).

Referring to FIG. 19, the steps of solution learning can be exemplified with the recording at each step of the learning process operators applied, new state of the problem, evaluation function used and its results, current relevant goal/subgoals, and other information that differs from previous step(s). The state of the problem or problem state can be evaluated to determine if the problem is solved. If not, then using information from the latest problem state after the last step, re-run the problem solving process, evaluation of progress, and selection of next operators to apply. After which, the process can return to the step of recording.

If the problem is solved, then record successful or unsuccessful solutions for retrieval to save effort of solving previously solved problems and to inform problems solving efforts about previous unsuccessful paths.

Successful solutions and unsuccessful attempts with keywords for future matching/retrieval can be indexed using semantic analysis, hash functions, and/or other means.

A periodical review of all stored solutions can be implemented to ensure they meet established ethical and safety guidelines, and flag unsafe/unethical solutions for removal from the database.

Periodically update and propagate changes to the solution database so problem solving network and agents can access an ever-increasing repertoire of solutions as well as increasing knowledge of unsuccessful attempts.

Referring to FIG. 20, the present technology can utilize a natural language to problem solving language translator, where any part of the problem request can be translated into an unambiguous language utilizable in the universal problem solving architecture including the decision tree. A description of any one of or any combination of a current problem state, a goal of the problem request, relevant problem solving information, and a next step that the human workers will take in the problem solving process can be described in natural language. While humans typically would use the natural language translator, since natural language is a universal interface for LLMs, LLMS or AI agents could also use natural language as an intermediate step to translate their problem solving activity into a rigorous specification for other intelligent (human or AI) entities.

A human can describe in natural language the current problem state, the goal, other relevant problem solving information, and/or the next step(s) that the human wants to take.

An AI/AAAI agent (e.g. LLM) parses and translates the natural language description into the unambiguous language of the universal problem solving architecture.

If the AI/AAAI agent is unable to completely specify the problem state, including relevant operators and other information needed to take the next step in problem solving based on its parsing and translation, it engages in dialog with the human until a precise problem state can be specified.

Addition to the dialog, a VR simulation incorporating gestures, textual interaction, verbal/audio interaction, and/or other types of interactions could be specified.

Problem solving can progress to the next step as specified by the problem solving architecture (see FIG. 18), and then repeat steps until solution achieved or resources exhausted.

The matched human (or intelligent entity) workers can be compensated/rewarded for the sub-solutions, respectively. Further, a reputation attribute can be assigned to any one of or any combination of the human workers and the AAAIs.

Referring to FIG. 21, a reputation attribute can be assigned to any one of intelligent entities. The reputation attribute can include metrics on any one of or any combination of a time to the sub-solutions, a difficulty value of the problem request, short and long-term user satisfaction with the sub-solutions, a number of times any one of the sub-solutions has been re-used on the neural network, a rating other human workers, a responsiveness value of the human workers, and a reliability value of the human workers. The intelligent entity can specify, rank and/or rate the dimensions that are most important (e.g., cost, time to solution, past track record of quality, etc.) in selection of problem solvers.

A matching algorithm can be used with client specification of reputational dimensions, together with other criteria to recruit best-match solvers to specific client problems and/or sub-problems. The algorithm can use a hierarchy of the metrics that is preset by a human user of the problem request. After which, the intelligent entities (problem solver(s)) work on problem with solution steps recorded, including criteria such as time taken for each step.

After a successful solution, or after solver ceases problem solving, all recorded information can be analyzed by standard methods to update the relevant dimensions of the solver's reputation including time to solution, etc.

At predetermined intervals after solution, client satisfaction information can be solicited via surveys, dialog and other means to obtain short and long-term satisfaction metrics that are used to update the solver's reputation.

For stored solutions, metrics on how often a stored solution can be used are recorded and used to update relevant dimensions of the solver's reputation over time.

Links can be provided to stored records of solutions and attempts for auditability and transparency and to enhance the usefulness of the reputations.

The recorded information can be analyzed after the overall solution is accepted or after the problem solving process is complete, and analysis can be used for updating the metrics of the reputation attribute.

AGI will be so powerful that it will change the course of human history. If misused, it could end all human life.

According to one aspect, the present technology can include a system for artificial intelligence (AI) electronically communicating over a network. The system can include a computer system including a processor, a computer-readable storage medium, and program instructions stored on the computer-readable storage medium being executable by the processor to cause the computer system to:
execute a customization subsystem configured or configurable for customizing one or more attributes of an AI system;
execute a common cognitive architecture subsystem configured or configurable for implementing one or more problem solving protocols on a request received by the AI system;
execute a collective network subsystem configured or configurable for electronically communicating the AI system and one or more additional AI systems;
execute an integration subsystem configured or configurable for utilizing one or more datasets from any one of or any combination of the AI system and the additional AI systems; and
execute an improvement subsystem utilizing one or more techniques configured or configurable for continuous improvement of any one of or any combination of the customization subsystem, the common cognitive architecture subsystem, the collective network subsystem and the integration subsystem.

According to another aspect and as generally illustrated in FIG. 1, the present technology can include a method for artificial intelligence (AI) utilizing multiple intelligent entities being any one of or any combination of multiple AI systems and multiple humans each using a computer system, wherein the intelligent entities are electronically communicating over a collective network, or if entities reside within a single computer system, then communicating internally. The method can include:
customizing one or more attributes of an AI system;
implementing one or more problem solving protocols on a problem request provided by any one of or any combination of the AI system and intelligent entities, the problem solving protocols utilizing a common cognitive architecture;
communicating the AI system and the intelligent entities utilizing a collective network;
integrating one or more datasets from any one of or any combination of the AI system and the intelligent entities; and
improving, by utilizing one or more techniques, any one of or any combination of the customizing of the attributes, the common cognitive architecture, the collective network and the integrating of the datasets.

In some embodiments, the step of customizing the attributes of the AI system can include the steps of:
creating an interface configured or configurable to allow a human user to input training data;
selecting one or more training methods and setting training parameters depending on any one of or any combination of a speed factor, a precision factor, an accuracy factor, and a transferability factor;
executing multiple training epochs that includes one or more mechanisms to determine an optimum number of epochs given specific training objectives and quality metrics; and
engaging in one or more feedback sessions to refine the training parameters, and to re-run the training epochs based on any one of or any combination of an input from the human user and an input from one or more of the intelligent entities in communication with each other over the network.

In some embodiments, the interface can be accessible through a web-based application or a mobile application and can be configured or configurable to upload a file or allow the user to enter data manually into an input field.

In some embodiments, the training data can contain any one of or any combination of: an amount of training time the user has to devote to customizing the AI system; an amount of financial resources the user is willing devote to customize the AI system; an amount of social media information available to customize the AI system; an amount of email information available to customize the AI system; an amount of electronic information available about the user to customize the AI system; and an amount of electronic information available collected by third parties about the user to customize the AI system.

In some embodiments, the training data can contain information about the user obtained by any one of or any combination of a personality test, a standardized test, a certification, and assessments or questionnaires provided by the user.

In some embodiments, the training parameters can be any one of or any combination of: a type of training, tuning or other machine learning algorithm to be used; a type and size of a training dataset; a degree to which the training dataset is to be formatted, labelled or processed before customization begins; a number of training epochs; a type of base model being customized; a required timeframe for training; an amount of human user supervision to be used in the customizing of the AI system; and an amount of AI supervision to be used in the customizing of the AI system.

In some embodiments, the training data can include ethical information provided by the human user or a second human user by way of the interface, the ethical information is stored in an ethical profile, and wherein the customizing of the attributes of the AI system includes the ethical information.

In some embodiments, the step of implementing the problem solving protocols on the problem request utilizing the common cognitive architecture can include the steps of:
submitting the problem request from a human user using a user interface or from any one of the intelligent entities;
acquiring information associated with the problem request from any one of a human user of the AI system or any one of the intelligent entities;
identifying one or more of the intelligent entities that have one or more attributes related to one or more request criteria of the problem request;
implementing by each of the identified intelligent entities the problem solving protocols on the problem request to create a completion solution; and
providing the completion solution to any one of or any combination of the AI system and any one of the intelligent entities for final acceptance by the user.

In some embodiments, the information can be any one of or any combination of a name and description of the problem request, a total reward that the user will pay for a successful completion solution to the problem request, a criteria to determine whether the completion solution is deemed successful, a time limit for solving the problem request, a minimum and maximum number of the identified intelligent entities allowed to work on the problem request simultaneously, qualifications required of users associated with the identified intelligent entities working on the problem request, a part of the problem request is confidential, a part of the completion solution is confidential, whether the completion solution is exclusive to the user, whether the completion solution is to be re-used for other users, parameters relating to how to reward the users associated with the identified intelligent entities for working on the problem request, and parameters relating to how to reward the users associated with the identified intelligent entities that provide a successful completion solution.

Some embodiments of the present technology can include a step of timestamping and validating the completion solution against a success criteria assigned by the user before being provided to the user for the final acceptance.

Some embodiments of the present technology can include a step of distributing a reward to the identified intelligent entities associated with the final acceptance completion solution, wherein the reward is based on a payment parameter.

In some embodiments, the payment parameter can include any one of or any combination of if a goal of the problem request has been achieved, if a subgoal of the problem request has been achieved, and if an ethical criteria related to each of the goal and the subgoal preceding the distributing of the reward has been satisfied.

Some embodiments of the present technology can include a step of splitting the problem request into a series of sub-problems that are each solved by any one of or any combination of the identified intelligent entities.

In some embodiments, the AI system can be cloned to create one or more cloned AI systems.

Some embodiments of the present technology can include a step of implementing in parallel by each of the cloned AI systems the common cognitive architecture including the problem solving protocols on the problem request to create a completion solution of the cloned AI systems.

In some embodiments, the completion solution can utilize any one of or combination of the completion solution from the identified intelligent entities, and the cloned completion solution from the cloned AI systems.

In some embodiments, the problem solving protocols can provide layers provides an infrastructure configured or configurable to build and scale the AI system. The protocols can enable re-use of completion solutions within and across the AI system and the identified intelligent entities. The problem solving protocols can be configured or configurable to manage a payment of royalties.

In some embodiments, the infrastructure can be blockchain or Ethereum based.

In some embodiments, the common cognitive architecture can include:
defining a problem space configured or configurable to support all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state, and then applying operators to reduce the difference, a safety or ethics screening is applied each time the goals or the subgoals is set;
applying heuristic rules that are configured or configurable to guide a selection of the operators in an absence of the completion solution, the heuristic rules are used to reduce the problem space;
identifying one or more second operators configured or configurable to enact an action to transform one of the states into another state, the second operators move from the initial state to the goal state by changing a current state of the problem request;
applying a control structure including a set of rules that govern a selection of the second operators to be applied at each step of the problem solving protocols, and that determines which of the second operators to apply next based on the current state of the problem request and the goal state;
applying evaluation functions to determine an application of the second operators;
assigning a credit or blame value to the completion solution or sub-solution to the completion solution that enables tracing back and determining which of the second operators were most useful and also which of the evaluation functions led to success or failure of problem solving attempts;
recording of both successful and unsuccessful problem request solution attempts; and
analyzing the solution attempts to improve selection of the heuristic rules and the evaluation functions.

In some embodiments, the step of utilizing the collective network can include the steps of:
acquiring information associated with the problem request from any one of a human user of the AI system or any one of the intelligent entities;
identifying one or more of the intelligent entities that have one or more criteria related to one or more request criteria of the problem request;
implementing by a first intelligent entity of the identified intelligent entities the problem solving protocols on the problem request;
identifying by the first identified intelligent entity that a completion solution to the problem request requires solving a first sub-problem and one or more additional sub-problems;
implementing by the first intelligent entity the problem solving protocols on the first sub-problem to create a first sub-solution;
assigning at least one of the additional sub-problems to a second intelligent entity of the identified intelligent entities, and implementing by the second identified intelligent entity the problem solving protocols on the at least one of the additional sub-problems to create a second sub-solution;
creating, updating or creating and updating a decision tree including the first sub-solution and the second sub-solution and any additional sub-solutions to create the completion solution to the problem request; and
providing the completion solution to the user interface for final acceptance by the user.

In some embodiments, the decision tree can be maintained in blockchain or Ethereum logs.

In some embodiments, the first and second identified intelligent entities can access the decision tree by way of an online address or directly from a blockchain.

Some embodiments of the present technology can include a step of distributing a reward to the first identified intelligent entity associated with an acceptance of the completion solution or the first sub-solution, wherein the reward is based on a payment parameter.

Some embodiments of the present technology can include a step of distributing a portion of the reward to the second identified intelligent entity by the first identified intelligent entity based on payment parameter assigned by the first identified intelligent entity.

Some embodiments of the present technology can include a step of assigning a blame value and a credit value associated with a problem solving history, using the blame value and the credit value to train the AI system.

Some embodiments of the present technology can include a step of translating natural language interactions with a human user and the AI system into a common problem solving representation so that both the human user and the AI system can engage in problem solving and the AI system can learn and improve by detecting a behavior and effectiveness of both the human user and the AI system utilizing a reinforcement learning scheme.

In some embodiments, any one of the identified intelligent entity is an additional AI system, and wherein the additional AI system can be cloned to create one or more cloned AI systems.

Some embodiments of the present technology can include a step of implementing in parallel by each of the cloned AI systems the common cognitive architecture including the problem solving protocols on the problem request to create a completion solution of the cloned AI systems.

In some embodiments, the completion solution can utilize any one of or combination of the completion solution from the identified intelligent entities, and the completion solution from the cloned AI systems.

In some embodiments, the step of integrating the datasets from the multiple AI systems can include:
acquiring information associated with the problem request from any one of a human user of the AI system or any one of the intelligent entities;
identifying the intelligent entities that have one or more criteria related to one or more request criteria of the problem request;
assigning the problem request or one or more sub-problems of the problem request to each of the intelligent entities;
implementing by the intelligent entities the problem solving protocols on the problem request or the sub-problems to create a problem solution or one or more sub-problem solutions, respectively;
integrating the problem solution and one or more of the sub-problem solutions to create a completion solution to the problem request; and
providing the completion solution to a user interface for final acceptance by the user.

Some embodiments of the present technology can include a step of assigning a credit value or a blame value to the datasets based on whether the datasets increase or decrease performance of the AI system based on performance metrics or evaluation functions.

Some embodiments of the present technology can include a step of quantifying a benefit weight or a harm weight to a contribution by each of the identified intelligent entities to the problem request.

Some embodiments of the present technology can include a step of distributing a reward to an owner of the identified intelligent entities proportionally to the contribution of the identified intelligent entities based on the benefit weight or the harm weight.

According to still another aspect and as generally illustrated in FIG. 10, the present technology can include a method for artificial intelligence (AI) by customizing one or more attributes of an AI system. The method can include:
creating an interface configured or configurable to allow a human user of the AI system or any one of the intelligent entities to input training data;
processing and converting the training data to a standardized training format;
selecting one or more training methods and setting training parameters depending on any one of or any combination of a speed factor, a precision factor, an accuracy factor, and a transferability factor;
executing multiple training epochs that includes one or more mechanisms to determine an optimum number of epochs given specific training objectives and quality metrics associated with the training format;
engaging in one or more feedback sessions to refine the training parameters, and to re-run the training epochs based on any one of or any combination of an input from the human user, and any one of the intelligent entities; and
customizing the attributes of the AI system with the training format.

In some embodiments, the interface can be accessible through a web-based application or a mobile application and is configured or configurable to upload a file or allow the human user to enter data.

In some embodiments, the training data can contain any one of or any combination of: an amount of training time the user has to devote to customizing the AI system; an amount of financial resources the user is willing devote to customize the AI system; an amount of computational resources the user is willing to devote to customize the AI system; an amount of social media information available to customize the AI system; an amount of email information available to customize the AI system; an amount of electronic information available about the user to customize the AI system; and an amount of electronic information available collected by third parties about the user to customize the AI system.

In some embodiments, the training data can contain information about the human user obtained by any one of or any combination of a personality test, a standardized test, a certification, and assessments or questionnaires provided by the human user.

In some embodiments, the training parameters can be any one of or any combination of: a type of training, tuning or other machine learning algorithm to be used; a type and size of a training dataset; a degree to which the training dataset is to be formatted, labelled or processed before customization begins; a number of training epochs; a type of base model being customized; a required timeframe for training; an amount of human user supervision to be used in the customizing the AI system; and an amount of AI supervision to be used in the customizing of the AI system.

In some embodiments, the training data can include ethical information provided by the human user by way of the interface. The ethical information can be stored in an ethical profile. The customizing of the attributes of the AI system can include the ethical information.

According to yet another aspect and as generally illustrated in FIG. 11, the present technology can include a method for artificial intelligence (AI) by problem solving utilizing a common cognitive architecture implemented in an AI system. The method can include:
providing a problem request from an intelligent entity being an AI system or a human user using a user interface on a computer system;
acquiring information associated with the problem request from the intelligent entity;
identifying multiple additional intelligent entities that are each communicable with each other over the network, and that each have one or more criteria related to one or more request criteria of the problem request, wherein the additional intelligent entities being any one of or any combination of multiple additional AI systems and multiple additional humans each using a computer system;
implementing by each of the identified AI systems the common cognitive architecture including one or more problem solving protocols on the problem request to create a completion solution; and
providing the completion solution to the intelligent entity for final acceptance by a user.

In some embodiments, the information can be any one of or any combination of a name and description of the problem request, a total reward that the user will pay for a successful completion solution to the problem request, a criteria to determine whether the completion solution is deemed successful, a time limit for solving the problem request, a minimum and maximum number of the identified additional intelligent entities allowed to work on the problem request simultaneously, qualifications required of users associated with the identified additional intelligent entities working on the problem request, a part of the problem request is confidential, a part of the completion solution is confidential, whether the completion solution is exclusive to the user, whether the completion solution is to re-used for other users, parameters relating to how to reward the users associated with the identified additional intelligent entities for working on the problem request, and parameters relating to how to reward the users associated with the identified additional intelligent entities that provide a successful completion solution.

Some embodiments of the present technology can include a step of timestamping and validating the completion solution against a success criteria assigned by the user before being provided to the user for the final acceptance.

Some embodiments of the present technology can include a step of distributing one or more tokens to the identified additional intelligent entities associated with the final acceptance completion solution, wherein the tokens are based on a payment parameter.

In some embodiments, the payment parameter can include any one of or any combination of if a goal of the problem request has been achieved, if a subgoal of the problem request has been achieved, and if an ethical criteria related to the goal and the subgoal preceding the distributing of the tokens has been satisfied.

Some embodiments of the present technology can include a step of splitting the problem request into a series of sub-problems that are each solved by any one of or any combination of the identified additional intelligent entities.

In some embodiments, any one of or combination of the identified additional AI systems can be cloned to create one or more cloned AI systems.

Some embodiments of the present technology can include a step of implementing by each of the cloned AI systems the common cognitive architecture including the problem solving protocols on the problem request to create a completion solution of the cloned AI systems.

In some embodiments, the completion solution can utilize any one of or combination of the completion solution from the AI system, the identified additional intelligent entities, and the completion solution from the cloned AI systems.

In some embodiments, the common cognitive architecture can include:
defining a problem space configured or configurable to include all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state, and then applying the operators to reduce the difference, a safety or ethics screening is applied each time the goals or the subgoals is set;
applying heuristic rules that are configured or configurable to guide the selection of the operators in an absence of the completion solution, the heuristic rules are used to reduce the problem space;
identifying one or more operators configured or configurable to enact an action to transform one of the states into another state, the operators move from the initial state to the goal state by changing a current state of the problem request;
applying a control structure including a set of rules that govern a selection of the operators to be applied at each step of the problem solving protocols, and that determines which of the operators to apply next based on the current state of the problem request and the goal state;
applying evaluation functions to determine an application of the operators; assigning a credit or blame value to the completion solution or sub-solution to the completion solution that enables tracing back and determining which of the operators were most useful and also which of the evaluation functions led to success or failure of problem solving attempts;
recording of both successful and unsuccessful problem request solution attempts; and
analyzing the solution attempts to improve selection of the heuristic rules and the evaluation functions.

According to still yet another aspect and as generally illustrated in FIG. 12, the present technology can include method for artificial intelligence (AI) by problem solving utilizing a collective network of AI systems. The method can include:
submitting a problem request from a human user using a user interface on a computer system or from an AI system;
acquiring information associated with the problem request from the computer system of the human user or from the AI system;
identifying intelligent entities being any one of or any combination of multiple additional AI systems and multiple humans each using a computer system that are each communicable with each other over the network, and that each have one or more criteria related to one or more request criteria of the problem request;
implementing by a first intelligent entity of the identified intelligent entities a common cognitive architecture including one or more problem solving protocols on the problem request;
determining by the first intelligent entity that a completion solution to the problem request requires solving a first sub-problem and one or more additional sub-problems;
implementing by the first intelligent entity the problem solving protocols on the first sub-problem to create a first sub-solution;
assigning at least one of the additional sub-problems to a second intelligent entity of the identified intelligent entities, and implementing by the second intelligent entity the problem solving protocols on the at least one of the additional sub-problems to create a second sub-solution;
creating a decision tree including the first sub-solution and the second sub-solution to create the completion solution to the problem request; and
providing the completion solution to the user interface or the AI system for final acceptance by the user.

In some embodiments, the decision tree can be maintained in blockchain Ethereum logs.

In some embodiments, the first and second identified intelligent entities can access the decision tree by way of an online address or directly from a blockchain, Some embodiments of the present technology can include a step of distributing one or more tokens to the first identified intelligent entity associated with an acceptance of the completion solution or the first sub-solution, wherein the tokens are based on a payment parameter.

In some embodiments, the payment parameter can include any one of or any combination of if a goal of the problem request has been achieved, if a subgoal of the problem request has been achieved, and if an ethical criteria related to the goal and the subgoal preceding the distributing of the tokens has been satisfied.

Some embodiments of the present technology can include a step of distributing one or more of the tokens to the second identified intelligent entity by the first identified intelligent entity based on a payment parameter assigned by the first identified intelligent entity.

Some embodiments of the present technology can include a step of influencing a direction of the problem solving protocols by assigning a first token reward for the first sub-problem, and a second token reward for the second sub-solution that is of a value different to the first token reward.

In some embodiments, the problem solving protocols can provide layers of an infrastructure configured or configurable to build and scale the identified intelligent entities. The problem solving protocols can enable re-use of completion solutions within and across the intelligent entities. The problem solving protocols can be configured or configurable to manage a payment of royalties.

In some embodiments, the infrastructure can be blockchain or Ethereum based.

According to still another aspect and as generally illustrated in FIG. 12, the present technology can include a method for artificial intelligence (AI) by integrating one or more datasets from multiple AI systems on a collective network. The method can include:
submitting a problem request from a human user using a user interface on a computer system or from an AI system;
acquiring information associated with the problem request from the computer system of the human user or the AI system;
identifying multiple intelligent entities that are each communicable with each other over a neural network, and that each have one or more criteria related to one or more request criteria of the problem request, wherein the intelligent entities being any one of or any combination of multiple additional AI systems and multiple humans each using a computer system;
assigning the problem request or one or more sub-problems of the problem request to each of the intelligent entities;
implementing by the intelligent entities a common cognitive architecture including one or more problem solving protocols on the problem request or the sub-problems to create a problem solution or a sub-problem solution, respectively;
integrating the problem solution and the sub-problem solution to create a completion solution to the problem request; and
providing the completion solution to the user interface or the AI system for final acceptance by the user.

Some embodiments of the present technology can include a step of assigning a credit value or a blame value to the datasets based on whether the datasets increase or decrease performance of the intelligent entities based on performance metrics or evaluation functions.

Some embodiments of the present technology can include a step of quantifying a benefit weight or a harm weight to a contribution by each of the intelligent entities to the problem request.

Some embodiments of the present technology can include a step of distributing a reward to an owner of the intelligent entities proportionally to the contribution of the intelligent entities based on the benefit weight or the harm weight.

According to yet another aspect, the present technology can include a system for Artificial Intelligence (AI) by utilizing multiple AI systems electronically communicating over a collective intelligence network to respond to a request. The system can include a computer system including a processor, a computer-readable storage medium, and program instructions stored on the computer-readable storage medium being executable by the processor, to cause the computer system to:
receive a problem request;
identify AI systems that are each communicable with the computer system, and that each have one or more criteria related to one or more request criteria of the request or the program instructions;
generate one or more answers in response to the request or the program instructions, the answers resulting from collaboration of the identified AI systems; and
provide the answers to a user device.

In some embodiments, a parameter of any one of or any combination of the AI systems can be customizable after an iteration of the generated answers.

In some embodiments, the parameter can have a characteristic selected from any one of or combination of an ethical characteristic, a time characteristic, a financial characteristic, a computational resource characteristic, a legacy characteristic, a safety characteristic, an educational characteristic, and a monetizing characteristic.

In some embodiments, any one of or combination of the AI systems can be cloned before or after customization to create one or more cloned AI systems.

In some embodiments, the answers can be generated by the computer system utilizing any one of or combination of the AI systems, and the cloned AI systems.

In some embodiments, a constraint to any one of or any combination of the AI systems can be customizable by the user or one or more second users different to that of the user.

In some embodiments, the computer system can utilize multiple combinations of the AI systems to generate the answers.

In some embodiments, the AI systems can be a first AI system located remotely to one or more additional AI systems all in communication with the computer system over the network.

In some embodiments, the first AI system and one or more of the additional AI systems and human users can create an Artificial General Intelligence (AGI) network.

In some embodiments, the request or the program instructions can be received by the computer system by a user input by way of natural language on a user AI system.

According to still yet another aspect, the present technology can include a method for developing Artificial General Intelligence (AGI) for generating an answer to a response utilizing multiple Artificial Intelligence (AI) systems electronically communicating over a collective intelligence network. The method can include:
a) inputting a request into an interface of a first AI system by a human user, the request including one or more criteria;
b) identifying multiple intelligent entities that are each communicable with the first AI system, and that has a criteria related to the criteria of the request, wherein the intelligent entities being any one of or any combination of multiple additional AI systems and multiple humans each using a computer system;
c) communicating the first AI system and the additional AI systems utilizing a collective intelligence network;
d) receiving the request by the identified intelligent entities from the first AI system;
e) generating one or more answers in response to the request by each of the identified intelligent entities;
f) developing an AGI by collaborating each of the answers to create a collaborative answer; and
g) providing any one of or any combination of the answers and the collaborative answer to the first AI system.

Some embodiments of the present technology can include a steps of customizing one or more attributes of the first AI system by the user.

In some embodiments, step e) can include the steps of:
implementing one or more problem solving protocols on the request by each of the identified intelligent entities utilizing a common cognitive architecture;
integrating one or more datasets from any one of or any combination of the first AI system and the identified intelligent entities; and
improving, by utilizing one or more techniques, any one of or any combination of the customizing of the attributes, the common cognitive architecture, the collective intelligence network and the integrating of the datasets.

In some embodiments, any one of or combination of the multiple additional AI systems can be cloned to create one or more cloned AI systems.

Some embodiments of the present technology can include a step of implementing in parallel by each of the cloned AI systems the common cognitive architecture including the problem solving protocols on the request to create an answer of the cloned AI systems.

In some embodiments, the collaborative answer can utilize any one of or combination of the answers and the cloned answer.

In some embodiments, the attributes can include ethical information provided by the human user or one or more second human users. The ethical information can be stored in an ethical profile. The customizing of the attributes of the first AI system can include the ethical information.

Some embodiments of the present technology can include a step of distributing a reward to the identified intelligent entities associated with the answers or the collaborative answer accepted by the human user, wherein the reward is based on a payment parameter, and wherein the payment parameter includes any one of or any combination of if a goal of the request has been achieved, if a subgoal of the request has been achieved, and if an ethical criteria related to the goal and the subgoal preceding the distributing of the reward has been satisfied.

Yet another aspect of the present technology can include a method for AI utilizing a single computerized intelligent system including multiple AI agents residing in the single computerized intelligent system. The method can include:
providing a problem request including a problem criteria into an AI agent residing in a single computerized intelligent system;
customizing one or more attributes of the AI agent;
matching, by the AI agent or the single computerized intelligent system, one or more additional AI agents to the problem request based on the problem criteria, the additional AI agents reside in the single computerized intelligent system;
utilizing, by the AI agent and the additional AI agents, a universal problem solving architecture in a problem solving process on the goal, respectively, to create one or more solutions;
receiving, by the AI agent, the solutions from each of the additional AI agents for the goal delegated thereto;
integrating one or more datasets from any one of or any combination of the AI agent and the additional AI agents;
combining, by the AI agent, the solutions into an overall solution to the goal; and
improving, by the AI agent or the additional AI agents, any one of or any combination of the customizing of the attributes, the common cognitive architecture, and the integrating of the datasets utilizing one or more techniques.

Another aspect of the present technology can include a method for developing AGI) that can include a step of translating natural language interactions with a human user and an AI system into a common problem solving representation so that both the human user and the AI system engage in problem solving of a problem request.

There has thus been outlined, rather broadly, features of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology.

It is therefore an object of the present technology to provide a new and novel AAAI system and methods that has all of the advantages of the prior art AI systems and methods and none of the disadvantages.

It is another object of the present technology to provide a new and novel AAAI system and methods that may be easily and efficiently manufactured and marketed.

An even further object of the present technology is to provide a new and novel AAAI system and methods that has a low cost of manufacture with regard to both materials and labor, and which accordingly is then susceptible of low prices of sale to the consuming public, thereby making such AAAI system and methods economically available to the buying public.

Still another object of the present technology is to provide a new AAAI system and methods that provides in the apparatuses and methods of the prior art some of the advantages thereof, while simultaneously overcoming some of the disadvantages normally associated therewith.

For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the following description is not limited to meeting most or all of the objects identified and that some embodiments of the present technology may meet only one such object or none at all.

While embodiments of the AAAI system and methods have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable computer system may be used instead of the above-described. And although developing AGI has been described, it should be appreciated that the AAAI system and methods herein described is also suitable for developing other aspects of AI or machine learning systems.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

What is claimed is:

1. A system for artificial intelligence (AI) electronically communicating over a network, the system comprising:
a computer system comprising: a processor, a computer-readable storage medium, and program instructions stored on the computer-readable storage medium being executable by the processor to cause the computer system to:
execute a customization subsystem configured or configurable for customizing one or more attributes of an AI system;
execute a common cognitive architecture subsystem configured or configurable for implementing one or more problem solving protocols on a request received by the AI system;
execute a collective network subsystem configured or configurable for electronically communicating the AI system and one or more additional AI systems;
execute an integration subsystem configured or configurable for utilizing one or more datasets from any one of or any combination of the AI system and the additional AI systems; and
execute an improvement subsystem utilizing one or more techniques configured or configurable for continuous improvement of any one of or any combination of the customization subsystem, the common cognitive architecture subsystem, the collective network subsystem and the integration subsystem.

2. A method for artificial intelligence (AI) utilizing multiple intelligent entities being any one of any combination of multiple AI systems and multiple humans each using a computer system, wherein the intelligent entities electronically communicating over a collective network, the method comprising:
customizing one or more attributes of an AI system;
implementing one or more problem solving protocols on a problem request provided by any one of or any combination of the AI system, and the intelligent entities, the problem solving protocols utilizing a common cognitive architecture;
communicating the AI system and the intelligent entities utilizing a collective network;
integrating one or more datasets from any one of or any combination of the AI system and the intelligent entities; and
improving, by utilizing one or more techniques, any one of or any combination of the customizing of the attributes, the common cognitive architecture, the collective network and the integrating of the datasets.

3. The method of claim 2, wherein the step of customizing the attributes of the AI system includes the steps of:
creating an interface configured or configurable to allow a human user to input training data;
selecting one or more training methods and setting training parameters depending on any one of or any combination of a speed factor, a precision factor, an accuracy factor, and a transferability factor;
executing multiple training epochs that includes one or more mechanisms to determine an optimum number of epochs given specific training objectives and quality metrics; and
engaging in one or more feedback sessions to refine the training parameters, and to re-run the training epochs based on any one of or any combination of an input from the human user and an input from one or more of the intelligent entities in communication with each other over the network.

4. The method of claim 2, wherein the step of implementing the problem solving protocols on the problem request utilizing the common cognitive architecture further comprising the steps of:
submitting the problem request from a human user using a user interface or any one of the intelligent entities;
acquiring information associated with the problem request from any one of a human user of the AI system or any one of the intelligent entities;
identifying one or more of the intelligent entities that have one or more attributes related to one or more request criteria of the problem request;
implementing by each of the identified intelligent entities the problem solving protocols on the problem request to create a completion solution; and
providing the completion solution to any one of or any combination of the AI system and any one of the intelligent entities for final acceptance by the user.

5. The method of claim 4, wherein the AI system is cloned to create one or more cloned AI systems.

6. The method of claim 2, wherein the common cognitive architecture includes:
defining a problem space configured or configurable to support all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state, and then applying operators to reduce the difference, a safety or ethics screening is applied each time the goals or the subgoals is set;
applying heuristic rules that are configured or configurable to guide a selection of the operators in an absence of the completion solution, the heuristic rules are used to reduce the problem space;
identifying one or more second operators configured or configurable to enact an action to transform one of the states into another state, the second operators move from the initial state to the goal state by changing a current state of the problem request;
applying a control structure including a set of rules that govern a selection of the second operators to be applied at each step of the problem solving protocols, and that determines which of the second operators to apply next based on the current state of the problem request and the goal state;
applying evaluation functions to determine an application of the second operators;
assigning a credit or blame value to the completion solution or sub-solution to the completion solution that enables tracing back and determining which of the second operators were most useful and also which of the evaluation functions led to success or failure of problem solving attempts;
recording of both successful and unsuccessful problem request solution attempts; and
analyzing the solution attempts to improve selection of the heuristic rules and the evaluation functions.

7. The method of claim 2, wherein the step of utilizing the collective network further comprises the steps of:
acquiring information associated with the problem request from any one of a human user of the AI system or any one of the intelligent entities;
identifying one or more of the intelligent entities that have one or more criteria related to one or more request criteria of the problem request;
implementing by a first intelligent entity of the identified intelligent entities the problem solving protocols on the problem request;
identifying by the first identified intelligent entity that a completion solution to the problem request requires solving a first sub-problem and one or more additional sub-problems;
implementing by the first identified intelligent entity the problem solving protocols on the first sub-problem to create a first sub-solution;
assigning at least one of the additional sub-problems to a second intelligent entity of the identified intelligent entities, and implementing by the second identified intelligent entity the problem solving protocols on the at least one of the additional sub-problems to create a second sub-solution;
creating, updating or creating and updating a decision tree including the first sub-solution, the second sub-solution and any additional sub-solutions to create the completion solution to the problem request; and
providing the completion solution to the user interface for final acceptance by the user.

8. The method of claim 7, wherein any one of the identified intelligent entities is an additional AI system, and wherein the additional AI system is cloned to create one or more cloned AI systems.

9. The method of claim 2, wherein the step of integrating the datasets from the multiple AI systems further includes:
acquiring information associated with the problem request from any one of a human user of the AI system or any one of the intelligent entities;
identifying the intelligent entities that have one or more criteria related to one or more request criteria of the problem request;
assigning the problem request or one or more sub-problems of the problem request to each of the identified intelligent entities;
implementing by the identified intelligent entities the problem solving protocols on the problem request or the sub-problems to create a problem solution or one or more sub-problem solutions, respectively;
integrating the problem solution and one or more of the sub-problem solutions to create a completion solution to the problem request; and
providing the completion solution to a user interface for final acceptance by the user.

10. A method for artificial intelligence (AI) by problem solving utilizing a common cognitive architecture implemented in an AI system, the method comprising:
providing a problem request from an intelligent entity being an AI system or a human user using a user interface on a computer system;
acquiring information associated with the problem request from the intelligent entity;
identifying multiple additional intelligent entities that are each communicable with each other over a network, and that each have one or more criteria related to one or more request criteria of the problem request, wherein the additional intelligent entities being any one of or any combination of multiple additional AI systems and multiple additional humans each using a computer system;
implementing by each of the identified additional intelligent entities the common cognitive architecture including one or more problem solving protocols on the problem request to create a completion solution; and
providing the completion solution to the intelligent entity for final acceptance by a user.

11. A method for artificial intelligence (AI) by problem solving utilizing a collective network of AI systems, the method comprising:
submitting a problem request from a human user using a user interface on a computer system or from an AI system;
acquiring information associated with the problem request from the computer system of the human user or from the AI system;
identifying intelligent entities being any one of or any combination of multiple additional AI systems and multiple humans each using a computer system that are each communicable with each other over a network, and that each have one or more criteria related to one or more request criteria of the problem request;
implementing by a first intelligent entity of the identified intelligent entities a common cognitive architecture including one or more problem solving protocols on the problem request;
determining by the first intelligent entity that a completion solution to the problem request requires solving a first sub-problem and one or more additional sub-problems;
implementing by the first intelligent entity the problem solving protocols on the first sub-problem to create a first sub-solution;
assigning at least one of the additional sub-problems to a second intelligent entity of the identified intelligent entities, and implementing by the second intelligent entity the problem solving protocols on the at least one of the additional sub-problems to create a second sub-solution;
creating a decision tree including the first sub-solution and the second sub-solution to create the completion solution to the problem request; and
providing the completion solution to the user interface or the AI system for final acceptance by the user.

12. The method of claim 11 further comprising the step of distributing one or more tokens to the first identified intelligent entity associated with an acceptance of the completion solution or the first sub-solution, wherein the tokens are based on a payment parameter.

13. A method for artificial intelligence (AI) by integrating one or more datasets from multiple AI systems on a collective network, the method comprising:
submitting a problem request from a human user using a user interface on a computer system or from an AI system;
acquiring information associated with the problem request from the computer system of the human user or the AI system;
identifying multiple intelligent entities that are each communicable with each other over a network, and that each have one or more criteria related to one or more request criteria of the problem request, wherein the intelligent entities being any one of or any combination of multiple additional AI systems and multiple humans each using a computer system;
assigning the problem request or one or more sub-problems of the problem request to each of the intelligent entities;
implementing by the intelligent entities a common cognitive architecture including one or more problem solving protocols on the problem request or the sub-problems to create a problem solution or a sub-problem solution, respectively;
integrating the problem solution and the sub-problem solution to create a completion solution to the problem request; and
providing the completion solution to the user interface or the AI system for final acceptance by the user.

14. The method of claim 13 further comprising the step of assigning a credit value or a blame value to the datasets based on whether the datasets increase or decrease performance of the intelligent entities based on performance metrics or evaluation functions.

15. A system for Artificial Intelligence (AI) by utilizing multiple AI systems electronically communicating over a collective intelligence network to respond to a request, the system comprising:
a computer system comprising: a processor, a computer-readable storage medium, and program instructions stored on the computer-readable storage medium being executable by the processor, to cause the computer system to:
receive a problem request;
identify AI systems that are each communicable with the computer system, and that each have one or more criteria related to one or more request criteria of the request or the program instructions;
assign the request to each of the identified AI systems;
implement by each of the AI systems a common cognitive architecture including one or more problem solving protocols on the request;
generate one or more answers in response to the request or the program instructions, the answers resulting from collaboration of the identified AI systems; and
provide the answers to a user device.

16. The system of claim 15, wherein a parameter of any one of or any combination of the AI systems is customizable after an iteration of the generated answers.

17. The system of claim 15, wherein the computer system utilizes multiple combinations of the AI systems to generate the answers.

18. A method for developing Artificial General Intelligence (AGI) for generating an answer to a response utilizing multiple Artificial Intelligence (AI) systems electronically communicating over collective intelligence network, the method comprising:
a) inputting a request into an interface of a first AI system by a human user, the request including one or more criteria;
b) identifying multiple intelligent entities that are each communicable with the first AI system, and that has a criteria related to the criteria of the request, wherein the intelligent entities being any one of or any combination of multiple additional AI systems and multiple humans each using a computer system;
c) communicating the first AI system and the additional AI systems utilizing a collective intelligence network;
d) receiving the request by the identified intelligent entities from the first AI system;
e) generating one or more answers in response to the request by each of the identified intelligent entities;
f) developing an AGI by collaborating each of the answers to create a collaborative answer; and
g) providing any one of or any combination of the answers and the collaborative answer to the first AI system.

19. The method of claim 18 further comprising the steps of customizing one or more attributes of the first AI system by the user; and wherein step e) further comprises the steps of:
implementing one or more problem solving protocols on the request by each of the identified intelligent entities utilizing a common cognitive architecture;
integrating one or more datasets from any one of or any combination of the first AI system and the identified intelligent entities; and
improving, by utilizing one or more techniques, any one of or any combination of the customizing of the attributes, the common cognitive architecture, the collective intelligence network and the integrating of the datasets.

20. A method for artificial intelligence (AI) utilizing a single computerized intelligent system including multiple AI agents residing in the single computerized intelligent system, the method comprising:
providing a problem request including a problem criteria into an AI agent residing in a single computerized intelligent system;
customizing one or more attributes of the AI agent;
matching, by the AI agent or the single computerized intelligent system, one or more additional AI agents to the problem request based on the problem criteria, the additional AI agents reside in the single computerized intelligent system;
utilizing, by the AI agent and the additional AI agents, a universal problem solving architecture in a problem solving process on the goal, respectively, to create one or more solutions;
receiving, by the AI agent, the solutions from each of the additional AI agents for the goal delegated thereto;
integrating one or more datasets from any one of or any combination of the AI agent and the additional AI agents;
combining, by the AI agent, the solutions into an overall solution to the goal; and
improving, by the AI agent or the additional AI agents, any one of or any combination of the customizing of the attributes, the common cognitive architecture, and the integrating of the datasets utilizing one or more techniques.
